(19) United States
(12) Patent Application Publication
(10) Pub. No.: US 2026/0229485 A1
(43) Pub. Date: Aug. 6, 2026

(54) SECONDARY BATTERY, METHOD FOR MANUFACTURING SECONDARY BATTERY, POSITIVE ELECTRODE ACTIVE MATERIAL, AND METHOD FOR MANUFACTURING POSITIVE ELECTRODE ACTIVE MATERIAL

(71) Applicant: SEMICONDUCTOR ENERGY LABORATORY CO., LTD., Atsugi-shi, Kanagawa-ken (JP)

(72) Inventors: Yohei MOMMA, Isehara, Kanagawa (JP); Toshihiro NAKAMURA, Atsugi, Kanagawa (JP); Sachiko KAWAKAMI, Atsugi, Kanagawa (JP); Yasuhiro NIIKURA, Komae, Tokyo (JP); Shunpei YAMAZAKI, Setagaya, Tokyo (JP); Yusuke YOSHITANI, Isehara, Kanagawa (JP); Takashi HIRAHARA, Atsugi, Kanagawa (JP); Kenta NAKANISHI, Atsugi, Kanagawa (JP)

(21) Appl. No.: 19/146,279

(22) PCT Filed: Jan. 4, 2024
(86) PCT No.: PCT/IB2024/050069

§ 371 Date: Jul. 8, 2025

(30) Foreign Application Priority Data
Jan. 11, 2023 (JP) 2023-002141
Jan. 26, 2023 (JP) 2023-010323
Nov. 1, 2023 (JP) 2023-187869

(51) Int. Cl. H01M 4/04; C01G 53/50; H01M 4/02; H01M 4/36; H01M 4/505; H01M 4/525; H01M 10/0525; H01M 10/058

(52) U.S. Cl. CPC H01M 4/0471; C01G 53/50; H01M 4/0416; H01M 4/364; H01M 4/505; H01M 4/525; H01M 10/0525; H01M 10/058; C01P 2002/01; C01P 2004/03; C01P 2004/04; H01M 2004/021; H01M 2004/028; H01M 2220/20; H01M 2220/30

(57) ABSTRACT

A secondary battery with improved cycle performance or improved safety. A secondary battery includes a positive electrode and a negative electrode, the positive electrode includes a positive electrode active material, the positive electrode active material includes a lithium composite oxide containing nickel, cobalt, and manganese, and the surface roughness obtained by quantifying unevenness data on a surface or a vicinity of the surface is less than 3 nm in a cross-sectional STEM image of the positive electrode active material.

### TECHNICAL FIELD

One embodiment of the present invention relates to a secondary battery, a positive electrode active material, and a method for manufacturing a positive electrode active material. Note that one embodiment of the present invention is not limited to the above field, and relates to a semiconductor device, a display device, a light-emitting device, a power storage device, a lighting device, an electronic device, or a manufacturing method thereof.

### BACKGROUND ART

The demand for secondary batteries is expanding rapidly in recent years and secondary batteries are essential for a modern society as energy sources that can be used repeatedly. An example of a positive electrode active material of a secondary battery is a lithium composite oxide having a layered rock-salt crystal structure, and an example of the lithium composite oxide is a ternary lithium composite oxide represented by Formula LiMO₂ (M=Ni, Mn, Co, and the like) (the lithium composite oxide is sometimes referred to as a composite oxide containing lithium and a transition metal since M is selected from transition metals). Since nickel is more inexpensive than cobalt, a composite oxide containing nickel at an increased proportion has been researched and developed as a positive electrode active material. However, the lithium composite oxide containing nickel at an increased proportion does not necessarily have a long lifetime. To solve this problem, Patent Document 1 proposes a structure in which titanium coating is performed.

A problem of lithium cobalt oxide having a layered rock-salt crystal structure is that a phase change from a hexagonal crystal to a monoclinic crystal is caused when lithium ions are extracted to some extent in charging, and the amount of lithium ions extracted is limited for use with excellent cycle performance. To solve these problems, Patent Document 2 proposes that addition of an additive element to lithium cobalt oxide can inhibit a crystal structure change even in charging.

X-ray diffraction (XRD) is one of methods used for analysis of a crystal structure of a positive electrode active material. With the use of ICSD (Inorganic Crystal Structure Database) introduced in Non-Patent Document 1, XRD data can be analyzed. For example, the ICSD can be referred to for the lattice constant of the lithium cobalt oxide described in Non-Patent Document 2. For Rietveld analysis, the analysis program RIETAN-FP described in Non-Patent Document 3 can be used, for example. As the drawing software of the crystal structure, VESTA described in Non-Patent Document 4 can be used.

As image processing software, for example, ImageJ (Non-Patent Document 5 to Non-Patent Document 7) is known. Using this software makes it possible to analyze the shape of a positive electrode active material, for example.

Meanwhile, lithium-ion secondary batteries are known to enter thermal runaway after passing through several states when the temperature rises (Non-Patent Document 8).

### REFERENCES

### Patent Documents

[Patent Document 1] Japanese Published Patent Application No. 2022-042107
[Patent Document 2] International Publication WO2020/026078

### Non-Patent Documents

[Non-Patent Document 1] Belsky, A. et al., “New developments in the Inorganic Crystal Structure Database (ICSD): accessibility in support of materials research and design”, Acta Cryst., (2002) B58 364-369.
[Non-Patent Document 2] Akimoto, J.; Gotoh, Y.; Oosawa, Y. “Synthesis and structure refinement of LiCoO₂ single crystals”, Journal of Solid State Chemistry (1998) 141, p. 298-302.
[Non-Patent Document 3] F. Izumi and K. Momma, Solid State Phenom., 130, 15-20 (2007).
[Non-Patent Document 4] K. Momma and F. Izumi, J. Appl. Cryst. (2011). 44, 1272-1276
[Non-Patent Document 5] Rasband, W. S., ImageJ, U. S. National Institutes of Health, Bethesda, Maryland, USA, http://rsb.info.nih.gov/ij/, 1997-2012.
[Non-Patent Document 6] Schneider, C. A., Rasband, W. S., Eliceiri, K. W. “NIH Image to ImageJ: 25 years of image analysis”. Nature Methods 9, 671-675, 2012.
[Non-Patent Document 7] Abramoff, M. D., Magelhaes, P. J., Ram, S. J. “Image Processing with ImageJ”. Biophotonics International, volume 11, issue 7, pp. 36-42, 2004.
[Non-Patent Document 8] Nobuo Eda, “2-4: Mechanism of Heat Generation” in “Learning Charging and Discharging Techniques of Li-Ion Batteries from Data” [Translated from Japanese.], CQ Publishing Co., Ltd., published on Apr. 4, 2020, p. 68-72.

### SUMMARY OF THE INVENTION

### Problems to be Solved by the Invention

Positive electrode active materials can be obtained in accordance with Patent Document 1 and the like described above; however, there is room for improvement in terms of cycle performance, safety, and other aspects.

In view of the above description, an object of one embodiment of the present invention is to provide a positive electrode active material enabling excellent cycle performance and a method for manufacturing the positive electrode active material. An object of another embodiment of the present invention is to provide a positive electrode active material offering a high level of safety and a method for manufacturing the positive electrode active material. An object of another embodiment of the present invention is to provide a secondary battery having excellent cycle performance and/or a high level of safety and a method for manufacturing the positive electrode active material.

Note that the description of the above objects does not preclude the presence of other objects. Moreover, objects other than the above objects can be derived from the description of the specification, the drawings, and the claims. One embodiment of the present invention does not necessarily achieve all the above objects, and achieves at least any one of all the above objects.

### Means for Solving the Problems

In view of the above problems, one embodiment of the present invention is a method for manufacturing a lithium-ion secondary battery including a positive electrode including a positive electrode active material and a negative electrode. The positive electrode active material is manufactured through a first step of heating a composite oxide including lithium and a transition metal, a second step of mixing the composite oxide including the lithium and the transition metal with a magnesium source to form a first mixed solution, a third step of performing heating after drying the first mixed solution to form a second composite oxide, a fourth step of mixing the second composite oxide with a nickel source or an aluminum source to form a second mixed solution, and a fifth step of performing heating after drying the second mixed solution. The magnesium source includes an organometallic compound including magnesium, the nickel source includes an organometallic compound including nickel, and the aluminum source includes an organometallic compound including aluminum.

Another embodiment of the present invention is a method for manufacturing a lithium-ion secondary battery including a positive electrode including a positive electrode active material and a negative electrode. The positive electrode active material is manufactured through a first step of heating a composite oxide including lithium and a transition metal, a second step of mixing the composite oxide including the lithium and the transition metal with a magnesium source to form a first mixed solution, a third step of performing heating after drying the first mixed solution to form a second composite oxide, a fourth step of mixing the second composite oxide with a nickel source and an aluminum source to form a second mixed solution, and a fifth step of performing heating after drying the second mixed solution. The magnesium source includes an organometallic compound including magnesium, the nickel source includes an organometallic compound including nickel, and the aluminum source includes an organometallic compound including aluminum.

Another embodiment of the present invention is a method for manufacturing a lithium-ion secondary battery including a positive electrode including a positive electrode active material and a negative electrode. The positive electrode active material is manufactured through a first step of heating a composite oxide including lithium and a transition metal, a second step of mixing the composite oxide including the lithium and the transition metal with a magnesium source, a nickel source, and an aluminum source to form a first mixed solution, and a third step of performing heating after drying the first mixed solution to form a second composite oxide. The magnesium source includes an organometallic compound including magnesium, the nickel source includes an organometallic compound including nickel, and the aluminum source includes an organometallic compound including aluminum.

In another embodiment of the present invention, the magnesium source preferably includes an organic solvent in which the organometallic compound including magnesium is dissolved.

Another embodiment of the present invention is a method for manufacturing a positive electrode active material, including a first step of heating a composite oxide including lithium and a transition metal, a second step of mixing the composite oxide including the lithium and the transition metal with a magnesium source to form a first mixed solution, a third step of performing heating after drying the first mixed solution to form a second composite oxide, a fourth step of mixing the second composite oxide with a nickel source or an aluminum source to form a second mixed solution, and a fifth step of performing heating after drying the second mixed solution. The magnesium source includes an organometallic compound including magnesium, the nickel source includes an organometallic compound including nickel, and the aluminum source includes an organometallic compound including aluminum.

Another embodiment of the present invention is a method for manufacturing a positive electrode active material, including a first step of heating a composite oxide including lithium and a transition metal, a second step of mixing the composite oxide including the lithium and the transition metal with a magnesium source to form a first mixed solution, a third step of performing heating after drying the first mixed solution to form a second composite oxide, a fourth step of mixing the second composite oxide with a nickel source and an aluminum source to form a second mixed solution, and a fifth step of performing heating after drying the second mixed solution. The magnesium source includes an organometallic compound including magnesium, the nickel source includes an organometallic compound including nickel, and the aluminum source includes an organometallic compound including aluminum.

Another embodiment of the present invention is a method for manufacturing a positive electrode active material, including a first step of heating a composite oxide including lithium and a transition metal, a second step of mixing the composite oxide including the lithium and the transition metal with a magnesium source, a nickel source, and an aluminum source to form a first mixed solution, and a third step of performing heating after drying the first mixed solution to form a second composite oxide. The magnesium source includes an organometallic compound including magnesium, the nickel source includes an organometallic compound including nickel, and the aluminum source includes an organometallic compound including aluminum.

In another embodiment of the present invention, the magnesium source preferably includes an organic solvent in which the organometallic compound including magnesium is dissolved.

In view of the above problems, one embodiment of the present invention is a secondary battery including a positive electrode and a negative electrode. The positive electrode includes a positive electrode active material, the positive electrode active material includes a lithium composite oxide including nickel, cobalt, and manganese, and the surface roughness obtained by quantifying unevenness data on a surface or a vicinity of the surface is less than 3 nm in a cross-sectional STEM image of the positive electrode active material.

Another embodiment of the present invention is a secondary battery including a positive electrode and a negative electrode. The positive electrode includes a positive electrode active material, the positive electrode active material includes a lithium composite oxide including nickel, cobalt, manganese, and an additive element, the additive element includes one or more selected from titanium, calcium, aluminum, zirconium, magnesium, and fluorine, and the surface roughness obtained by quantifying unevenness data on a surface or a vicinity of the surface is less than 3 nm in a cross-sectional STEM image of the lithium composite oxide.

In another embodiment of the present invention, the surface roughness is preferably less than 1 nm.

Another embodiment of the present invention is a secondary battery including a positive electrode and a negative electrode. The positive electrode includes a positive electrode active material, the positive electrode active material includes a lithium composite oxide including nickel, cobalt, and manganese, and the number of projection portions per lithium composite oxide obtained by quantifying the projection portions is 5 or less in a surface SEM image of the positive electrode including the lithium composite oxide.

Another embodiment of the present invention is a secondary battery including a positive electrode and a negative electrode. The positive electrode includes a positive electrode active material, the positive electrode active material includes a lithium composite oxide including nickel, cobalt, manganese, and an additive element, the additive element includes one or more selected from titanium, calcium, aluminum, zirconium, magnesium, and fluorine, and the number of projection portions per lithium composite oxide obtained by quantifying the projection portions is 5 or less in a surface SEM image of the positive electrode including the lithium composite oxide.

In another embodiment of the present invention, the number of the projection portions is preferably 3 or less.

Another embodiment of the present invention is a positive electrode active material including a lithium composite oxide including nickel, cobalt, and manganese. The surface roughness obtained by quantifying unevenness data on a surface or a vicinity of the surface is less than 3 nm in a cross-sectional STEM image of the lithium composite oxide.

Another embodiment of the present invention is a positive electrode active material including a lithium composite oxide including nickel, cobalt, manganese, and an additive element. The additive element includes one or more selected from titanium, calcium, aluminum, magnesium, and fluorine, and the surface roughness obtained by quantifying unevenness data on a surface or a vicinity of the surface is less than 3 nm in a cross-sectional STEM image of the lithium composite oxide.

Another embodiment of the present invention is a positive electrode active material including a lithium composite oxide including nickel, cobalt, and manganese. The number of projection portions per lithium composite oxide obtained by quantifying the projection portions is 5 or less in a surface SEM image including the lithium composite oxide.

Another embodiment of the present invention is a positive electrode active material including a lithium composite oxide including nickel, cobalt, manganese, and an additive element. The additive element includes one or more selected from titanium, calcium, aluminum, magnesium, and fluorine, and the number of projection portions per lithium composite oxide obtained by quantifying the projection portions is 5 or less in a surface SEM image including the lithium composite oxide.

Another embodiment of the present invention is a method for manufacturing a positive electrode active material, including the steps of forming a lithium composite oxide including nickel, cobalt, and manganese and heating the lithium composite oxide. The temperature of the heating is higher than or equal to 600° C. and lower than or equal to 1000° C., and the time of the heating is longer than or equal to 1 hour and shorter than or equal to 30 hours.

Another embodiment of the present invention is a method for manufacturing a positive electrode active material, including the steps of forming a lithium composite oxide including nickel, cobalt, manganese, and a first additive element, heating the lithium composite oxide, and adding a second additive element to the heated lithium composite oxide. The first additive element and the second additive element each include one or more selected from titanium, calcium, aluminum, magnesium, and fluorine.

In another embodiment of the present invention, the temperature of the heating is preferably higher than or equal to 600° C. and lower than or equal to 1000° C., and the time of the heating is preferably longer than or equal to 1 hour and shorter than or equal to 30 hours.

In another embodiment of the present invention, the first additive element source preferably includes an inorganic metal compound.

In another embodiment of the present invention, the first additive element source preferably includes an organometallic compound.

### Effect of the Invention

According to the present invention, a positive electrode active material enabling excellent cycle performance and a method for manufacturing the positive electrode active material can be provided. Furthermore, according to the present invention, a positive electrode active material offering a higher level of safety and a method for manufacturing the positive electrode active material can be provided. Furthermore, according to the present invention, a secondary battery having excellent cycle performance and/or a high level of safety and a method for manufacturing the positive electrode active material can be provided.

Note that the description of these effects does not preclude the presence of other effects. Note that one embodiment of the present invention does not need to have all of these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A and FIG. 1B are diagrams each illustrating a positive electrode active material of one embodiment of the present invention.

FIG. 2A to FIG. 2C are diagrams each illustrating a positive electrode active material of one embodiment of the present invention.

FIG. 3A and FIG. 3B are flow charts for manufacturing a positive electrode active material of one embodiment of the present invention.

FIG. 4 is a flow chart for manufacturing a positive electrode active material of one embodiment of the present invention.

FIG. 5A and FIG. 5B are flow charts illustrating a manufacturing process of the positive electrode active material of one embodiment of the present invention.

FIG. 6A and FIG. 6B are flow charts illustrating a manufacturing process of the positive electrode active material of one embodiment of the present invention.

FIG. 7A and FIG. 7B are diagrams each illustrating an example of a manufacturing apparatus of a positive electrode active material of one embodiment of the present invention.

FIG. 8 is a diagram illustrating an example of a manufacturing apparatus of a positive electrode active material that is one embodiment of the present invention.

FIG. 9A and FIG. 9B are each a cross-sectional view of a positive electrode active material of one embodiment of the present invention.

FIG. 10A and FIG. 10B are diagrams showing distributions of additive elements.

FIG. 11A and FIG. 11B are diagrams showing distributions of additive elements.

FIG. 12 is an example of a TEM image showing crystal orientations substantially aligned with each other.

FIG. 13 is a diagram illustrating crystal structures of a positive electrode active material of one embodiment of the present invention.

FIG. 14 is a diagram illustrating a change of a c-axis length of a positive electrode active material of one embodiment of the present invention.

FIG. 15 is a diagram illustrating a diffraction peak of a positive electrode active material of one embodiment of the present invention.

FIG. 16 is a diagram illustrating a diffraction peak of a positive electrode active material of one embodiment of the present invention.

FIG. 17A and FIG. 17B are diagrams illustrating a diffraction peak of a positive electrode active material layer of one embodiment of the present invention.

FIG. 18A and FIG. 18B are diagrams illustrating a positive electrode of one embodiment of the present invention.

FIG. 19A and FIG. 19B are diagrams illustrating a solid electrolyte secondary battery.

FIG. 20A is an exploded perspective view of a coin-type secondary battery, FIG. 20B is a perspective view of the coin-type secondary battery, and FIG. 20C is a cross-sectional perspective view thereof.

FIG. 21A illustrates an example of a cylindrical secondary battery. FIG. 21B illustrates an example of the cylindrical secondary battery. FIG. 21C illustrates an example of a plurality of cylindrical secondary batteries. FIG. 21D illustrates an example of a power storage system including the plurality of cylindrical secondary batteries.

FIG. 22A and FIG. 22B are diagrams for describing examples of a secondary battery, and FIG. 22C is a diagram illustrating the internal state of the secondary battery.

FIG. 23A to FIG. 23C are diagrams illustrating an example of a secondary battery.

FIG. 24A and FIG. 24B are each an external view of a secondary battery.

FIG. 25A to FIG. 25C are diagrams illustrating a method for manufacturing a secondary battery.

FIG. 26A is a perspective view of a battery pack of one embodiment of the present invention, FIG. 26B is a block diagram of the battery pack, and FIG. 26C is a block diagram of a vehicle including the battery pack.

FIG. 27A to FIG. 27D are diagrams illustrating examples of transport vehicles. FIG. 27E is a diagram illustrating an example of an artificial satellite.

FIG. 28A is a diagram illustrating an electric bicycle, FIG. 28B is a diagram illustrating a secondary battery of the electric bicycle, and FIG. 28C is a diagram illustrating a motor scooter.

FIG. 29A to FIG. 29D are diagrams illustrating examples of electronic devices.

FIG. 30 is a graph showing a temperature rise in a secondary battery.

FIG. 31A to FIG. 31C are diagrams illustrating a nail penetration test.

FIG. 32 is a graph showing a temperature rise in a secondary battery when an internal short circuit occurs.

FIG. 33A and FIG. 33B are SEM images of samples.

FIG. 34A to FIG. 34C show XRD results of samples.

FIG. 35A to FIG. 35C are diagrams illustrating a method for quantifying smoothness of a positive electrode active material.

FIG. 36A to FIG. 36C are diagrams illustrating a method for quantifying smoothness of a positive electrode active material.

FIG. 37 shows SEM observation images in Example.

FIG. 38A and FIG. 38B are graphs showing results of a charge and discharge cycle test in Example.

FIG. 39A and FIG. 39B are graphs showing results of a charge and discharge cycle test in Example.

FIG. 40 shows SEM observation images in Example.

FIG. 41A and FIG. 41B are graphs showing results of a charge and discharge cycle test in Example.

FIG. 42A and FIG. 42B are graphs showing results of a charge and discharge cycle test in Example.

### MODE FOR CARRYING OUT THE INVENTION

Hereinafter, embodiments of the present invention will be described in detail below with reference to the drawings. However, the present invention is not limited to the description below and it is easily understood by those skilled in the art that the mode and details can be modified in various ways. In addition, the present invention should not be construed as being limited to the description of the embodiments below.

In this specification and the like, a positive electrode active material is sometimes referred to as a composite oxide, a positive electrode member, a positive electrode material, a lithium-ion secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In this specification and the like, a lithium-ion secondary battery refers to a battery in which lithium ions are used as carrier ions; however, carrier ions in the present invention are not limited to lithium ions. For example, as the carrier ions in the present invention, alkali metal ions or alkaline earth metal ions can be used; specifically, sodium ions or the like can be used. In that case, the present invention can be understood by replacing lithium ions with sodium ions or the like. Furthermore, in the case where there is no limitation on carrier ions, the term “secondary battery” is sometimes used.

In this specification and the like, an active material is expressed as an active material particle in some cases; note that the active material can have a variety of shapes and the shape is not limited to a particle form. For example, the shape of the active material (active material particle) in one cross section may be an ellipse, a rectangle, a trapezoid, a triangle, a quadrilateral with rounded corners, or an asymmetrical shape, as well as a circle.

In this specification and the like, description including a simple term “positive electrode active material” explains a plurality of positive electrode active material particles in some cases and explains one positive electrode active material particle in other cases, depending on an analysis method or the like. For example, when description relates to line analysis by a scanning transmission electron microscope-energy dispersive X-ray (STEM-EDX) detector, scanning transmission electron microscope-electron energy-loss spectroscopy (STEM-EELS), or electron diffraction, the description is made on one positive electrode active material particle unless otherwise specified. Meanwhile, when description relates to X-ray photoelectron spectroscopy (XPS), X-ray diffraction (XRD), various types of mass spectroscopy, or the like, the description is made on a plurality of positive electrode active material particles unless otherwise specified.

In this specification and the like, a secondary particle refers to a particle formed by aggregation of primary particles. In this specification and the like, aggregation includes a aggregated state irrespective of the bonding strength between a plurality of primary particles. In other words, the bonding force may be any of covalent bonding, ionic bonding, a hydrophobic interaction, the Van der Waals force, and other molecular interactions, or a plurality of bonding forces may work together. In this specification and the like, a primary particle refers to a particle whose appearance shows no grain boundary. The primary particle is referred to as a single particle in some cases. In this specification and the like, a single crystal refers to a crystal whose inner portion has no grain boundary, whereas a polycrystal refers to a crystal whose inner portion has a grain boundary. A polycrystal may be regarded as a group of a plurality of crystallites, and a grain boundary may be regarded as an interface existing between two or more crystallites. Note that crystallites in a polycrystal are preferably oriented in the same direction.

It can be said in this specification and the like that when surface unevenness information in one cross section of an active material is quantified with measurement data, a smooth surface of the active material has a surface roughness of at least 10 nm or less. The one cross section in this specification and the like is a cross section obtained in observation using a STEM (Scanning Transmission Electron Microscope) image, for example.

In this specification and the like, a median diameter (D50) is simply referred to as a median diameter in some cases.

In this specification and the like, the distribution of an element indicates a region where the element is successively detected by a successive analysis method to the extent that the detection value is no longer on the noise level. The region where the element is successively detected to the extent that the detection value is no longer on the noise level can also be regarded as a region where the element is surely detected when analysis is performed multiple times, for example.

Note that in this specification and the like, a surface portion of a positive electrode active material is a region of 20 nm or less or a region of 50 nm or less from a surface toward an inner portion in a direction perpendicular or substantially perpendicular to the surface. The surface portion is synonymous with the vicinity of a surface and a region in the vicinity of a surface. Note that “perpendicular” or “substantially perpendicular” specifically means that an angle to a surface is greater than or equal to 80° and less than or equal to 100°. The inner portion refers to a region that is at a larger depth than the surface portion of a positive electrode active material. The inner portion is synonymous with a bulk or a core.

In this specification and the like, the (001) plane, the (003) plane, and the like are sometimes collectively referred to as the (001) plane. Note that in this specification and the like, the (001) plane is sometimes referred to as a C plane, a basal plane, or the like, and it can be said that a diffusion path of lithium ions lies along the basal plane. In this specification and the like, a plane where lithium is inserted and extracted, i.e., a plane where a diffusion path of lithium ions is exposed, specifically, a plane other than the (001) plane, is referred to as an edge plane in some cases.

In this specification and the like, a short circuit of a lithium-ion secondary battery might cause not only malfunction in charge operation and/or discharge operation of the lithium-ion secondary battery but also thermal runaway, heat generation, and firing. An internal short circuit and an external short circuit are kinds of the short circuit. In this specification and the like, an internal short circuit of a lithium-ion secondary battery refers to contact between a positive electrode and a negative electrode in the battery. An external short circuit of a lithium-ion secondary battery refers to contact between a positive electrode and a negative electrode outside the battery on the assumption that the battery is misused.

In this specification and the like, ignition in a nail penetration test refers to a state where fire is observed outside an exterior body within one minute of nail penetration or a state where thermal runaway of a secondary battery has occurred within one minute of nail penetration. For example, a state where a pyrolysate(s) of a positive electrode and/or a negative electrode are/is observed at a position more than or equal to 2 cm away from a penetration point after a nail penetration test is finished is referred to as a state where thermal runaway has occurred. The pyrolysate(s) of the positive electrode and/or the negative electrode contains, for example, aluminum oxide formed by oxidation of aluminum of a positive electrode current collector or copper oxide formed by oxidation of copper of a negative electrode current collector.

In this specification, the description is made on the assumption that materials (such as a positive electrode active material, a negative electrode active material, an electrolyte solution, and a separator) of a lithium-ion secondary battery have not deteriorated unless otherwise specified. A decrease in discharge capacity due to aging treatment and burn-in treatment during the manufacturing process of a lithium-ion secondary battery is not regarded as deterioration. For example, the case where discharge capacity is higher than or equal to 97% of the rated capacity of a lithium-ion secondary battery of a cell can be regarded as a non-deteriorated state. The rated capacity conforms to JIS C 8711:2019 in the case of a lithium-ion secondary battery for a portable device. The rated capacities of other lithium-ion secondary batteries conform to JIS described above, JIS for electric vehicle propulsion, industrial use, and the like, standards defined by IEC, and the like.

In this specification and the like, the phrase “A and/or B” is an example of an expression that encompasses only A, only B, and A and B.

### Embodiment 1

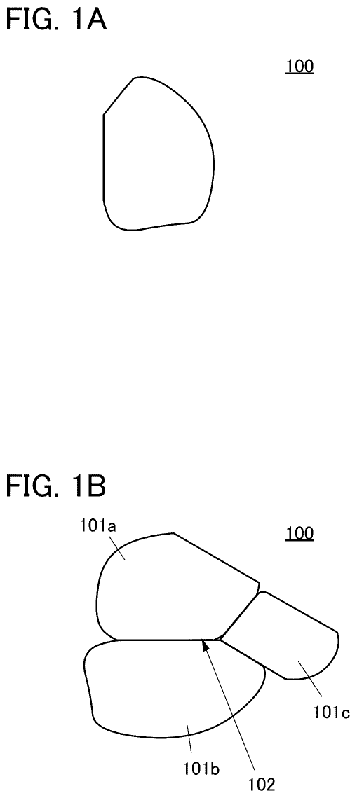

In this embodiment, a positive electrode active material 100 of one embodiment of the present invention is described with reference to FIG. 1.

A positive electrode active material of a lithium-ion secondary battery preferably contains a transition metal which can be oxidized or reduced in order to maintain a neutrally charged state even when lithium ions are inserted and extracted. In other words, the positive electrode active material preferably contains a composite oxide containing lithium and a transition metal. As the transition metal, cobalt is preferably used, and at least one or two or more selected from cobalt, nickel, and manganese are preferably used. Furthermore, the positive electrode active material preferably includes a composite oxide having a layered rock-salt crystal structure, in which case the capacity of the secondary battery is expected to be increased. Specifically, as the composite oxide having a layered rock-salt crystal structure, one or two or more selected from a lithium cobalt oxide (sometimes referred to as LCO), a lithium composite oxide containing nickel, cobalt, and manganese (sometimes referred to as NCM or NMC), a lithium composite oxide containing nickel, cobalt, and aluminum (sometimes referred to as NCA), and a lithium composite oxide containing nickel, manganese, and aluminum (sometimes referred to as NMA) are preferably used. These composite oxides are collectively referred to as lithium composite oxides.

FIG. 1A illustrates the positive electrode active material 100 containing NCM or the like. In the present invention, a positive electrode active material in which a plurality of positive electrode active material particles are aggregated may be used; for example, as illustrated in FIG. 1B, the positive electrode active material 100 in which a first positive electrode active material particle 101a, a second positive electrode active material particle 101b, and a third positive electrode active material particle 101c are aggregated may be used. In the case where the particles are aggregated, an interface 102 can sometimes be observed at the boundary between the positive electrode active material particles. The first positive electrode active material particle 101a, the second positive electrode active material particle 101b, and the third positive electrode active material particle 101c are each referred to as a primary particle in some cases.

Although the above-described lithium composite oxide can be used for the positive electrode active material 100, it is preferable to use specifically a lithium composite oxide containing nickel, cobalt, and manganese (NCM). When the composition of NCM is represented by LiNiₓCo_{y}Mn_{z}O₂ (x>0, y>0, z>0, 0.8<x+y+z<1.2), x, y, and z preferably satisfy x:y:z=8:1:1 or the neighborhood thereof. Alternatively, x, y, and z preferably satisfy x:y:z=9:0.5:0.5 or the neighborhood thereof. That is, a high nickel content percentage that satisfies x>2 (y+Z) is preferable. As the composition with a high nickel content percentage, x, y, and z preferably satisfy x:y:z=6:2:2 or the neighborhood thereof. Alternatively, x, y, and z preferably satisfy x:y:z=5:2:3 or the neighborhood thereof. Note that the composition of the positive electrode active material 100 is not particularly limited, and x, y, and z may satisfy x:y:z=1:1:1 or the neighborhood thereof. Alternatively, x, y, and z may satisfy x:y:z=1:4:1 or the neighborhood thereof. Note that in this specification and the like, a value in the neighborhood of a composition refers to a range where the composition is obtained when the significant number is one digit. At this time, the digit next to the significant number is rounded. For example, x:y:z=4.6:2.3:3.1 can be regarded as a value in the neighborhood of x:y:z=5:2:3.

### <Smooth Region>

One feature of the present invention is that the positive electrode active material 100 is smoothed. In the case where the particles are aggregated, the first positive electrode active material particle 101a, the second positive electrode active material particle 101b, and the third positive electrode active material particle 101c are each preferably smoothed. The smoothed state is referred to as a smooth surface of the positive electrode active material in some cases. The smoothed state is referred to as a glossy surface of the positive electrode active material in some cases.

Note that the positive electrode active material 100 may partly include an angular portion (referred to as a corner portion) as long as the positive electrode active material 100 includes a smooth region. For example, in FIG. 1B, the first positive electrode active material particle 101a may have a corner portion in the vicinity of the interface 102. The second positive electrode active material particle 101b may have a corner portion in the vicinity of the interface 102. The third positive electrode active material particle 101c may have a corner portion in the vicinity of the interface 102. In other words, in the case of aggregated particles, a smooth region is not necessarily included in the vicinity of the interface 102. In the secondary battery including the positive electrode active material 100, an electrolyte solution is sometimes present at the interface 102.

When a smooth region is present in the positive electrode active material 100, the cycle performance can be improved. This is because a crack is unlikely to be caused in a smooth region in the positive electrode active material 100 and deterioration due to the crack is not caused when charging and discharging are repeated and/or pressing is performed at the time of manufacturing. In addition, a smooth region can improve the safety of the secondary battery including the positive electrode active material 100. For evaluation of the safety, a nail penetration test is preferably performed on a secondary battery, for example.

The smoothness of the positive electrode active material 100 can be evaluated from, for example, a surface SEM image, a cross-sectional SEM image, a cross-sectional TEM image, or a cross-sectional STEM image of the positive electrode active material 100, or the specific surface area or the like of the positive electrode active material 100. As a STEM image, a High-Angle Annular Dark Field Scanning TEM (HAADF-STEM) image is preferably used.

### <Method 1>

A method 1 for quantifying the smoothness of the positive electrode active material 100 using the above cross-sectional STEM image is described.

First, any positive electrode active material 100 is selected from the positive electrode. In the case of the aggregated positive electrode active material 100, any positive electrode active material is selected after the aggregation is loosened. Next, the positive electrode active material 100 is processed with a focused ion beam (FIB) apparatus or the like to expose a cross section. At this time, FIB processing is preferably performed after a surface protective film is formed in an observation portion of the positive electrode active material 100.

Next, a cross-sectional STEM image of the positive electrode active material 100 is taken. In a cross-sectional STEM image, a surface of the positive electrode active material 100 is specified. Since the surface protective film is also observed in a cross-sectional STEM image, the boundary between the positive electrode active material 100 and the surface protective film is preferably extracted using image processing software. There is no particular limitation on image processing software, and for example, “ImageJ” in Non-Patent Documents 1 to 3 can be used. “ImageJ” can be used as image processing software used for any processing described later.

Furthermore, noise processing is preferably performed on a cross-sectional STEM image. For example, the Gaussian Blur (σ=2) is performed using image processing software, and then binarization is performed, whereby noise can be removed.

After that, unevenness on the surface of the positive electrode active material 100 and/or the vicinity of the surface is specified, and data of the unevenness is quantified. After quantification, the quantified values are output to spreadsheet software or the like, and surface roughness can be obtained from the quantified values. For example, a function of the spreadsheet software or the like is used to show the values on a scatter graph, and unevenness can be evaluated by numerical values using the specified surface as a reference surface. Furthermore, root-mean-square (RMS) surface roughness, which is a standard deviation of surface roughness, can be obtained.

In the positive electrode active material 100, root-mean-square (RMS) surface roughness is preferably less than 3 nm, further preferably less than 1 nm, still further preferably less than 0.5 nm. The root-mean-square (RMS) surface roughness is an index of roughness and is suitable as an evaluation index of a smooth region. The evaluation of such surface roughness is a method suitable for showing that the positive electrode active material 100 has smoothness, i.e., includes a smooth region.

Since the above-described surface roughness is obtained from an observation area of a cross-sectional STEM image, it can be said that the surface roughness is surface roughness of a positive electrode active material included in the observation area, in other words, the surface roughness is surface roughness of the outer periphery of a predetermined range of the positive electrode active material. Therefore, the above observation area is preferably determined such that the outer periphery of the positive electrode active material is higher than or equal to 30%, preferably higher than or equal to 50%, further preferably higher than or equal to 70% of the entire outer periphery.

Needless to say, a different method may be used to show that the positive electrode active material 100 includes a smooth region. In that case, the different method and the method 1 may be regarded as being independent of each other, and the correlation therebetween does not matter.

### <Method 2>

Next, the ratio of an actual specific surface area A_{R} measured by a gas adsorption method to an ideal specific surface area Aᵢ obtained from the median diameter (D50) can prove that the positive electrode active material 100 includes a smooth region. This method is described.

Although a physical adsorption method (typically a constant-volume method) and a chemical adsorption method are given as the above gas adsorption method, a constant-volume method is preferably used as the typical gas adsorption method. The median diameter (D50) can be measured with a particle size distribution analyzer or the like using a laser diffraction and scattering method. The ideal specific surface area Aᵢ is calculated on the assumption that all the particles have the same diameter, have the same weight, and have ideal spherical shapes as the particle shape.

First, the ideal specific surface area Aᵢ obtained from the median diameter (D50) of the positive electrode active material 100 is calculated. Then, the actual specific surface area A_{R} of the positive electrode active material 100 is obtained by a constant-volume method. When the ratio A_{R}/Aᵢ is 2.1 or less, the positive electrode active material has a shape close to an ideal sphere. Thus, it can be said that the positive electrode active material 100 includes a smooth region when the ratio A_{R}/Aᵢ is 2.1 or less.

Needless to say, a different method may be used to show that the positive electrode active material 100 includes a smooth region. In that case, the different method and the method 2 may be regarded as being independent of each other, and the correlation therebetween does not matter.

### <Method 3>

Next, a method 3 for quantifying the smoothness of the positive electrode active material 100 using a surface SEM image is described.

First, a surface SEM image of the positive electrode active material 100 is taken. At this time, coating with a conductive film may be performed as pretreatment for observation. The conductive film can be regarded as a surface protective film. The plane observed in the surface SEM image is preferably perpendicular to an electron beam.

Then, the above SEM image is converted into an 8-bit image (which is referred to as a grayscale image) with the use of image processing software. The 8-bit is an example. The grayscale image includes luminance (brightness information), and in an 8-bit grayscale image, luminance can be represented by 28=256 gradation levels. A dark portion has a low gradation level and a bright portion has a high gradation level, and thus luminance can be quantified in relation to the number of gradation levels. The value is referred to as a grayscale level. The smoothness of the positive electrode active material 100 can be quantified on the basis of the grayscale level.

In the positive electrode active material 100, the difference between the maximum grayscale level and the minimum grayscale level is preferably less than or equal to 120, further preferably less than or equal to 115, still further preferably greater than or equal to 70 and less than or equal to 115. The standard deviation of the grayscale level is preferably less than or equal to 11, further preferably less than or equal to 8, still further preferably greater than or equal to 4 and less than or equal to 8. Such evaluation is suitable for showing that the positive electrode active material 100 has smoothness, i.e., includes a smooth region.

In addition, luminance in a target region can also be represented with a histogram. A histogram three-dimensionally shows distribution of gradation in a target region and is also referred to as a luminance histogram. A luminance histogram enables visually easy-to-understanding and evaluation of the smoothness of the positive electrode active material.

Needless to say, a different method may be used to show that the positive electrode active material 100 includes a smooth region. In that case, the different method and the method 3 may be regarded as being independent of each other, and the correlation therebetween does not matter.

### <Projection Portion>

It is further preferable that the surface of the positive electrode active material 100 be smooth and have no projection portions or few projection portions. Having no projection portions or few projection portions means that the positive electrode active material 100 includes a smooth region. The projection portion of the positive electrode active material 100 is probably caused by a flake of the positive electrode active material and/or an unreacted starting material thereof. The projection portion on the surface of the positive electrode active material 100 can be determined, for example, from a surface SEM image, a cross-sectional SEM image, a cross-sectional TEM image, or a cross-sectional STEM image of the positive electrode active material 100. Moreover, a projection portion formed of an unreacted starting material is referred to as a fine particle in some cases, and refers to a metal compound particle with a particle diameter greater than or equal to 0.001 μm and less than or equal to 1 μm. The particle diameter of the metal compound particle is a Feret diameter or a projected area equivalent circle diameter measured on a surface SEM image, and is obtained in a different manner from that of the median diameter (D50) of the positive electrode active material 100. Whether or not the positive electrode active material 100 is a metal compound can be analyzed by SEM-EDX or the like.

### <Method 4>

Considering the projection portion described above, a method for quantifying projection portions included in the positive electrode active material 100 by using a surface SEM image is described.

First, an observation area of the positive electrode is determined, and a surface SEM image including the positive electrode active material 100 is obtained. The surface SEM image is preferably used, in which case an aggregated positive electrode active material can also be included in an observation area. The SEM image is trimmed with image processing software. For example, a part that is not used for image analysis is eliminated.

In the case where the aggregated positive electrode active material is included, interface extraction is preferably performed on the above SEM image using image processing software. Specifically, when binarization is performed after the trimming, interface extraction is possible.

Even after the trimming, the observation area may include a background (a region excluding the positive electrode active material). In this case, image processing for separating the background and the inside of the positive electrode active material is performed. For example, it is preferable that binarization be performed using an Otsu's algorithm by image processing software. The Otsu's algorithm enables image threshold processing.

After the above-described processing, a particle(s) A in a predetermined area is/are specified by using image processing software, and the particles A can be counted. It can be understood that the particle A in a predetermined area corresponds to the positive electrode active material 100. In that case, an appropriate area is preferably determined on the basis of the median diameter (D50) of the positive electrode active material 100.

Next, a projection portion is specified. By specifying a particle(s) B (which has a smaller area than the particle A and is referred to as a fine particle B) in a predetermined area of the surface of the particle A using the image processing software, the fine particles B can be counted. In specifying the fine particles B, a low-resolution region or the like may be removed as noise.

When the particle(s) A and the fine particle(s) B can be specified in this manner, the number of particles A and the number of fine particles B can be calculated. In the positive electrode active material 100, no fine particles B are preferably present or the number of the fine particles B per particle A is preferably 10 or less, further preferably 5 or less, still further preferably 3 or less, and such a particle A is included in the positive electrode active material 100 including a smooth region.

Needless to say, a different method may be used to evaluate the projection portion in the positive electrode active material 100. In that case, the different method and the method 4 may be regarded as being independent of each other, and the correlation therebetween does not matter. The method 4 for quantifying projection portions can be combined with any of the methods 1 to 3 described above as appropriate.

### <Crystallinity 1>

The positive electrode active material 100 preferably has high crystallinity and is further preferably a single crystal. The positive electrode active material made of a single crystal is preferable because a crack is less likely to be generated even when the volume of the positive electrode active material 100 changes due to charging and discharging. Furthermore, when the positive electrode active material is made of a single crystal, a secondary battery using the positive electrode active material 100 is presumably unlikely to ignite and can have a high level of safety.

The crystallite size of the positive electrode active material 100 can be calculated from, for example, the Scherrer equation shown below.

$$Crystallite size [ nm ] = \frac{Scherrer constant \times X - ray wavelength [ nm ]}{Half width [ rad ] \times cos ( \frac{Peak diffraction angle [ rad ]}{2} )} \qquad [ Formula 1 ]$$

To calculate the crystallite size, all diffraction peaks detected in a 2θ range of 15° to 90°, inclusive, in an X-ray diffraction (XRD) method can be used. In the case where all diffraction peaks are used, the average value of the crystallite sizes can be calculated from the diffraction peaks.

To obtain a large crystallite size, excess lithium is added. However, excess lithium might cause gelling of a binder when an electrode such as a positive electrode is formed. The upper limit of the crystallite size is preferably set to avoid the above problem. For example, when the crystallite size calculated from the XRD diffraction pattern is less than or equal to 600 nm, preferably less than or equal to 500 nm, the above problem can be avoided.

For example, since the positive electrode active material 100 is made of a single crystal, the lower limit of the crystallite size calculated from the diffraction pattern of XRD is preferably greater than or equal to 250 nm, further preferably greater than or equal to 420 nm. This lower limit value can be freely combined with the above-described upper limit of the crystallite size.

Although an XRD measurement is preferably performed in a state of the positive electrode active material alone, the XRD measurement may be performed in a state of a positive electrode including a current collector, a binder, a conductive material, and the like in addition to the positive electrode active material. Note that the positive electrode active material may have orientation in the positive electrode owing to, for example, pressure application in a manufacturing process. With high orientation, the crystallite might fail to be calculated accurately; thus, it is further preferable to perform an XRD measurement in the following manner: a positive electrode active material layer is extracted from the positive electrode, the binder and the like in the positive electrode active material layer are removed to some extent using a solvent or the like, and the resultant positive electrode active material is placed in a sample holder, for example.

The XRD measurement conditions will be described. The apparatus and conditions of the XRD measurement are not particularly limited as long as the apparatus is adjusted appropriately and calibration is performed using a standard sample. The measurement can be performed with the apparatus and conditions as described below, for example.
XRD apparatus: Bruker AXS D8 ADVANCE
X-ray source: CuKα₁ radiation
Output: 40 kV, 40 mA
Angle of divergence: Div. Slit, 0.5°
Detector: LynxEye
Scanning method: 2θ/θ continuous scanning
Measurement range (2θ): from 15° to 90° Step width (2θ): 0.01° counting time: 1 second/step
Rotation of sample stage: 15 rpm
From the obtained XRD patterns, the background and CuKα₂ radiation peak can be removed using analysis software, DIFFRAC. EVA, or the like.

As a standard sample, a standard sintered alumina plate SRM 1976 from National Institute of Standards and Technology (NIST) can be used, for example.

In the case where the measurement sample is a powder, powder XRD is performed, where the sample is set by, for example, being placed on a glass sample holder or being sprinkled on a reflection-free silicon plate to which grease is applied. In the case where the measurement sample is a positive electrode, the sample is set in such a manner that the positive electrode is attached to a stage with a double-sided adhesive tape and the position of the positive electrode active material layer of the positive electrode can be set at the level of a measurement plane required by the measurement apparatus.

Characteristic X-rays may be monochromatized with the use of a filter or the like or may be monochromatized with XRD data analysis software after an XRD diffraction pattern is obtained. For example, a peak due to CuKα₂ radiation can be eliminated and only a peak due to CuKα₁ radiation can be extracted by using DEFFRAC.EVA (XRD data analysis software by Bruker). This software can also be used to eliminate the background, for example.

By analyzing the obtained XRD diffraction pattern using crystal structure analysis software (e.g., TOPAS), the crystallite size can be calculated.

### <Particle Diameter 1>

In the case where the positive electrode active material 100 is a single particle (a primary particle), a smaller particle diameter is preferable because cracking is less likely to occur. However, too small a particle diameter might increase the specific surface area and increase a side reaction with the electrolyte solution undesirably, for example. Thus, the median diameter (D50) of the positive electrode active material 100 measured by a laser diffraction and scattering method is preferably greater than or equal to 2 μm and less than or equal to 15 μm.

A positive electrode is preferably formed using a mixture of positive electrode active materials having different particle diameters, in which case the electrode density can be increased, leading to a secondary battery with a high energy density. The positive electrode active material with a relatively small particle diameter is expected to enable high charge and discharge rate performance. The positive electrode active material having a relatively large particle diameter is expected to have high charge and discharge cycle performance and maintain high discharge capacity. The particle diameter can be replaced with the median diameter (D50).

### <Additive Element>

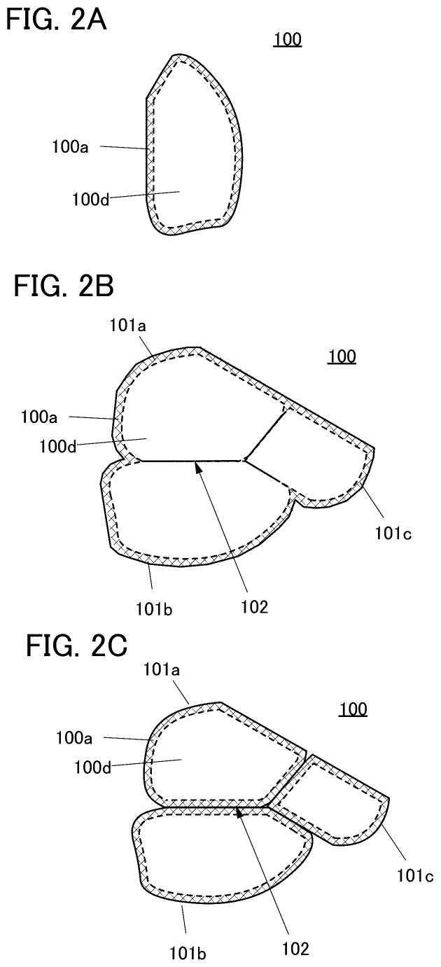

The lithium composite oxide may contain an additive element. As the additive element, one or two or more selected from titanium, calcium, aluminum, zirconium, nickel, magnesium, and fluorine can be used. Note that nickel may be used as the additive element added to NCM. The additive element is segregated in the surface portion of the positive electrode active material 100 in some cases, and this is referred to as a barrier film in some cases. The positive electrode active material 100 containing the additive element is described with reference to FIG. 2. Note that the positive electrode active material 100 includes a surface portion 100a and an inner portion 100d.

### <Surface Portion>

In this specification and the like, the surface portion 100a refers to a region extending from the surface to 200 nm or less, preferably 100 nm or less, further preferably 50 nm or less, still further preferably 20 nm or less toward the inner portion, for example. The surface portion is synonymous with the vicinity of a surface or a region in the vicinity of a surface.

### <Inner Portion>

The inner portion 100d refers to a region that is deeper than the surface portion 100a of the positive electrode active material 100. The inner portion 100d is synonymous with an inner region or a core.

### <Solid Solution and Substitution>

The additive element preferably forms a solid-solution with the positive electrode active material 100. Alternatively, the additive element preferably substitutes for any of the sites of the transition metal, oxygen, and lithium contained in the positive electrode active material 100.

FIG. 2A illustrates the positive electrode active material 100 corresponding to FIG. 1A in which a barrier film is formed by addition of an additive element. Since the additive element is likely to be segregated in the surface portion 100a, the barrier film is formed in the surface portion 100a. The additive element preferably forms a solid-solution with the lithium composite oxide in the surface portion 100a.

FIG. 2B illustrates the positive electrode active material 100 corresponding to FIG. 1B in which the first positive electrode active material particle 101a to the third positive electrode active material particle 101c aggregate and a barrier film is formed on the outside of the positive electrode active material 100. That is, the barrier film is provided in the surface portion 100a of each particle but is not provided at the interface 102.

FIG. 2C illustrates the positive electrode active material 100 corresponding to FIG. 1B in which the first positive electrode active material particle 101a to the third positive electrode active material particle 101c aggregate and a barrier film is formed in the outside of the positive electrode active material 100 and at the interface 102. That is, the barrier film is formed in the surface portion 100a of each particle and at the interface 102 or in the vicinity thereof.

The above-described barrier film is preferably formed uniformly in the surface portion 100a and the like, and the barrier film is formed in at least the surface portion having a surface other than the (001) plane into and from which carrier ions are inserted and extracted. In the case where NCM is used for the positive electrode active material 100, carrier ions are lithium ions.

The positive electrode active material 100 illustrated in each of FIG. 2A to FIG. 2C also has a smooth region, and thus can show excellent cycle performance. In addition, the safety of the secondary battery can be improved.

This embodiment can be freely combined with the other embodiments.

### Embodiment 2

In this embodiment, a method for manufacturing the positive electrode active material 100 will be described.

### <<Manufacturing Method 1 of Positive Electrode Active Material>>

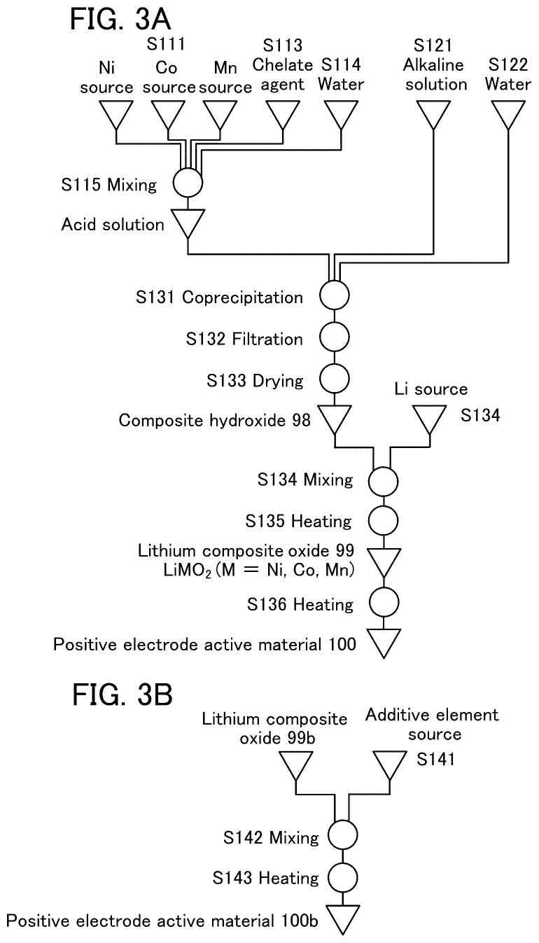

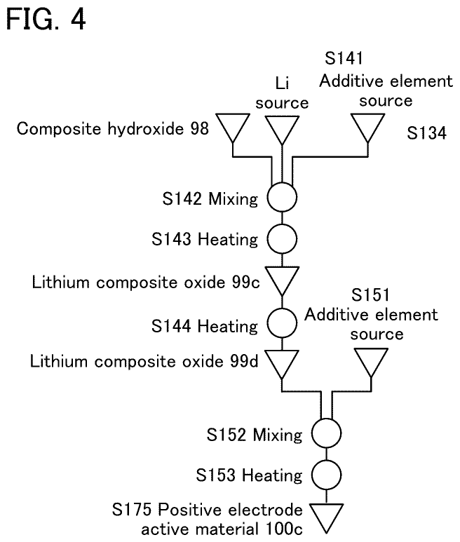

A manufacturing method 1 of the positive electrode active material 100 is described with reference to FIG. 3A to FIG. 4. As the manufacturing method 1, a method for manufacturing a positive electrode active material including lithium composite oxide LiMO₂ (M=Ni, Co, and Mn), i.e., NCM, is described as an example.

### <Step S111>

In Step S111 in FIG. 3A, a transition metal M source is prepared. Specifically, a nickel source (denoted as Ni source in the diagram), a cobalt source (denoted as Co source in the diagram), and a manganese source (denoted as Mn source in the diagram) are prepared as the transition metal M source. The mixed ratio of nickel, cobalt, and manganese is preferably within a range with which a layered rock-salt crystal structure can be obtained.

It is preferable that as the transition metal M contained in the positive electrode active material 100, a large amount of especially nickel is contained, in which case the cost of source materials may be lower than that in the case of containing a large amount of cobalt and charge and discharge capacity per weight may be increased. For example, when the proportion of nickel in the transition metal M (M is the total of nickel, cobalt, and manganese) is too high, the chemical stability and heat resistance might be decreased. Thus, the proportion of nickel in the transition metal M is preferably lower than or equal to 95 atomic %.

Cobalt is preferably contained as the transition metal M, in which case the average discharge voltage is high and a secondary battery can be highly reliable because cobalt contributes to stabilization of a layered rock-salt structure.

The transition metal M preferably contains manganese, in which case the heat resistance and chemical stability are improved. However, a too high proportion of manganese tends to decrease a discharge voltage and a discharge capacity. For this reason, the proportion of manganese in the transition metal M is preferably higher than or equal to 2.5 atomic % and lower than or equal to 34 atomic %.

As the transition metal M source, an aqueous solution containing the transition metal M is prepared. As the nickel source, an aqueous solution of nickel salt can be used. As the nickel salt, nickel sulfate, nickel chloride, nickel nitrate, or a hydrate thereof can be used, for example. Furthermore, an organic acid salt of nickel typified by nickel acetate or a hydrate thereof can also be used. As the nickel source, an aqueous solution of nickel alkoxide or an organic nickel complex can also be used. In this specification and the like, the term “organic acid salt” denotes a compound of a metal and an organic acid such as an acetic acid, a citric acid, an oxalic acid, a formic acid, or a butyric acid.

Similarly, an aqueous solution of cobalt salt can be used as the cobalt source. As the cobalt salt, cobalt sulfate, cobalt chloride, cobalt nitrate, or a hydrate thereof can be used, for example. Furthermore, an organic acid salt of cobalt typified by cobalt acetate or a hydrate thereof can also be used. As the cobalt source, an aqueous solution of cobalt alkoxide or an organic cobalt complex can be used.

Similarly, an aqueous solution of manganese salt can be used as the manganese source. As the manganese salt, manganese sulfate, manganese chloride, manganese nitrate, or an aqueous solution thereof can be used. Furthermore, an organic acid salt of manganese typified by manganese acetate or a hydrate thereof can also be used. As the manganese source, an aqueous solution of manganese alkoxide or an organic manganese complex can be used.

In this embodiment, an aqueous solution in which nickel sulfate, cobalt sulfate, and manganese sulfate are dissolved in pure water is prepared as the transition metal M source. The aqueous solution shows acidity, and thus can be referred to as an acid aqueous solution. In this aqueous solution, the atomic ratio of nickel to cobalt to manganese may be expressed by Ni:Co:Mn=8:1:1 or in the neighborhood thereof or Ni:Co:Mn=9:0.5:0.5 or in the neighborhood thereof. Note that the atomic ratio of nickel, cobalt, and manganese is not limited. The pure water is water with a resistivity of 1 MΩ·cm or higher, preferably water with a resistivity of 10 MΩ·cm or higher, further preferably water with a resistivity of 15 MΩ·cm or higher. Water with the above-described resistivity has high purity and an extremely small amount of impurities.

### <Step S113>

In Step S113 in FIG. 3A, a chelate agent is prepared. Note that the chelate agent may be prepared optionally. As the chelate agent, one or two or more selected from glycine, oxine, 1-nitroso-2-naphthol, 2-mercaptobenzothiazole, and EDTA (ethylenediaminetetraacetic acid) can be used. The selected chelate agent is preferably dissolved in pure water, which is referred to as a chelate aqueous solution. The chelate agent is a complexing agent for forming a chelate compound and is suitable for Step S113 as compared with a general complexing agent. The chelate aqueous solution has an effect of suppressing generation of unnecessary crystal nuclei and promoting growth. Since generation of unnecessary crystal nuclei is suppressed to inhibit generation of fine particles, a composite hydroxide with good particle size distribution can be obtained. Furthermore, the use of the chelate solution can control an acid-base reaction, that is, slow the acid-base reaction. In other words, the reaction gradually progresses, so that a nearly spherical secondary particle can be obtained. When a pH is greater than or equal to 9 and less than or equal to 10 or a value in the neighborhood thereof, glycine among chelate agents has an effect of keeping the pH value constant. Therefore, the use of a glycine aqueous solution as the chelate aqueous solution is preferable because it is easy to control the pH in a reaction vessel for obtaining the above composite hydroxide 98. Naturally, a complexing agent may be used in Step S113, in which case ammonia water is preferably used.

### <Step S114>

In Step S113 in FIG. 3A, water is prepared. Note that preparation of water may be optional. The water is preferably pure water.

### <Step S115>

Next, in Step S115 in FIG. 3A, the transition metal M source in Step S111, the chelate agent in Step S113, and the water in Step S114 are mixed. By mixing, an acid solution can be obtained.

### <Step S121>

Next, in Step S121 in FIG. 3A, an alkaline solution is prepared. As the alkaline solution, one or two or more of an aqueous solution containing sodium hydroxide, potassium hydroxide, lithium hydroxide, and ammonia can be used. In the case where an alkaline solution is used as the aqueous solution, for example, one or two or more selected from sodium hydroxide, potassium hydroxide, lithium hydroxide, and ammonia are preferably dissolved in pure water.

### <Step S122>

In Step S122 in FIG. 3A, water is prepared. The water is put in a reaction vessel. Note that preparation of water may be optional. The water is preferably pure water. The use of pure water promotes nucleation, leading to formation of a composite hydroxide with a small particle diameter. The water put in the reaction vessel can be referred to as an adjustment liquid or a filling liquid in the reaction vessel. A chelate aqueous solution may be put in the reaction vessel instead of water. For the case of preparing a chelate solution, refer to the description for Step S113.

### <Step S131>

Next, in Step S131 in FIG. 3A, an acid solution and an alkaline solution are mixed. The mixing refers to reaction of such solutions, and can be referred to as a coprecipitation reaction, a neutralization reaction, or an acid-base reaction.

During mixing of Step S131, the pH of the solution in the reaction vessel is preferably controlled to be higher than or equal to 9.0 and lower than or equal to 11.5. For example, in the case where pure water and an alkaline solution are put in the reaction vessel and an acid solution is dropped thereto, the pH of the aqueous solution in the reaction vessel is preferably controlled to be kept higher than or equal to 9.0 and lower than or equal to 11.5. Alternatively, pure water and an acid solution can be put in the reaction vessel, in which case an alkaline solution is dropped thereto, and the pH of the aqueous solution in the reaction vessel is preferably controlled to be kept higher than or equal to 9.0 and lower than or equal to 11.5. The liquid-delivery speed (also referred to as dropping rate) of the acid solution or the alkaline solution to be dropped is preferably lower than or equal to 0.15 mL/min when 200 mL to 350 mL of the solution is in the reaction vessel, in which case the pH can be easily controlled.

The aqueous solution in the reaction vessel is preferably kept being stirred with a stirring means. As the stirring means, a stirrer, an agitator blade, or the like can be used. The impeller can have two to six blades, for example, when an impeller with four blades is employed, the four blades may be arranged to make a cross shape seen from above. The rotation number of the stirring means may be controlled to be 800 rpm to 1200 rpm, inclusive. A baffle plate may be provided in the reaction vessel in addition to the stirring means. The stirring direction and the flow rate of the aqueous solution can be changed with the use of the baffle plate. The use of the baffle plate improves mixing efficiency and allows synthesis of more uniform composite hydroxide particles.

The temperature of the aqueous solution in the reaction vessel is preferably controlled to be higher than or equal to 50° C. and lower than or equal to 90° C. After the temperature falls within the above temperature range, dropping of the alkaline solution or the acid solution is preferably started.

The reaction vessel preferably has an inert atmosphere. A nitrogen gas or an argon gas can be used as the inert atmosphere at this time. In the case of the nitrogen atmosphere, a nitrogen gas may be introduced into the reaction vessel at a flow rate of 0.5 L/min to 2 L/min, inclusive.

In the reaction vessel, a reflux condenser is preferably placed. The nitrogen gas can be released from the reaction vessel and water vapor can be returned to the reaction vessel with use of the reflux condenser.

The coprecipitation reaction proceeds under such control, so that the composite hydroxide 98 can be obtained. Specifically, the composite hydroxide 98 is precipitated in the aqueous solution of the reaction vessel.

### <Step S132>

Filtration is preferably performed to collect the composite hydroxide 98 in Step S132 in FIG. 3A. The filtration is preferably suction filtration, in which case the aqueous solution in the reaction vessel is poured into a funnel, suction filtration is performed using pure water, and then suction filtration is performed using an organic solvent (e.g., acetone).

### <Step S133>

In Step S133 in FIG. 3A, the composite hydroxide 98 after the filtration is preferably dried. For example, drying is preferably performed in a vacuum at higher than or equal to 60° C. and lower than or equal to 200° C. for longer than or equal to 0.5 hours and shorter than or equal to 20 hours, preferably for 12 hours.

Through the steps described above, the composite hydroxide 98 can be obtained. The composite hydroxide 98 is a hydroxide containing a plurality of kinds of metals and can be referred to as a precursor of the positive electrode active material 100.

### <Step S134>

Next, in Step S134 in FIG. 3A, a lithium source is prepared. For example, when the total of atomic numbers of nickel, cobalt, and manganese is 1, the atomic ratio of lithium is preferably 1.0 or in the neighborhood thereof. Note that the neighborhood of a value includes a value that is 0.95 times or more and 1.05 times or less the value.

As the lithium source, one or two or more selected from lithium hydroxide, lithium carbonate, lithium fluoride, and lithium nitrate can be used, for example. Lithium hydroxide, which has a melting point of 462° C. and is a material having a low melting point among lithium compounds, is preferable as the lithium source. Since a positive electrode active material containing nickel at a high proportion easily causes cation mixing as compared with lithium cobalt oxide or the like, heating in Step S143 and the like needs to be performed at low temperatures. Therefore, a material having a low melting point, such as lithium hydroxide, is preferably used.

The particle diameter of the lithium source is preferably small, in which case a favorable reaction is facilitated. A lithium source that is made into fine particles by fluidized bed jet milling can be used, for example. Here, the particle diameter refers to a median diameter (D50).

### <Step S134>

Next, in Step S134 in FIG. 3A, the composite hydroxide 98 and the lithium source are mixed. The mixing can be performed by a dry method or a wet method. For example, a ball mill or a bead mill can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. When a ball mill or a bead mill is used, the composite hydroxide 98 and the lithium compound are ground in the same step as the mixing in some cases.

### <Step S135>

Next, in Step S135 in FIG. 3A, the mixture of the composite hydroxide 98 and the lithium source are heated. An electric furnace or a rotary kiln furnace can be used as a firing device for the heating. A crucible, a sagger, a setter, or a container (hereinafter referred to as a container) used in the heating is preferably made of a material that hardly releases impurities. For example, a container made of aluminum oxide with a purity of 99.9% is preferably used. In the case of mass production, a container made of mullite cordierite (Al₂O₃·SiO₂·MgO) is preferably used, for example. Furthermore, heating may be performed in a state where the container is covered with a lid.

The heating in Step S135 is preferably performed at a temperature higher than or equal to 600° C. and lower than or equal to 1000° C., further preferably higher than or equal to 650° C. and lower than or equal to 950° C. The time for the heating in Step S135 is preferably longer than or equal to 1 hour and shorter than or equal to 30 hours, further preferably longer than or equal to 2 hours and shorter than or equal to 20 hours.

The heating is preferably performed in an atmosphere containing oxygen or an oxygen-containing atmosphere that is what is called dry air with little water (e.g., with a dew point lower than or equal to −50° C., preferably lower than or equal to −80° C.).

A crushing step may be performed before and after the above-described heating step in Step S135.

Through this step, a lithium composite oxide 99 can be obtained. The lithium composite oxide 99 includes a single crystal and is further preferably a single particle. The lithium composite oxide 99 can be referred to as LiMO₂ (M=Ni, Co, Mn), based on the source materials in Step S111. The lithium composite oxide 99 may be a known general product; specifically, a commercially available positive electrode active material may be used.

### <Step S136>

In Step S136 shown in FIG. 3A, the lithium composite oxide 99 is heated. The heating in Step S136 is initial heating performed on the lithium composite oxide 99, specifically, the first heating, and thus is sometimes referred to as the initial heating. Alternatively, the heating in Step S136 is referred to as preheating or pretreatment in some cases.

Through the initial heating, the lithium composite oxide 99 is smoothed. As described in the above embodiment, smoothing is regarded as making the surface of the lithium composite oxide 99 smooth. A smooth surface includes a state where the lithium composite oxide 99 is rounded as a whole. Furthermore, the smooth surface includes a state where the surface of the lithium composite oxide 99 has few projection portions, i.e., few foreign matters attached thereto. In the initial heating in this step, a flux may be prepared optionally. In other words, when only the lithium composite oxide 99 is subjected to heat treatment, a smooth surface can be obtained.

The initial heating may cause extraction of lithium from part of the lithium composite oxide 99. Typically, lithium in the surface portion of the lithium composite oxide 99 is easily extracted. Note that in the initial heating in this step, the lithium source may or may not be prepared. That is, the lithium source may be prepared optionally.

Although impurities might be mixed into the lithium source prepared in Step S134 and/or the nickel source, the cobalt source, and the manganese source prepared in Step S111, the impurities in the lithium composite oxide 99 can be reduced by the initial heating. Note that in the initial heating in this step, the additive element source may be prepared optionally.

Too short initial heating cannot give a sufficient effect, whereas too long initial heating lowers the productivity. For example, the initial heating conditions can be selected from the conditions described for Step S135. As a supplementary explanation of the heating conditions in Step S13, the heating temperature in the initial heating is preferably lower than that in Step S135 so that the crystal structure of the lithium composite oxide 99 can be maintained. The time of the initial heating is preferably shorter than that of the time in Step S135 so that the crystal structure of the lithium composite oxide 99 can be maintained.

In addition, an effect of increasing the crystallinity of the inner portion of the lithium composite oxide 99 by the initial heating can be expected. In the case of the lithium composite oxide 99 in which differential shrinkage occurs between the surface portion and the inner portion, increasing the crystallinity of the inner portion includes reducing the differential shrinkage. The differential shrinkage is explained here. Since the lithium composite oxide 99 has a volume, the heating in Step S135 might cause a temperature difference between the surface and the inner portion. When the temperature difference occurs, the surface and the inner portion are different in fluidity, and thus differential shrinkage occurs in the lithium composite oxide 99. That is, the differential shrinkage causes distortion in the lithium composite oxide 99.

Thus, the above-described initial heating can reduce differential shrinkage or distortion of the lithium composite oxide 99. It is presumed that the surface of the lithium composite oxide 99 is smoothed by such a phenomenon. The state of the smoothed surface may be expressed as the surface of lithium composite oxide 99 being improved.

Such differential shrinkage causes a shift in a crystal, i.e., a grain boundary, in the lithium composite oxide 99 in some cases. To reduce the shift, the initial heating is preferably performed. The reduction of the shift may be referred to as alignment of crystal grains. It is conceivable that the surface of the lithium composite oxide 99 becomes smooth due to the reduction in the shift.

The lithium composite oxide 99 having a smooth surface is preferably used as the positive electrode active material, in which case cracking of the positive electrode active material through a manufacturing process or charging and discharging can be prevented and deterioration in charging and discharging of the secondary battery can be inhibited.

In the case where a lithium composite oxide synthesized in advance is used as the lithium composite oxide 99, the initial heating enables the lithium composite oxide to have a smooth surface.

Through the steps described above, the positive electrode active material 100 is obtained.

### <<Manufacturing Method 2 of Positive Electrode Active Material>>

A manufacturing method 2 in which an additive element is added is described with reference to FIG. 3B. The manufacturing method 2 includes a step of adding an additive element to a lithium composite oxide 99b, which is the positive electrode active material 100 obtained in the manufacturing method 1.

### <Step S141>

As an additive element source, a compound containing one or two or more selected from titanium, calcium, aluminum, zirconium, magnesium, and fluorine can be used.

### <Inorganic Metal Compound>

As the compound, an inorganic metal compound containing an additive element is described.

As a titanium source, titanium oxide, titanium hydroxide, titanium fluoride, or the like can be used. Two or more of these titanium sources may be used.

As the calcium source, for example, calcium carbonate, calcium fluoride, calcium hydroxide, calcium oxide, or the like can be used. Two or more of these calcium sources may be used.

As the aluminum source, aluminum oxide, aluminum hydroxide, aluminum fluoride, or the like can be used, for example. Two or more of these aluminum sources may be used.

As the zirconium source, zirconium oxide, zirconium hydroxide, zirconium fluoride, or the like can be used, for example. Two or more of these zirconium sources may be used.

As the magnesium source, for example, magnesium fluoride, magnesium oxide, magnesium hydroxide, magnesium carbonate, or the like can be used. Two or more of these magnesium sources may be used.

Magnesium fluoride can be used as both the fluorine source and the magnesium source. Lithium fluoride can also be used as the lithium source.

As the fluorine source, for example, one or two or more of lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), and sodium aluminum hexafluoride (Na₃AlF₆) can be used. Among them, lithium fluoride, which has a relatively low melting point of 848° C., is preferable because it is easily serves as a flux in a heating step of Step S143 or the like described later.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

### <Organometallic Compound>

An organometallic compound is described as the compound. A general formula, which is an example of an organic compound containing an additive element, is as shown in General Formula (G1) below.

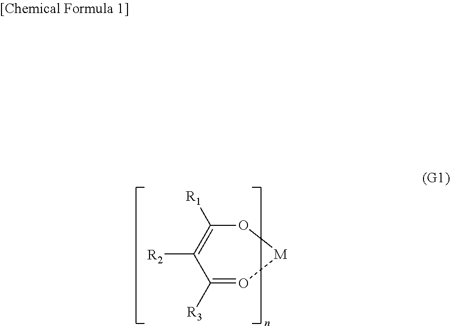

In General Formula (G1) above, R1 to R3 each independently represent hydrogen (including deuterium), a substituted or unsubstituted alkyl group having 1 to 10 carbon atoms, a substituted or unsubstituted cycloalkyl group having 3 to 10 carbon atoms, a substituted or unsubstituted alkyl halide group having 1 to 10 carbon atoms, a substituted or unsubstituted aryl group having 6 to 30 carbon atoms, a substituted or unsubstituted heteroaryl group having 1 to 30 carbon atoms, a halogen, a nitrile group, a substituted or unsubstituted carboxylic ester group having 1 to 30 carbon atoms, a substituted or unsubstituted acyl group having 1 to 10 carbon atoms, or a substituted or unsubstituted ethenyl group having 2 to 10 carbon atoms; n represents an integer of 2 to 4; a plurality of R1s may be different or the same, a plurality of R2s may be different or the same, a plurality of R3s may be different or the same; M represents magnesium, titanium, titanium oxide, or aluminum; and the dashed line represents coordinate bonding.

A general formula, which is another example of an organic compound containing an additive element, is as shown in General Formula (G2) below.

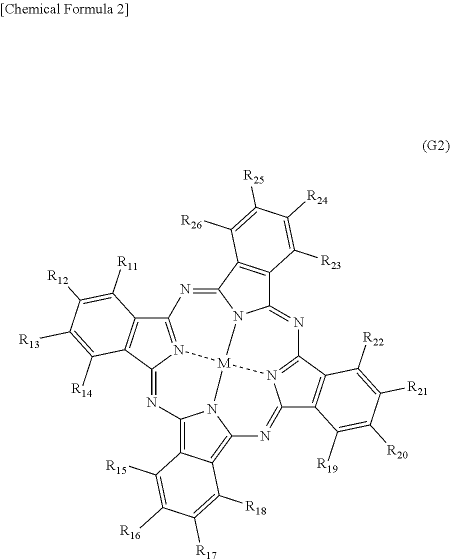

Note that in General Formula (G2) above, M represents magnesium, magnesium oxide, magnesium hydroxide, magnesium halide, aluminum, aluminum oxide, aluminum hydroxide, aluminum halide, titanium, titanium oxide, titanium hydroxide, or titanium halide; the dashed line represents coordinate bonding; R11 to R26 each independently represent hydrogen (including deuterium), a substituted or unsubstituted alkyl group having 1 to 20 carbon atoms, a substituted or unsubstituted cycloalkyl group having 3 to 10 carbon atoms, a substituted or unsubstituted haloalkyl group having 1 to 20 carbon atoms, or a substituted or unsubstituted alkoxy group having 1 to 20 carbon atoms; and H₂O or H₃O⁺ may be bonded or coordinated to M or a ketone compound such as acetone or a skeleton having a heterocycle such as pyridine may be bonded to or coordinated to M.

When magnesium is selected as the additive element, a magnesium source (Mg source) can be prepared as the additive element source shown in Step S141. As the magnesium source, a compound containing magnesium is used. When an organometallic compound rather than the above-described inorganic metal compound is used as the compound, the temperature in a heating step described later can be lowered, which is preferable in terms of process simplification, and it is preferable to use an alkyl diketone complex as the organometallic compound. As the alkyl diketone, acetylacetone or an acetylacetonate complex is preferably used. When alkyl diketone in a solid state and the lithium composite oxide 99 are mixed and then heated, magnesium can be added to the lithium composite oxide 99. The acetylacetonate complex in the state of being dissolved or mixed in an organic solvent is preferably used, in which case magnesium can be uniformly added to the lithium composite oxide 99. In particular, in the case where a slight amount of magnesium is added, a magnesium source in a state in which an acetylacetonate complex or the like is dissolved or mixed in an organic solvent is preferably prepared, in which case the total amount of the magnesium source can be increased. As the organic solvent, acetone or alcohol such as ethanol or isopropanol (an alcohol of isopropanol is typically an isopropyl alcohol) is preferably used. When a solution containing an organometallic compound dissolved or mixed in an organic solvent is applied to the lithium composite oxide 99, the rate of the solution can also be controlled using a boiling point of the organic solvent. By using the boiling point of the organic solvent, the solution can be applied uniformly. By the uniform application, the solution can be attached to the lithium composite oxide 99 so as to be in a film-like state. Therefore, magnesium or the like can be uniformly distributed in the lithium composite oxide 99. As such an acetylacetonate complex containing magnesium, typically, magnesium acetylacetonate can be used. In addition, a hydrate of an acetylacetonate complex may be used. The use of the hydrate enables dissolution or mixing even when water is used instead of the organic solvent. The structural formula of magnesium acetylacetonate is as shown in Structural Formula (H11) below. Note that in Structural Formula (H11), the dashed line represents coordinate bonding.

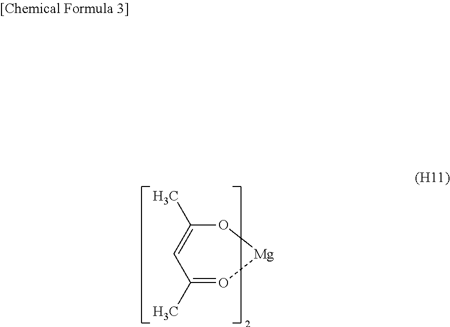

As another organometallic compound, lactate or ammonium lactate is preferably used. When lactate or ammonium lactate in a solid state and the lithium composite oxide 99 are mixed and then heated, magnesium can be added to the lithium composite oxide 99. In addition, lactate or ammonium lactate in a state of being dissolved in water is preferably used, in which case magnesium can be uniformly added to the lithium composite oxide 99. In particular, in the case where a slight amount of magnesium is added, a magnesium source in a state in which lactate or ammonium lactate is dissolved in water is preferably prepared, in which case the total amount of the magnesium source can be increased. As such lactate containing magnesium, typically, magnesium lactate can be used.

Furthermore, it is preferable to use a phthalocyanine complex as another organometallic compound. The phthalocyanine complex of magnesium in a solid state and the lithium composite oxide 99 are mixed and then heated, whereby magnesium can be added to the lithium composite oxide 99. Preferably, the phthalocyanine complex in a state of being dissolved in an organic solvent may be used, in which case magnesium can be uniformly added to the lithium composite oxide 99. In particular, in the case where a slight amount of magnesium is added, a magnesium source in a state in which a phthalocyanine complex or the like is dissolved in an organic solvent is preferably prepared, in which case the total amount of the magnesium source can be increased. Toluene is preferably used as the organic solvent. As such a phthalocyanine complex containing magnesium, typically, magnesium phthalocyanine can be used. The structural formula of magnesium phthalocyanine is as shown in Structural Formula (H31) below. Note that in Structural Formula (H31), the dashed line represents coordinate bonding.

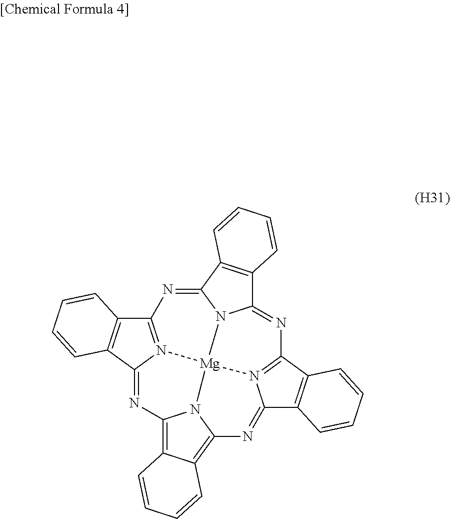

Note that two or more of the above organometallic compounds may be used for the magnesium source.

Unlike an inorganic metal compound such as magnesium fluoride, the above organometallic compounds do not contain fluorine. The above organometallic compounds are stable in the air. Thus, the above-described organometallic compounds are easy to handle and thus productivity is improved. An improvement in productivity is expected to shorten the process time.

Nickel can also be selected as the additive element. When nickel is selected, a nickel source can be prepared as the additive element source shown in Step S141. As the nickel source, a compound containing nickel is used. Although an inorganic metal compound may be used as the compound, the use of an organometallic compound is preferable in terms of process simplification because the temperature in a heating step described later can be lowered, and it is preferable to use an alkyl diketone complex as the organometallic compound. As the alkyl diketone, acetylacetone or an acetylacetonate complex is preferably used. When alkyl diketone in a solid state and the lithium composite oxide 99 are mixed and then heated, nickel can be added to the lithium composite oxide 99. The acetylacetonate complex in the state of being dissolved or mixed in an organic solvent is preferably used, in which case nickel can be uniformly added to the lithium composite oxide 99. In particular, in the case where a slight amount of nickel is added, a nickel source in a state in which an acetylacetonate complex or the like is dissolved or mixed in an organic solvent is preferably prepared, in which case the total amount of the nickel source can be increased. As the organic solvent, acetone or alcohol such as ethanol or isopropanol (an alcohol of isopropanol is typically an isopropyl alcohol) is preferably used. When a solution containing an organometallic compound dissolved or mixed in an organic solvent is applied to the lithium composite oxide 99, the rate of the solution can also be controlled using a boiling point of the organic solvent. By using the boiling point of the organic solvent, the solution can be applied uniformly. By the uniform application, the solution can be attached to the lithium composite oxide 99 so as to be in a film-like state. Therefore, nickel or the like can be uniformly distributed in the lithium composite oxide 99. As such an acetylacetonate complex containing nickel, typically, nickel acetylacetonate can be used. The structural formula of nickel acetylacetonate is as shown in Structural Formula (H12) below.

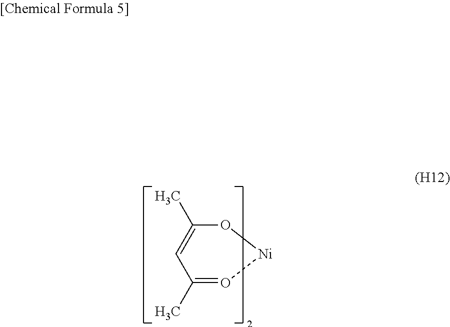

As another organometallic compound, lactate or ammonium lactate is preferably used. When lactate or ammonium lactate in a solid state and a lithium cobalt oxide are mixed and then heated, nickel can be added to the lithium cobalt oxide. In addition, lactate or ammonium lactate in a state of being dissolved in water is preferably used, in which case nickel can be uniformly added to the lithium cobalt oxide. In particular, in the case where a slight amount of nickel is added, a nickel source in a state in which lactate or ammonium lactate is dissolved in water is preferably prepared, in which case the total amount of the nickel source can be increased. As such lactate containing nickel, typically, nickel lactate can be used.

Furthermore, it is preferable to use a phthalocyanine complex as another organometallic compound. The phthalocyanine complex in a solid state and the lithium cobalt oxide are mixed and then heated, whereby nickel can be added to the lithium cobalt oxide. The phthalocyanine complex in a state of being dissolved in an organic solvent is preferably used, in which case nickel can be uniformly added to the lithium cobalt oxide. In particular, in the case where a slight amount of nickel is added, a nickel source in a state in which a phthalocyanine complex or the like is dissolved in an organic solvent is preferably prepared, in which case the total amount of the nickel source can be increased. Toluene is preferably used as the organic solvent. As such a phthalocyanine complex containing nickel, typically, nickel phthalocyanine can be used. The structural formula of nickel phthalocyanine is as shown in Structural Formula (H32) below.

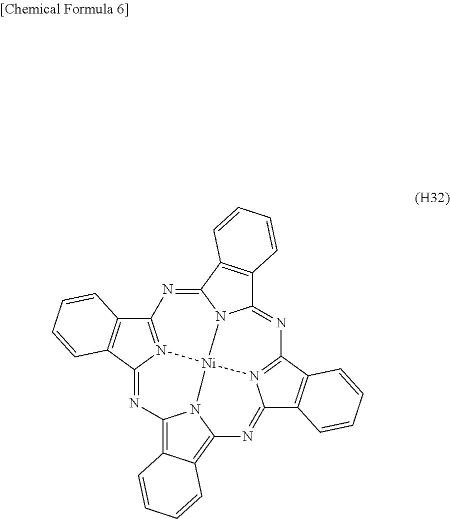

Note that two or more of the above organometallic compounds can also be used as the nickel source.

When aluminum is selected as the additive element, an aluminum source can be prepared as the additive element source shown in Step S141. As the aluminum source, a compound containing aluminum is used. Although the above-described inorganic metal compound may be used as the compound, the use of the organometallic compound is preferable in terms of process simplification because the temperature in a heating step described later can be lowered, and it is preferable to use an alkyl diketone complex as the organometallic compound. As the alkyl diketone, acetylacetone or an acetylacetonate complex is preferably used. When alkyl diketone in a solid state and the lithium composite oxide 99 are mixed and then heated, aluminum can be added to the lithium composite oxide 99. The acetylacetonate complex in the state of being dissolved or mixed in an organic solvent is preferably used, in which case aluminum can be uniformly added to the lithium composite oxide 99. In particular, in the case where a slight amount of aluminum is added, an aluminum source in a state in which an acetylacetonate complex or the like is dissolved or nixed in an organic solvent is preferably prepared, in which case the total amount of the aluminum source can be increased. As the organic solvent, acetone or alcohol such as ethanol or isopropanol (an alcohol of isopropanol is typically an isopropyl alcohol) is preferably used. When a solution containing an organometallic compound dissolved or mixed in an organic solvent is applied to the lithium composite oxide 99, the rate of the solution can also be controlled using a boiling point of the organic solvent. By using the boiling point of the organic solvent, the solution can be applied uniformly. By the uniform application, the solution can be attached to the lithium composite oxide 99 so as to be in a film-like state. Therefore, aluminum or the like can be uniformly distributed in the lithium composite oxide 99. As such an acetylacetonate complex containing aluminum, typically, aluminum acetylacetonate can be used. The structural formula of aluminum acetylacetonate is as shown in Structural Formula (H13) below. Note that in Structural Formula (H13), the dashed line represents coordinate bonding.

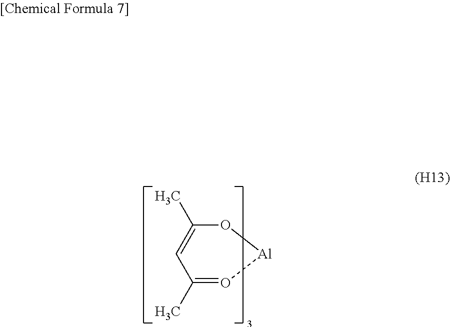

As another organometallic compound, lactate or ammonium lactate is preferably used. When lactate or ammonium lactate in a solid state and the lithium composite oxide 99 are mixed and then heated, aluminum can be added to the lithium composite oxide 99. In addition, lactate or ammonium lactate dissolved in water is preferably used, in which case aluminum can be uniformly added to the lithium composite oxide 99. In particular, in the case where a slight amount of aluminum is added, an aluminum source in a state in which ammonium lactate is dissolved in water is preferably prepared, in which case the total amount of the aluminum source can be increased. As such ammonium lactate containing aluminum, typically, aluminum lactate can be used.

Furthermore, it is preferable to use a phthalocyanine complex as another organometallic compound. The phthalocyanine complex in a solid state and the lithium composite oxide 99 are mixed and then heated, whereby aluminum can be added to the lithium composite oxide 99. The phthalocyanine complex dissolved in an organic solvent is preferably used, in which case aluminum can be uniformly added to the lithium composite oxide 99. In particular, in the case where a slight amount of aluminum is added, an aluminum source in a state in which a phthalocyanine complex or the like is dissolved or mixed in an organic solvent is preferably prepared, in which case the total amount of the aluminum source can be increased. Toluene is preferably used as the organic solvent. As such a phthalocyanine complex containing aluminum, typically, one or two or more selected from phthalocyanine aluminum, aluminum phthalocyanine halide, and aluminum phthalocyanine hydroxide can be used. The structural formula of phthalocyanine aluminum is as shown in Structural Formula (H33) below or Structural Formula (H34) below. Note that in Structural Formula (H33), the dashed line represents coordinate bonding.

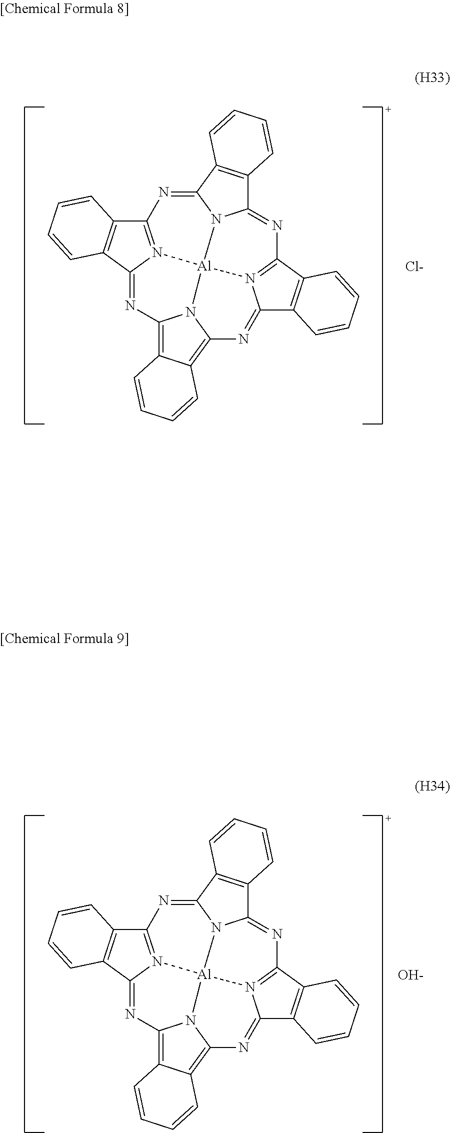

Note that two or more of the above organometallic compounds can also be used as the aluminum source.

When titanium is selected as the additive element, a titanium source is prepared as the additive element source shown in Step S40. A compound containing titanium is used as the titanium source. Although the above-described inorganic metal compound may be used as the compound, the use of the organometallic compound is preferable in terms of process simplification because the temperature in a heating step described later can be lowered, and it is preferable to use an alkyl diketone complex as the organometallic compound. As the alkyl diketone, acetylacetone or an acetylacetonate complex is preferably used. When alkyl diketone in a solid state and the lithium composite oxide 99 are mixed and then heated, titanium can be added to the lithium composite oxide 99. The acetylacetonate complex dissolved or mixed in an organic solvent is preferably used, in which case titanium can be uniformly added to the lithium composite oxide 99. In particular, in the case where a slight amount of titanium is added, a titanium source in a state in which an acetylacetonate complex or the like is dissolved or mixed in an organic solvent is preferably prepared, in which case the total amount of the titanium source can be increased. As the organic solvent, acetone or alcohol such as ethanol or isopropanol (an alcohol of isopropanol is typically an isopropyl alcohol) is preferably used. When a solution containing an organometallic compound dissolved or mixed in an organic solvent is applied to the lithium composite oxide 99, the organic solvent can also be evaporated. By using evaporation of the organic solvent, the solution can be applied uniformly. By the uniform application, the solution can be attached to the lithium composite oxide 99 so as to be in a film-like state. Therefore, titanium or the like can be uniformly distributed in the lithium composite oxide 99. As such an acetylacetonate complex containing titanium, typically, titanyl acetylacetonate can be used. The structural formula of titanium acetylacetonate is represented by Structural Formula (H14) below. Note that in Structural Formula (H14), the dashed line represents coordinate bonding.

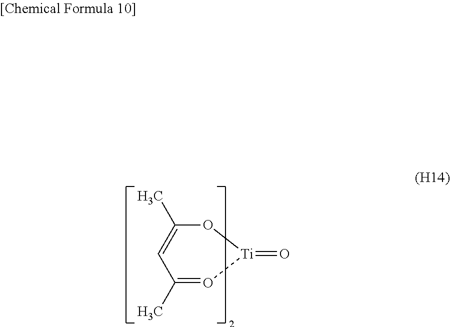

As another organometallic compound, lactate or ammonium lactate is preferably used. When lactate or ammonium lactate in a solid state and the lithium composite oxide 99 are mixed and then heated, titanium can be added to the lithium composite oxide 99. In addition, lactate or ammonium lactate dissolved in water is preferably used, in which case titanium can be uniformly added to the lithium composite oxide 99. In particular, in the case where a slight amount of titanium is added, a titanium source in a state in which lactate or ammonium lactate is dissolved in water is preferably prepared, in which case the total amount of the titanium source can be increased. As such ammonium lactate containing titanium, typically, titanium lactate can be used.

Furthermore, it is preferable to use a phthalocyanine complex as another organometallic compound. The phthalocyanine complex in a solid state and the lithium composite oxide 99 are mixed and then heated, whereby titanium can be added to the lithium composite oxide 99. The phthalocyanine complex in a state of being dissolved in an organic solvent is preferably used, in which case magnesium can be uniformly added to the lithium composite oxide 99. In particular, in the case where a slight amount of titanium is added, a titanium source in a state in which a phthalocyanine complex or the like is dissolved or mixed in an organic solvent or water is preferably prepared, in which case the total amount of the titanium source can be increased. Toluene is preferably used as the organic solvent. As such a phthalocyanine complex containing titanium, typically, titanyl phthalocyanine can be used. The structural formula of titanyl phthalocyanine is as shown in Structural Formula (H35) below. Note that in Structural Formula (H35), the dashed line represents coordinate bonding.

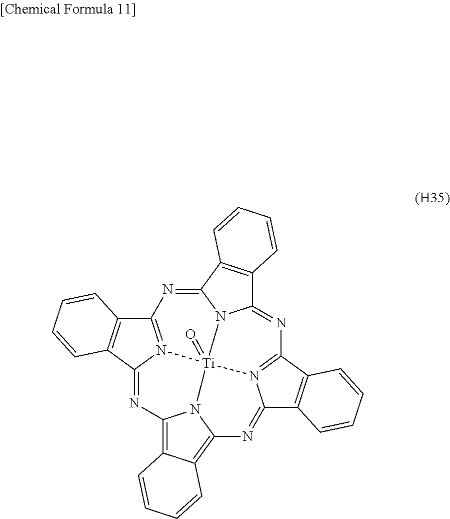

Note that two or more of the above organometallic compounds can also be used as the titanium source.

An oxide or a hydroxide is preferably used as the inorganic compound containing the above-described additive element.

The above organometallic compounds are stable in the air. Thus, the organometallic compounds are each easily handled, and the use of such an organometallic compound increases productivity. An improvement in productivity is expected to shorten the process time.

In Step S141 shown in FIG. 3B, a lithium source may be prepared in addition to the additive element source. The lithium source is as described in Step S134.

### <Step S142>

Next, in Step S142 in FIG. 3B, the lithium composite oxide 99 and the additive element source are mixed. The mixing can be performed by a dry method or a wet method. For example, a ball mill, a bead mill, or the like can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material.

### <Step S143>

Next, in Step S143 in FIG. 3B, the mixture of the lithium composite oxide 99 and the additive element source is heated. For the heating conditions of this step, any of the heating conditions described for Step S135 can be selected.

Through the above process, a positive electrode active material 100b is obtained.

### <<Manufacturing Method 3 of Positive Electrode Active Material>>

Although FIG. 3B illustrates the manufacturing method including one step of adding the additive element source, one embodiment of the present invention is not limited thereto. The additive element source may be added in a plurality of steps. A method for manufacturing a positive electrode active material where two separate steps of adding an additive element source are performed is described with reference to FIG. 4. Differences from the manufacturing method described with reference to FIG. 3B will be mainly described.

### <Step S111 to Step S133>

First, as in FIG. 3A, the composite hydroxide 98 is formed through Step S111 to Step S133. Note that in Step S134, an additive element source is prepared together with the lithium source in Step S134. That is, the first additive element is prepared in this step. As the additive element source, the additive element source described with reference to FIG. 3B can be used.

### <Step S141 to Step S143>

Next, through steps similar to Step S142 to Step S143 in FIG. 3B, a lithium composite oxide 99c is obtained. The lithium composite oxide 99c includes a single crystal and is further preferably a single particle. The lithium composite oxide 99c can be expressed as LiMO₂A (M=Ni, Co, Mn, A=Ti, Ca, Al, Zr, Mg, F), based on the source materials and the additive element source in Step S111. As the lithium composite oxide 99c, a known general product, i.e., a commercially available positive electrode active material may be used.

### <Step S144>

In Step S144 shown in FIG. 4, the lithium composite oxide 99b is heated. The heating in Step S144 is initial heating performed on the lithium composite oxide 99c, specifically, the first heating, and thus is sometimes referred to as the initial heating as in Step S136. Alternatively, the heating in Step S144 is referred to as preheating or pretreatment in some cases.

Through the initial heating, the lithium composite oxide 99c is smoothed. As described in the above embodiment, smoothing is regarded as making the surface of the lithium composite oxide 99c smooth. A smooth surface includes a state where the lithium composite oxide 99c is rounded as a whole. Furthermore, the smooth surface includes a state where the surface of the lithium composite oxide 99c has few projections, i.e., few foreign matters attached thereto. In the initial heating in this step, a flux may be prepared optionally. In other words, when only the lithium composite oxide 99c is subjected to heat treatment, a smooth surface can be obtained.

The initial heating may cause extraction of lithium from part of the composite oxide 99c. Typically, lithium in the surface portion of the lithium composite oxide 99c is easily extracted. Note that in the initial heating in this step, the lithium source may or may not be prepared. That is, the lithium source may be prepared optionally.

Although impurities might be mixed into the lithium source prepared in Step S134 and/or the nickel source, the cobalt source, and the manganese source prepared in Step S111, the impurities in the lithium composite oxide 99c can be reduced by the initial heating. Note that in the initial heating in this step, the additive element source may be prepared optionally.

Too short initial heating cannot give a sufficient effect, whereas too long initial heating lowers the productivity. For example, the initial heating conditions can be selected from the conditions described for Step S135. As a supplementary explanation of the heating conditions in Step S13, the heating temperature in the initial heating is preferably lower than that in Step S143 so that the crystal structure of the lithium composite oxide 99c can be maintained. The time of the initial heating is preferably shorter than the time in Step S143 so that the crystal structure of the lithium composite oxide 99c can be maintained.

In addition, an effect of increasing the crystallinity of the inner portion of the lithium composite oxide 99c by the initial heating can be expected. In the case of the lithium composite oxide 99c in which differential shrinkage occurs between the surface portion and the inner portion, increasing the crystallinity of the inner portion includes reducing the differential shrinkage. The differential shrinkage is explained here. Since the lithium composite oxide 99b has a volume, the heating in Step S143 might cause a temperature difference between the surface and the inner portion. When the temperature difference occurs, the surface and the inner portion are different in fluidity, and thus differential shrinkage occurs in the lithium composite oxide 99c. That is, the differential shrinkage causes distortion in the lithium composite oxide 99b.

Thus, the above-described initial heating can reduce differential shrinkage or distortion of the lithium composite oxide 99c. It is presumed that the surface of the lithium composite oxide 99b is smoothed by such a phenomenon. The state of the smoothed surface may be expressed as the surface of lithium composite oxide 99c being improved.

Such differential shrinkage causes a shift in a crystal, i.e., a grain boundary, in the lithium composite oxide 99c in some cases. To reduce the shift, the initial heating is preferably performed. The reduction of the shift may be referred to as alignment of crystal grains. It is conceivable that the surface of the lithium composite oxide 99c becomes smooth due to the reduction in the shift.

The lithium composite oxide 99c having a smooth surface is preferably used as the positive electrode active material, in which case cracking of the positive electrode active material through a manufacturing process or charging and discharging can be prevented and deterioration in charging and discharging of the secondary battery can be inhibited.

In the case where a commercially available lithium composite oxide, that is, a well-known product, is used as the lithium composite oxide 99c, the initial heating enables the lithium composite oxide to have a smooth surface.

Through the steps described above, a lithium composite oxide 99d is obtained.

### <Step S151>

In Step S151 in FIG. 4, an additive element source is prepared. For the additive element source, the description of Step S141 can be referred to. The additive element source selected in Step S1511 is preferably different from the additive element source in Step S141.

### <Step S152>

Next, in Step S152 in FIG. 4, the lithium composite oxide 99d and the additive element source are mixed. For the mixing, the description of Step S142 can be referred to.

### <Step S153>

Next, in Step S153 in FIG. 4, the mixture of the lithium composite oxide 99d and the additive element source is heated. Heating in Step S153 is preferably performed at a sufficiently high temperature to increase the crystallite size of the positive electrode active material 100. The temperature range may depend on the composition of the transition metal M.

In the case where the proportion of nickel in the transition metal M is high, e.g., higher than or equal to 70% in the lithium composite oxide 99d, the temperature is preferably higher than or equal to 750° C. Meanwhile, if the heating temperature in Step S153 is too high, it might cause reduction of the transition metal M such as nickel to the divalent state, for example. Accordingly, the heating temperature is preferably lower than or equal to 950° C., further preferably lower than or equal to 920° C., still further preferably lower than or equal to 900° C., for example.

In the case where the proportion of nickel used as the transition metal M is higher than 0% and lower than 70%, the heating temperature is preferably higher than or equal to 850° C., further preferably higher than or equal to 900° C., still further preferably lower than or equal to 1000° C., for example. Meanwhile, if the heating temperature in Step S153 is too high, it might cause a disadvantage similar to the above; thus, the heating temperature is preferably lower than or equal to 1050° C. For the other conditions of the heating, the description of Step S143 can be referred to.

A crushing step may be performed before and after the above-described heating step in Step S153.

Although the method in which heating is performed in Step S153 after the additive element source is mixed in Step S151 is described with reference to FIG. 4, one embodiment of the present invention is not limited thereto. Heating may be performed twice or more as the heating in Step S153.

Through the steps described above, a positive electrode active material 100c can be manufactured.

Although this embodiment describes the manufacturing method in which the additive element is added together with the lithium source or after the lithium source is added, one embodiment of the present invention is not limited thereto, and the additive element may be added in another step. For example, an additive element may be added together with the transition metal M source. Alternatively, the additive element may be added in a step after a composite oxide containing lithium and the transition metal M is formed. The additive element may be added to a composite oxide containing lithium and the transition metal M, which is obtained beforehand. By changing the step of adding the additive element, the profile of the additive element in the depth direction of the positive electrode active material can be changed in some cases.

This embodiment can be freely combined with any of the other embodiments.

The steps are preferably performed in accordance with the procedure of the steps described in this embodiment, in which case the smoothness of the surface obtained by the initial heating can be maintained. That is, the surface of the positive electrode active material 100 of one embodiment of the present invention becomes smooth. A positive electrode active material with a smooth surface is unlikely to crack, and a secondary battery including the positive electrode active material 100 is expected to have improved cycle performance.

Since the additive element is added in the manufacturing methods 2 and 3, the cycle performance is further improved. Since the additive element is added to the lithium composite oxide that has become smoother, the additive element is distributed appropriately.

### <<Manufacturing Method 4 of Positive Electrode Active Material>>

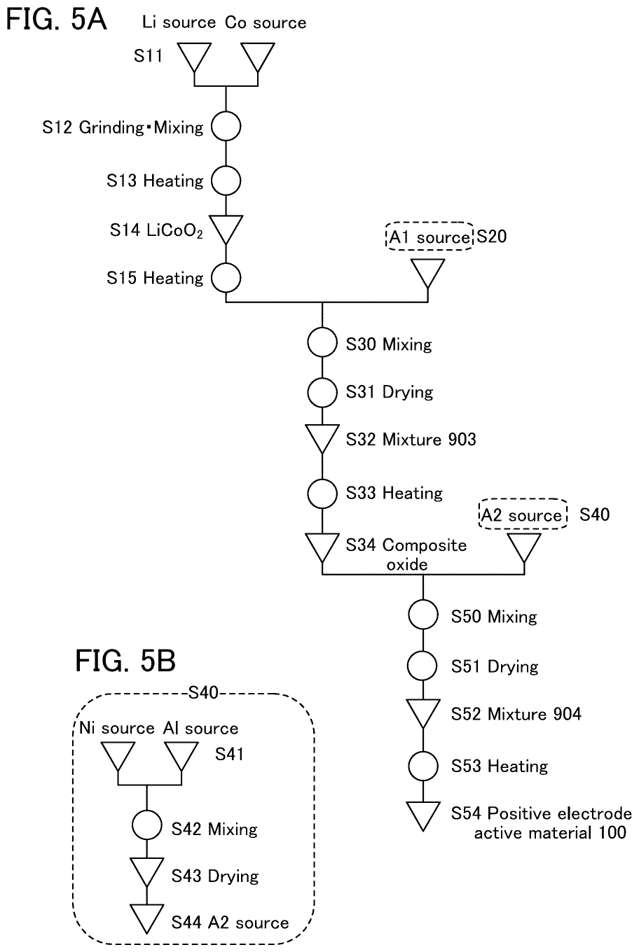

In a manufacturing method 4, a method for manufacturing the positive electrode active material 100, including the initial heating, is described with reference to FIG. 5 and the like. As the manufacturing method 4, an example of a method for manufacturing a positive electrode active material containing a lithium cobalt oxide is shown

### <Step S11>

In Step S11 shown in FIG. 5A, a cobalt source (denoted as Co source in the drawing) and a lithium source (denoted as Li source in the drawing) are prepared. Needless to say, one or two or more selected from a cobalt source, a nickel source, a manganese source, and an aluminum source can be used in Step S11 in accordance with the positive electrode active material. Note that the cobalt source, the lithium source, and the like shown in Step S11 can be referred to as starting materials of the lithium cobalt oxide. That is, the source materials shown in Step S11 can be referred to as starting materials of the composite oxide containing lithium and a transition metal.

As the lithium source, a lithium-containing compound is preferably used and for example, one or two or more of lithium carbonate, lithium hydroxide, lithium oxide, lithium nitrate, and lithium fluoride can be used. The lithium source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example.

As the cobalt source, a cobalt-containing compound is preferably used, and for example, one or two or more cobalt oxide, cobalt carbonate, and cobalt hydroxide can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities in the positive electrode active material can be reduced by using a high-purity material as a starting material. As a result, a secondary battery with an increased capacity and/or increased reliability can be obtained.

In addition, the lithium source and the cobalt source preferably have high crystallinity. For example, the lithium source preferably includes a single crystal. For example, the cobalt source preferably includes a single crystal. For evaluation of the crystallinity of the lithium source and the cobalt source, a TEM (transmission electron microscope) image, a STEM (scanning transmission electron microscope) image, a HAADF-STEM (high-angle annular dark-field scanning transmission electron microscope) image, or an ABF-STEM (annular bright-field scanning transmission electron microscope) image, or X-ray diffraction (XRD), electron diffraction, or neutron diffraction can be used as an evaluation means.

### <Step S12>

Next, in Step S12 shown in FIG. 5A, the lithium source and the cobalt source are ground and mixed to form a mixed material (also referred to as a mixture). The grinding and mixing can be performed by a dry method or a wet method. A wet method is preferable because the lithium source and the cobalt source can be ground to a smaller size. When a wet method is employed, a solvent is prepared. As the solvent, ketone such as acetone, alcohol such as ethanol or isopropanol, ether, dioxane, acetonitrile, N-methyl-2-pyrrolidone (NMP), or the like can be used. The solvent preferably has a high purity and is preferably higher than or equal to 99.5%, for example. Typically, acetone with a water content of 10 ppm or less and a purity of 99.5% or higher (referred to as dehydrated acetone) is preferably used. The use of a solvent having high purity is preferable because impurities that might be mixed into the mixed material can be reduced.

A ball mill, a bead mill, or the like can be used for the grinding and mixing. When a ball mill is used, aluminum oxide balls or zirconium oxide balls are preferably used as a medium. Zirconium oxide balls are preferable because they release fewer impurities such as zirconium to a composite oxide. In order to inhibit contamination from the media, the peripheral speed at the time of grinding and mixing is preferably higher than or equal to 100 mm/s and lower than or equal to 2000 mm/s. For example, when the number of rotations is set to 400 rpm when the diameter of the ball mill is 40 mm, the peripheral speed is 838 mm/s, which is preferable as one condition for inhibiting contamination.

### <Step S13>

Next, the above mixture is heated in Step S13 shown in FIG. 5A. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the cobalt source. An excessively high temperature might lead to sublimation of lithium from the lithium source and/or excessive reduction of cobalt, for example. For example, when lithium is sublimated, lithium in lithium cobalt oxide is deficient in some cases. An oxygen vacancy or the like might be induced in lithium cobalt oxide by a change of trivalent cobalt into divalent cobalt, for example. The heating may be performed in an oxygen-containing atmosphere to inhibit oxygen defects.

When the heating time is too short, lithium cobalt oxide is not easily synthesized, but when the heating time is too long, the productivity is lowered. Thus, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature raising rate is preferably 200° C./h.

The heating is preferably performed in an atmosphere with little water. For example, an atmosphere including a dry air is preferable, typically, an atmosphere with a dew point lower than or equal to −50° C., further preferably lower than or equal to −80° C., still further preferably, approximately −93° C. is preferable. To reduce impurities that might enter lithium cobalt oxide, the concentrations of impurities such as CH₄, CO, CO₂, and H₂ in the heating atmosphere are each preferably lower than or equal to 5 ppb (parts per billion).

For conditions of synthesizing the lithium cobalt oxide, an atmosphere containing oxygen as well as little water is preferable as the heating atmosphere. For example, by continuously introducing dry air into a reaction chamber or a furnace, the reaction chamber or the furnace can have an atmosphere containing oxygen with little water. In this case, the flow rate of a dry air can be higher than or equal to 8 L/min and 15 L/min, preferably higher than or equal to 10 L/min and lower than or equal to 12 L/min. Continuously introducing a gas into a reaction chamber or a furnace to make the gas flow therein is referred to as flow.

The heating may be performed in an oxygen-containing atmosphere. In addition to the above-described flow, the reaction chamber or the furnace can be made to have an oxygen-containing atmosphere by a method in which the pressure in the reaction chamber or the furnace is reduced, the chamber is filled with oxygen, and the oxygen is prevented from entering and exiting from the reaction chamber or the furnace. For example, the pressure in the reaction chamber or the furnace may be reduced to −970 hPa read by a differential pressure gauge, and then, the reaction chamber may be filled with oxygen until the pressure becomes 50 hPa. The oxygen may be a dry air, and the reaction chamber or the furnace can have an atmosphere containing oxygen with little water. A method in which a reaction chamber or a furnace is filled with a gas and then the gas is prevented from entering and exiting is referred to as purge.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. The advantage of heating with a rotary kiln is that heating with stirring can be performed in either case of a sequential rotary kiln or a batch-type rotary kiln.

A crucible or a sagger in which a material is to be put is preferably prepared at the time of the heating. A crucible or a saggar made of aluminum oxide or zirconium oxide is preferably used. A crucible or a saggar made of aluminum oxide is preferable, which are less likely to release impurities to the positive electrode active material (typically, lithium cobalt oxide). Furthermore, a crucible or a saggar is preferably highly purified, and typically, a crucible or a saggar made of an aluminum oxide having a purity of 99.9% or a zirconium oxide having a purity of 99.9% can be used. The crucible or the saggar can be provided with a lid, and heating the crucible or the sagger covered with the lid can prevent sublimation of a material.

A used crucible or sagger is preferred to a new crucible or sagger. A new crucible or saggar in this step refers to a crucible or sagger that is subjected to heating two or less times with a material containing a lithium source and a material containing a cobalt source contained therein. A used crucible or saggar in this step refers to a crucible or sagger that is subjected to heating three or more times with a material containing a lithium source and a material containing a cobalt source contained therein. The use of a new crucible or saggar might cause absorption, diffusion, transfer, and/or attachment of part of the lithium source into the crucible or saggar. When part of the lithium source is lost in this manner, lithium cobalt oxide is less likely to be synthesized. Meanwhile, a used crucible or saggar is preferably used, in which case the above-described risk is reduced.

After the heating, crushing may be performed as needed. Furthermore, sieving may be performed in addition to crushing.

In this manner, the heating in Step S13 can be performed. Note that the conditions described in Step S13 can be applied to a heating step other than the above-described step S13. Thus, the conditions described in Step S13 are not described again in the heating step other than Step S13 in some cases.

### <Step S14>

Through the above steps, lithium cobalt oxide (LiCoO₂) can be synthesized in Step S14 in FIG. 5A. Although the description is made using lithium cobalt oxide in this embodiment, it is acceptable as long as the composite oxide containing lithium and a transition metal can be synthesized in Step S14. Although an example of manufacturing lithium cobalt oxide by a solid phase method as in Step S11 to Step S14 is described in this embodiment, a composite oxide containing lithium and a transition metal, such as lithium cobalt oxide, may be formed by a liquid phase method, typically a coprecipitation method.

Furthermore, pre-synthesized lithium cobalt oxide may be used in Step S14. In other words, a pre-synthesized composite oxide containing lithium and a transition metal may be used in Step S14. This is preferable because Step S11 to Step S13 can be omitted, leading to higher productivity.

In the composite oxide containing lithium and a transition metal, such as lithium cobalt oxide, used in Step S14, the concentration of an element other than the main components is preferably within a certain range. In this embodiment, the concentrations of elements are described using lithium cobalt oxide as an example. Note that elements as main components of lithium cobalt oxide mean lithium, oxygen, and cobalt, and elements other than the main component mean elements other than lithium, oxygen, and cobalt. The element corresponding to the additive element described later can be regarded as an element other than the main components; however, the concentration of the element corresponding to the additive element may be out of a certain range.

When lithium cobalt oxide is analyzed by glow discharge mass spectrometry (GD-MS), the concentration of each element can be obtained. Table 1 to Table 3 show the concentrations of elements in four kinds of lithium cobalt oxide (a material Sm-1, a material Sm-2, a material Sm-3, and a material Sm-4). For easy viewing, one table is divided into Table 1 to Table 3. In addition, “Matrix” in the table means a main component; “Binder” means an auxiliary electrode; “Source” means being influenced by a member of a measurement apparatus; “<” means a value below the lower detection limit, and “s” means that an interfering element overlaps but is less than or equal to a numerical value; “~” means that a variation is seen or an interfering element partly overlaps but means a semi-quantitative value. The measurement value of each element obtained in ppm weight can be converted into atomic % by multiplying the measurement value by the atomic weight of each element and expressing the result in percentage.

TABLE 1
[ppm wt]

| Element | Sm-1 | Sm-2 | Sm-3 | Sm-4 |
|---|---|---|---|---|
| Mg | 30 | 25 | 44 | 800 |
| Ni | 18 | 7.4 | 140 | 0.42 |
| Al | 57 | 67 | 67 | 19 |
| Ti | 39 | ~3100 | 5.1 | 2.7 |
| Mn | 7.4 | 10 | 4.4 | 0.56 |
| F | 9.4 | 3.4 | 35 | 110 |
| P | 12 | 13 | 5.6 | 11 |
| Li | Matrix | Matrix | Matrix | Matrix |
| Co | Matrix | Matrix | Matrix | Matrix |
| O | Matrix | Matrix | Matrix | Matrix |
| Be | <0.01 | <0.01 | <0.01 | <0.01 |
| B | 2.5 | 4.3 | 1.5 | 6.6 |
| Na | 54 | 49 | 40 | 48 |
| Si | 94 | 44 | 80 | 37 |
| S | 67 | 520 | 340 | 580 |
| Cl | ~9.4 | ~6.7 | ~6.7 | 6.4 |

TABLE 2
[ppm wt]

| Element | Sm-1 | Sm-2 | Sm-3 | Sm-4 |
|---|---|---|---|---|
| K | 3.7 | 3.8 | 3.8 | 1 |
| Ca | 26 | 250 | 87 | 280 |
| Sc | <0.01 | 0.02 | 0.03 | <0.01 |
| V | 0.02 | 0.02 | 0.05 | 0.04 |
| Cr | 4.7 | 8 | 8 | 1.1 |
| Fe | 14 | 19 | 48 | 2.8 |
| Cu | 0.45 | 0.94 | 6.4 | 0.11 |
| Zn | 1.2 | <0.5 | 0.87 | <0.5 |
| Ga | <0.1 | <0.1 | <0.1 | <0.1 |
| Ge | <0.5 | <0.5 | <0.5 | <0.5 |
| As | ≤32 | ≤740 | ≤1100 | ≤60 |
| Se | <0.5 | <0.5 | <0.5 | <0.5 |
| Br | <0.1 | <0.1 | <0.1 | <0.1 |
| Rb | <0.05 | <0.05 | <0.05 | <0.05 |
| Sr | 3.4 | 31 | 8 | 2.3 |
| Y | <0.05 | 1.5 | <0.05 | <0.05 |
| Zr | 0.51 | 4 | 7.4 | 1.8 |
| Nb | <2 | <2 | <2 | <2 |
| Mo | <1 | <1 | 4.4 | <1 |
| Ru | <0.1 | <0.1 | <0.1 | <0.1 |
| Rh | <0.05 | <0.05 | <0.05 | <0.05 |
| Pd | <0.1 | <0.1 | <0.1 | <0.1 |
| Ag | <0.5 | <0.5 | <0.5 | <0.5 |
| Cd | <0.5 | <0.5 | <0.5 | <0.5 |
| In | Binder | Binder | Binder | Binder |
| Sn | <0.5 | 0.8 | 1 | <0.5 |
| Sb | 5.6 | 3.5 | 4.7 | 1.1 |
| Te | <0.05 | <0.05 | <0.05 | <0.05 |
| I | ≤140 | ≤94 | ≤110 | ≤57 |

TABLE 3
[ppm wt]

| Element | Sm-1 | Sm-2 | Sm-3 | Sm-4 |
|---|---|---|---|---|
| Cs | <0.05 | <0.05 | <0.05 | <0.05 |
| Ba | ≤1.3 | ≤19 | ≤25 | ≤1.0 |
| La | 0.48 | 0.74 | 0.41 | 0.87 |
| Ce | <0.1 | 0.48 | 0.67 | <0.1 |
| Pr | <0.1 | <0.1 | 0.27 | 0.38 |
| Nd | <0.1 | <0.1 | <0.1 | <0.1 |
| Sm | <0.1 | <0.1 | <0.1 | <0.1 |
| Eu | <0.1 | <0.1 | <0.1 | <0.1 |
| Gd | <0.1 | <0.1 | <0.1 | <0.1 |
| Tb | <0.1 | <0.1 | <0.1 | <0.1 |
| Dy | <0.1 | <0.1 | <0.1 | <0.1 |
| Ho | <0.1 | <0.1 | <0.1 | <0.1 |
| Er | <0.1 | <0.1 | <0.1 | <0.1 |
| Tm | <0.1 | <0.1 | <0.1 | <0.1 |
| Yb | <0.1 | <0.1 | <0.1 | <0.1 |
| Lu | <0.1 | <0.1 | <0.1 | <0.1 |
| Hf | <0.5 | <0.5 | <0.5 | <0.5 |
| Ta | Source | Source | Source | Source |
| W | <1 | 1.3 | 1.3 | <1 |
| Re | <0.5 | <0.5 | <0.5 | <0.5 |
| Os | <0.1 | <0.1 | <0.1 | <0.1 |
| Ir | <0.1 | <0.1 | <0.1 | <0.1 |
| Pt | <0.5 | <0.5 | <0.5 | <0.5 |
| Au | <10 | <10 | <10 | <10 |
| Hg | <0.5 | <0.5 | <0.5 | <0.5 |
| Tl | <0.05 | <0.05 | <0.05 | <0.05 |
| Pb | <0.05 | <0.05 | 4.5 | 0.09 |
| Bi | <0.05 | <0.05 | <0.05 | 0.19 |
| Th | <0.01 | 0.02 | <0.01 | <0.01 |
| U | <0.01 | <0.01 | <0.01 | <0.01 |

The concentration ranges of the elements contained in the lithium cobalt oxide (the material Sm-1, the material Sm-2, the material Sm-3, and the material Sm-4) can be read from the above table. Specifically, from the above table, in the case where the material Sm-1, the material Sm-2, the material Sm-3, and the material Sm-4 are all preferable as the lithium cobalt oxide used in Step S14, for example, the concentration range of each element can be determined with the maximum value of the concentration of each element described in the material Sm-1, the material Sm-2, the material Sm-3, and the material Sm-4 as the upper limit of the concentration and the minimum value of each element concentration as the lower limit of the concentration.

### <Step S15>

In Step S15 shown in FIG. 5A, the composite oxide containing lithium and a transition metal, such as lithium cobalt oxide, is heated. The heating in Step S15 is initial heating, specifically, first heating, performed on the lithium cobalt oxide or the like and thus is sometimes referred to as the initial heating. The heating is performed before Step S20 described below, and thus is sometimes referred to as preheating or pretreatment.

Through the initial heating, an effect of smoothing the surface of the lithium cobalt oxide or the like is obtained. A smooth surface of the lithium cobalt oxide includes a state of the lithium cobalt oxide having little unevenness, an entirely rounded state of the lithium cobalt oxide, and a state of the lithium cobalt oxide with a projection portion having rounded corners. Furthermore, the smooth surface includes a state in which few foreign matters are attached to the surface of lithium cobalt oxide. Foreign matters cause unevenness and are preferably not attached to the surface of lithium cobalt oxide. In the initial heating in this step, a flux may be prepared optionally. In other words, when only lithium cobalt oxide is subjected to heat treatment, a smooth surface can be obtained.

Furthermore, part of lithium is sometimes extracted from the lithium cobalt oxide by the initial heating. Typically, lithium in the surface portion of the lithium cobalt oxide is easily extracted. Note that in the initial heating in this step, the lithium source may or may not be prepared. That is, the lithium source may be prepared optionally.

Although the lithium source and/or the cobalt source prepared in Step S11 might contain impurities, impurities in the lithium cobalt oxide can be reduced by the initial heating. Note that in the initial heating in this step, the additive element source may be prepared optionally.

When the heating time of the initial heating is too short, a sufficient effect is not obtained, but when the heating time of the initial heating is too long, the productivity is lowered. For example, the conditions for the initial heating can be selected from the conditions described for Step S13. As a supplementary explanation of the heating conditions in Step S13, the heating temperature in the initial heating is preferably lower than that in Step S13 so that the crystal structure of the lithium cobalt oxide can be maintained. The heating time of the initial heating is preferably shorter than the heating time in Step S13 so that the crystal structure of the lithium cobalt oxide can be maintained. That is, the initial heating is preferably performed at a temperature higher than or equal to 700° C. and lower than or equal to 1000° C. for longer than or equal to 2 hours and shorter than or equal to 20 hours, for example.

In addition, an effect of increasing the crystallinity of the inner portion of the lithium cobalt oxide by the initial heating can be expected. In the case of the lithium cobalt oxide in which differential shrinkage occurs between the surface portion and the inner portion, increasing the crystallinity of the inner portion includes reducing the differential shrinkage. The differential shrinkage is explained here. Since the lithium cobalt oxide has a volume, the heating in Step S13 might cause a temperature difference between the surface and the inner portion. When the temperature difference occurs, the surface and the inner portion are different in fluidity, and thus differential shrinkage occurs in the lithium cobalt oxide. That is, the differential shrinkage causes distortion in the lithium cobalt oxide.

Thus, the above-described initial heating can reduce differential shrinkage or distortion of the lithium cobalt oxide. It is presumed that the surface of the lithium cobalt oxide is smoothed by such a phenomenon. The state of the smoothed surface may be expressed as the surface of lithium cobalt oxide being improved.

Such differential shrinkage may cause a shift in the crystal, i.e., a grain boundary, in the lithium cobalt oxide. To reduce the shift, the initial heating is preferably performed. The reduction of the shift may be referred to as alignment of crystal grains. It is conceivable that the surface of the lithium cobalt oxide becomes smooth due to the reduction in the shift.

Lithium cobalt oxide having a smooth surface is preferably used as the positive electrode active material, in which case cracking of the positive electrode active material through a manufacturing process or charging and discharging can be prevented and deterioration in charging and discharging of the secondary battery can be inhibited.

In the case where pre-synthesized lithium cobalt oxide is used in Step S14, the initial heating can provide the lithium cobalt oxide with a smooth surface. In the case where a composite oxide containing lithium and a transition metal other than lithium cobalt oxide is prepared, the surface can be smoothed by the initial heating in Step S15.

### <Step S20>

An additive element is added to the lithium cobalt oxide that has been subjected to the initial heating and has a smooth surface. When the additive element is added to the lithium cobalt oxide with a smooth surface, the additive element can be uniformly added. It is thus preferable that the addition of the additive element be performed after the initial heating. As the additive element source, one or two or more selected from magnesium, nickel, aluminum, titanium, fluorine, zirconium, vanadium, iron, manganese, chromium, niobium, arsenic, zinc, silicon, sulfur, phosphorus, and boron can be used.

An organometallic compound is preferably used as the additive element source. A general formula, which is an example of an organic compound containing an additive element, is as shown in General Formula (G1) above.

A general formula, which is another example of an organic compound containing an additive element, is as shown in General Formula (G2) above.

The step of adding the additive element may be performed a plurality of times. In this embodiment, the case where the step of adding the additive element is performed twice is described, and Step S20 is the first addition step of the two steps. The additive element used in Step 20 is referred to as an additive element A1.

When magnesium is selected as the additive element A1, a magnesium source (Mg source) is prepared as the additive element A1 source (denoted as the A1 source in the drawing) shown in Step S20. As the magnesium source, a compound containing magnesium is used. When an organometallic compound rather than an inorganic metal compound is used as the compound, the temperature in a heating step described later can be lowered, which is preferable in terms of process simplification, and it is preferable to use an alkyl diketone complex as the organometallic compound. As the alkyl diketone, acetylacetone or an acetylacetonate complex is preferably used. When the alkyl diketone complex of magnesium in a solid state and lithium cobalt oxide are mixed and then heated, magnesium can be added to the lithium cobalt oxide. The acetylacetonate complex in the state of being dissolved or mixed in an organic solvent is preferably used, in which case magnesium can be uniformly added to the lithium cobalt oxide. In particular, in the case where a slight amount of magnesium is added, a magnesium source in a state in which an acetylacetonate complex or the like is dissolved or mixed in an organic solvent is preferably prepared, in which case the total amount of the magnesium source can be increased. As the organic solvent, acetone or alcohol such as ethanol or isopropanol (an alcohol of isopropanol is typically an isopropyl alcohol) is preferably used. When a solution containing an organometallic compound dissolved or mixed in an organic solvent is applied to lithium cobalt oxide, the rate of the solution can also be controlled using a boiling point of the organic solvent. By using the boiling point of the organic solvent, the solution can be applied uniformly. By the uniform application, the solution can be attached to the lithium cobalt oxide so as to be in a film-like state. Therefore, magnesium or the like can be uniformly distributed in the lithium cobalt oxide. As such an acetylacetonate complex containing magnesium, typically, magnesium acetylacetonate can be used. In addition, a hydrate of an acetylacetonate complex may be used. The use of the hydrate enables dissolution or mixing even when water is used instead of the organic solvent. The structural formula of magnesium acetylacetonate is as shown in Structural Formula (H11) below.

As another organometallic compound, lactate or ammonium lactate is preferably used. When lactate or ammonium lactate in a solid state and the lithium cobalt oxide are mixed and then heated, magnesium can be added to the lithium cobalt oxide. Alternatively, lactate or ammonium lactate of magnesium dissolved in water is preferably used, in which case magnesium can be uniformly added to the lithium cobalt oxide. In particular, in the case where a slight amount of magnesium is added, a magnesium source in a state in which lactate or ammonium lactate is dissolved in water is preferably prepared, in which case the total amount of the magnesium source can be increased. As such lactate containing magnesium, typically, magnesium lactate can be used.

Furthermore, it is preferable to use a phthalocyanine complex as another organometallic compound. The phthalocyanine complex of magnesium in a solid state and the lithium cobalt oxide are mixed and then heated, whereby magnesium can be added to the lithium cobalt oxide. Preferably, the phthalocyanine complex in a state of being dissolved in an organic solvent may be used, in which case magnesium can be uniformly added to the lithium cobalt oxide. In particular, in the case where a slight amount of magnesium is added, a magnesium source in a state in which a phthalocyanine complex or the like is dissolved in an organic solvent is preferably prepared, in which case the total amount of the magnesium source can be increased. Toluene is preferably used as the organic solvent. As such a phthalocyanine complex containing magnesium, typically, magnesium phthalocyanine can be used. The structural formula of magnesium phthalocyanine is as shown in Structural Formula (H31) above.

Note that two or more of the above organometallic compounds may be used for the magnesium source.

Unlike an inorganic metal compound such as magnesium fluoride, the above organometallic compounds do not contain fluorine. The above organometallic compounds are stable in the air. Thus, the above-described organometallic compounds are easy to handle and thus productivity is improved. An improvement in productivity is expected to shorten the process time.

In Step S20 shown in FIG. 5A, a lithium source may be prepared in addition to the Al source. The lithium source is as described in Step S11. In addition to the Al source, a fluorine source may be prepared in Step S20. LiF can be used as the fluorine source. The fluorine source is preferably used, in which case the heating temperature can be lowered and/or the heating time can be shortened in Step S33 or the like described later.

### <Step S30>

Next, in Step S30 shown in FIG. 5A, the lithium cobalt oxide and the Al source are mixed. In the case where the additive element A1 source is a liquid, a mixed solution is obtained. The lithium cobalt oxide is not necessarily dissolved in an organic solvent or the like, and the mixed solution may be a suspension solution. The mixing is preferably performed such that the atomic ratio of cobalt A_{Co} in the lithium cobalt oxide to magnesium A_{Mg} contained in the additive element A1 source is A_{Co}:A_{Mg}=100:y (0.1≤y≤6), further preferably A_{M}:A_{Mg}=100:y (0.3≤y≤ 3).

### <Step S31>

In Step S31 shown in FIG. 5A, the mixed solution is dried. The drying includes removal of an organic solvent attached in the previous step. In addition, the drying includes removal of water attached in the previous step. The drying includes natural drying, and the preferable temperature is higher than or equal to 50° C. and lower than or equal to 300° C., and the further referable temperature is higher than or equal to 80° C. and lower than or equal to 170° C. Furthermore, the drying time in this step is preferably longer than or equal to 1 hour and shorter than or equal to 24 hours, further preferably longer than or equal to 8 hours and shorter than or equal to 15 hours. The drying treatment in this step may be performed a plurality of times.

The atmosphere at the time of drying is preferably a dry atmosphere or an oxygen-containing atmosphere. The dry atmosphere is an atmosphere with reduced moisture, e.g., an atmosphere in which a dew point in a treatment chamber is preferably lower than or equal to −40° C., further preferably lower than or equal to −80° C., for example. Drying may be performed under an atmospheric pressure, under an atmosphere containing an inert gas such as nitrogen, helium, or argon, or in a vacuum. In the case where the drying is performed in a vacuum, for example, a bell jar type vacuum apparatus including a treatment container (referred to as a bell jar) the inside of which can be evacuated to a vacuum and a vacuum pump connected to the bell jar can be used. In the case where the drying is performed in a vacuum atmosphere, a vacuum drying furnace may be used, and the vacuum drying furnace includes a vacuum pump connected to the drying furnace. As the vacuum pump included in the bell jar type vacuum apparatus or the vacuum drying furnace, one or two or more of a dry pump, a turbomolecular pump, an oil rotary pump, a cryopump, and a mechanical booster pump can be used. In the case where two or more vacuum pumps are used, a vacuum atmosphere is made with use of the first vacuum pump and then the atmosphere can be evacuated to a vacuum with use of the second vacuum pump instead of the first vacuum pump. The vacuum atmosphere in the bell jar type vacuum apparatus or the vacuum drying furnace includes an atmosphere where the pressure is reduced to be higher than or equal to −0.1 MPa and lower than-0.08 MPa read by a differential pressure gauge of each apparatus. In the case where drying is performed in a nitrogen atmosphere, a gas containing nitrogen is supplied into a treatment container included in the atmosphere furnace. In addition, drying may be performed by a spray dryer. The spray dryer is an apparatus that allows an undiluted solution to turn into dry particles in a moment in a hot-air continuous drying apparatus.

### <Step S32>

Next, in Step S32 in FIG. 5A, the material obtained in the above manner is collected, whereby a mixture 903 is obtained. At the time of the collection, crushing may be performed. At the time of the collection, sieving may be performed as needed.

### <Step S33>

Then, in Step S33 shown in FIG. 5A, the mixture 903 is heated. Any of the heating conditions described for Step S13 can be selected to perform this step. As a supplementary explanation of the heating time, the heating time is preferably longer than or equal to 2 hours.

A supplementary explanation of the heating temperature is provided next. The lower limit of the heating temperature in Step S33 needs to be higher than or equal to the temperature at which a reaction between the lithium cobalt oxide and the additive element (A1) source proceeds. The temperature at which the reaction proceeds is the temperature at which interdiffusion of the elements included in lithium cobalt oxide and the additive element (A1) source occurs, and may be lower than the melting temperatures of these materials. It is known that in the case of an oxide as an example, solid phase diffusion occurs at the Tamman temperature T_{d} (0.757 times the melting temperature Tₘ). Accordingly, the heating temperature in Step S33 is preferably higher than or equal to 650° C.

The upper limit of the heating temperature is lower than the decomposition temperature (the melting point: 1130° C.) of the lithium cobalt oxide. At around the decomposition temperature, a slight amount of lithium cobalt oxide might be decomposed. Note that it is acceptable that the surface or the surface portion of the lithium cobalt oxide is melted. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Note that the heating temperature in Step S33 is preferably lower than that in Step S13. A higher heating temperature is preferable because it facilitates the reaction, shortens the heating time, and enables high productivity.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the additive element, and thereby the distribution of the additive element in the lithium cobalt oxide is likely to worsen.

In the case of using a rotary kiln in this step, the flow rate of an oxygen-containing atmosphere in the kiln is preferably controlled during the heating. In preferable examples, the flow rate of an oxygen-containing atmosphere is set low, or an atmosphere is purged first, an oxygen atmosphere is introduced into the kiln, and then no flowing of the atmosphere is performed. This heating step may be performed using a roller hearth kiln.

The heating conditions are preferably different depending on the median diameter (D50) of the lithium cobalt oxide. For example, the heating time is preferably changed depending on the heating temperature, the median diameter (D50) of the lithium cobalt oxide in Step S14, or the composition conditions. Typically, in the case where the median diameter (D50) of the lithium cobalt oxide is small, the heating is preferably performed at a lower temperature or for a shorter time than in the case where it is large, in some cases.

When the median diameter (D50) of the lithium cobalt oxide in Step S14 in FIG. 5A is greater than or equal to 10 μm and less than or equal to 20 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the temperature decreasing time after the heating is, for example, preferably longer than or equal to 10 hours and shorter than or equal to 50 hours.

In the case where the lithium cobalt oxide in Step S14 has a median diameter (D50) greater than or equal to 3 μm and less than 10 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the temperature decreasing time after the heating is, for example, preferably longer than or equal to 10 hours and shorter than or equal to 50 hours.

### <Step S34>

In Step S34 shown in FIG. 5A, the heated material is collected, whereby a composite oxide is obtained. At the time of the collection, crushing may be performed. At the time of the collection, sieving may be performed as needed. Although the resultant composite oxide can be used as the positive electrode active material, an additive element is further added thereto in this embodiment.

### <Application Example>

This embodiment describes that lithium cobalt oxide to which an additive element is added beforehand can be used; when lithium cobalt oxide to which magnesium has been added is prepared, the steps of Step S11 to Step S14 and Step S20 to Step S33 can be skipped, and the composite oxide in Step S34 can be obtained. Such a method is preferable because it is simple and has high productivity.

### <Step S40>

In Step S40 shown in FIG. 5A, an additive element is further added to lithium cobalt oxide, which is a composite oxide. As the additive element, one or two or more selected from magnesium, nickel, aluminum, titanium, zirconium, vanadium, iron, manganese, chromium, niobium, arsenic, zinc, silicon, sulfur, phosphorus, and boron is preferably used. It is preferable that the additive element used in Step S40 be referred to as an additive element A2, and the additive element A2 be different from the above-described additive element A1.

When nickel is selected as the additive element A2, a nickel source is prepared as an additive element A2 source (denoted as the A2 source in the drawing) shown in Step S40. As the nickel source, a compound containing nickel is used. Although an inorganic metal compound may be used as the compound, the use of an organometallic compound is preferable in terms of process simplification because the temperature in a heating step described later can be lowered, and it is preferable to use an alkyl diketone complex as the organometallic compound. As the alkyl diketone, acetylacetone or an acetylacetonate complex is preferably used. When alkyl diketone in a solid state and the lithium cobalt oxide are mixed and then heated, nickel can be added to the lithium cobalt oxide. The acetylacetonate complex in the state of being dissolved or mixed in an organic solvent is preferably used, in which case nickel can be uniformly added to the lithium cobalt oxide. In particular, in the case where a slight amount of nickel is added, a nickel source in a state in which an acetylacetonate complex or the like is dissolved or mixed in an organic solvent is preferably prepared, in which case the total amount of the nickel source can be increased. As the organic solvent, acetone or alcohol such as ethanol or isopropanol (an alcohol of isopropanol is typically an isopropyl alcohol) is preferably used. When a solution containing an organometallic compound dissolved or mixed in an organic solvent is applied to the lithium cobalt oxide, the rate of the solution can also be controlled using a boiling point of the organic solvent. By using the boiling point of the organic solvent, the solution can be applied uniformly. By the uniform application, the solution can be attached to the lithium cobalt oxide so as to be in a film-like state. Therefore, nickel or the like can be uniformly distributed in the lithium cobalt oxide. As such an acetylacetonate complex containing nickel, typically, nickel acetylacetonate can be used. The structural formula of nickel acetylacetonate is as shown in Structural Formula (H12) above.

As another organometallic compound, lactate or ammonium lactate is preferably used. When lactate or ammonium lactate in a solid state and the lithium cobalt oxide are mixed and then heated, nickel can be added to the lithium cobalt oxide. In addition, lactate or ammonium lactate dissolved in water is preferably used, in which case nickel can be uniformly added to the lithium cobalt oxide. In particular, in the case where a slight amount of nickel is added, a nickel source in a state in which lactate or ammonium lactate is dissolved in water is preferably prepared, in which case the total amount of the nickel source can be increased. As such lactate containing nickel, typically, nickel lactate can be used.

Furthermore, it is preferable to use a phthalocyanine complex as another organometallic compound. The phthalocyanine complex in a solid state and the lithium cobalt oxide are mixed and then heated, whereby nickel can be added to the lithium cobalt oxide. The phthalocyanine complex in a state of being dissolved in an organic solvent is preferably used, in which case nickel can be uniformly added to the lithium cobalt oxide. In particular, in the case where a slight amount of nickel is added, a nickel source in a state in which a phthalocyanine complex or the like is dissolved in an organic solvent is preferably prepared, in which case the total amount of the nickel source can be increased. Toluene is preferably used as the organic solvent. As such a phthalocyanine complex containing nickel, typically, nickel phthalocyanine can be used. The structural formula of nickel phthalocyanine is as shown in Structural Formula (H32) above.

Note that two or more of the above organometallic compounds can also be used as the nickel source.

When aluminum is selected as the additive element A2, an aluminum source is prepared as the additive element source A2 (A2 source) shown in Step S40. As the aluminum source, a compound containing aluminum is used. Although an inorganic metal compound may be used as the compound, the use of an organometallic compound is preferable in terms of process simplification because the temperature in a heating step described later can be lowered, and it is preferable to use an alkyl diketone complex as the organometallic compound. As the alkyl diketone, acetylacetone or an acetylacetonate complex is preferably used. When alkyl diketone in a solid state and the lithium cobalt oxide are mixed and then heated, aluminum can be added to the lithium cobalt oxide. The acetylacetonate complex in the state of being dissolved or mixed in an organic solvent is preferably used, in which case aluminum can be uniformly added to the lithium cobalt oxide. In particular, in the case where a slight amount of aluminum is added, an aluminum source in a state in which an acetylacetonate complex or the like is dissolved or mixed in an organic solvent is preferably prepared, in which case the total amount of the aluminum source can be increased. As the organic solvent, acetone or alcohol such as ethanol or isopropanol (an alcohol of isopropanol is typically an isopropyl alcohol) is preferably used. When a solution containing an organometallic compound dissolved or mixed in an organic solvent is applied to the lithium cobalt oxide, the rate of the solution can also be controlled using a boiling point of the organic solvent. By using the boiling point of the organic solvent, the solution can be applied uniformly. By the uniform application, the solution can be attached to the lithium cobalt oxide so as to be in a film-like state. Therefore, aluminum or the like can be uniformly distributed in the lithium cobalt oxide. As such an acetylacetonate complex containing aluminum, typically, aluminum acetylacetonate can be used. The structural formula of aluminum acetylacetonate is as shown in Structural Formula (H13) above.

As another organometallic compound, lactate or ammonium lactate is preferably used. When lactate or ammonium lactate in a solid state and the lithium cobalt oxide are mixed and then heated, aluminum can be added to the lithium cobalt oxide. In addition, lactate or ammonium lactate dissolved in water is preferably used, in which case aluminum can be uniformly added to the lithium cobalt oxide. In particular, in the case where a slight amount of aluminum is added, an aluminum source in a state in which ammonium lactate is dissolved in water is preferably prepared, in which case the total amount of the aluminum source can be increased. As such ammonium lactate containing aluminum, typically, aluminum lactate can be used.

Furthermore, it is preferable to use a phthalocyanine complex as another organometallic compound. The phthalocyanine complex in a solid state and the lithium composite oxide 99 are mixed and then heated, whereby aluminum can be added to the lithium composite oxide 99. The phthalocyanine complex dissolved in an organic solvent is preferably used, in which case aluminum can be uniformly added to the lithium composite oxide 99. In particular, in the case where a slight amount of aluminum is added, an aluminum source in a state in which a phthalocyanine complex or the like is dissolved or mixed in an organic solvent is preferably prepared, in which case the total amount of the aluminum source can be increased. Toluene is preferably used as the organic solvent. As such a phthalocyanine complex containing aluminum, typically, one or two or more selected from phthalocyanine aluminum, aluminum phthalocyanine halide, and aluminum phthalocyanine hydroxide can be used. The structural formula of phthalocyanine aluminum is as shown in Structural Formula (H33) or Structural Formula (H34) below.

Note that two or more of the above organometallic compounds can also be used as the aluminum source.

When titanium is selected as the additive element A2, a titanium source is prepared as the A2 source shown in Step S40. A compound containing titanium is used as the titanium source. Although an inorganic metal compound may be used as the compound, the use of an organometallic compound is preferable in terms of process simplification because the temperature in a heating step described later can be lowered, and it is preferable to use an alkyl diketone complex as the organometallic compound. As the alkyl diketone, acetylacetone or an acetylacetonate complex is preferably used. When alkyl diketone in a solid state and the lithium cobalt oxide are mixed and then heated, titanium can be added to the lithium cobalt oxide. The acetylacetonate complex dissolved or mixed in an organic solvent is preferably used, in which case titanium can be uniformly added to the lithium cobalt oxide. In particular, in the case where a slight amount of titanium is added, a titanium source in a state in which an acetylacetonate complex or the like is dissolved or mixed in an organic solvent is preferably prepared, in which case the total amount of the titanium source can be increased. As the organic solvent, acetone or alcohol such as ethanol or isopropanol (an alcohol of isopropanol is typically an isopropyl alcohol) is preferably used. When a solution containing an organometallic compound dissolved or mixed in an organic solvent is applied to lithium cobalt oxide, the rate of the solution can also be controlled using a boiling point of the organic solvent. By using the boiling point of the organic solvent, the solution can be applied uniformly. By the uniform application, the solution can be attached to the lithium cobalt oxide so as to be in a film-like state. Therefore, titanium or the like can be uniformly distributed in the lithium cobalt oxide. As such an acetylacetonate complex containing titanium, typically, titanium acetylacetonate can be used. The structural formula of titanium acetylacetonate is as shown in Structural Formula (H14) above.

As another organometallic compound, lactate or ammonium lactate is preferably used. When lactate or ammonium lactate in a solid state and the lithium cobalt oxide are mixed and then heated, titanium can be added to the lithium cobalt oxide. In addition, lactate or ammonium lactate dissolved in water is preferably used, in which case titanium can be uniformly added to the lithium cobalt oxide. In particular, in the case where a slight amount of titanium is added, a titanium source in a state in which lactate or ammonium lactate is dissolved in water is preferably prepared, in which case the total amount of the titanium source can be increased. As such lactate containing titanium, typically, titanium lactate can be used.

Furthermore, it is preferable to use a phthalocyanine complex as another organometallic compound. The phthalocyanine complex in a solid state and the lithium cobalt oxide are mixed and then heated, whereby titanium can be added to the lithium cobalt oxide. The phthalocyanine complex dissolved in an organic solvent is preferably used, in which case magnesium can be uniformly added to the lithium cobalt oxide. In particular, in the case where a slight amount of titanium is added, a titanium source in a state in which a phthalocyanine complex or the like is dissolved or mixed in an organic solvent or water is preferably prepared, in which case the total amount of the titanium source can be increased. Toluene is preferably used as the organic solvent. As such a phthalocyanine complex containing titanium, typically, titanyl phthalocyanine can be used. The structural formula of titanyl phthalocyanine is represented by Structural Formula (H35) above.

Note that two or more of the above organometallic compounds can also be used as the titanium source.

An oxide or a hydroxide is preferably used as the inorganic compound containing the above-described additive element.

The above organometallic compounds are stable in the air. Thus, the organometallic compounds are each easily handled, which increasing productivity. An improvement in productivity is expected to shorten the process time.

In Step S40 shown in FIG. 5A, a lithium source may be prepared in addition to the A2 source. The lithium source is as described in Step S11. In addition to the A2 source, a fluorine source may be prepared in Step S40. LiF can be used as the fluorine source. The fluorine source is preferably used, in which case the heating temperature can be lowered and/or the heating time can be shortened in Step S53 or the like described later.

### <Step S41 to Step S43>

Next, a method for preparing the A2 source is described with reference to FIG. 5B. In FIG. 5B, a nickel source (Ni source in the drawing) and an aluminum source (Al source in the drawing) are prepared, for example. Note that one additive element may be used in Step S40, and an aluminum source may be omitted, for example.

In Step S42 shown in FIG. 5B, the nickel source and the aluminum source are mixed, and the mixed solution is dried in Step S43. The condition of the drying step in Step S43 can be selected from the conditions of Step S31 described above. In the case where an inorganic compound is used as the nickel source and the aluminum source, the drying step in Step S43 can be skipped.

### <Step S44>

After that, the additive element A2 source can be obtained in Step S44 shown in FIG. 5B. Before mixing with the composite oxide in Step S34, the additive element A2 source is preferably mixed in Step S42, in which case two or more additive elements A2 can be uniformly added to the composite oxide in Step S34. In the case where two or more additive element A2 sources are prepared as in Step S41 and the additive element sources are dissolved in organic solvents, the same kind of organic solvent is preferably used, in which case the mixing in Step S42 can be easily performed.

Needless to say, the aluminum source may be added after the nickel source and the composite oxide are mixed. Alternatively, the nickel source may be added after the aluminum source and the composite oxide are mixed.

### <Step S50 to Step S53>

Next, Step S50 to Step S53 shown in FIG. 5A can be performed under the conditions similar to those in Step S30 to Step S33 shown in FIG. 5A. As a supplementary explanation of the heating step, the temperature of the heating condition in Step S53 may be lower than that of Step S33. As a supplementary explanation of the heating step, the time of the heating condition in Step S53 may be shorter than that of Step S33.

### <Step S54>

Through the above steps, the positive electrode active material 100 of one embodiment of the present invention can be manufactured in Step S54.

The steps are preferably performed in accordance with the procedure of the steps described in this embodiment, in which case the smoothness of the surface obtained by the initial heating can be maintained. That is, the surface of the positive electrode active material 100 of one embodiment of the present invention becomes smooth. A positive electrode active material with a smooth surface is unlikely to crack, and a secondary battery including the positive electrode active material 100 is expected to have improved cycle performance.

Although this embodiment describes the method example in which introduction of the additive element to the lithium cobalt oxide is performed in separate steps, introduction of the additive element A1 and introduction of the additive element A2, the distribution of the additive element can be adjusted by the separate introduction steps of the additive elements. For example, the additive element A1 can be distributed such that its concentration is higher in the surface portion than in the inner portion, and the additive element A2 can be distributed such that its concentration is higher in the inner portion than in the surface portion.

### <<Manufacturing Method 5 of Positive Electrode Active Material>>

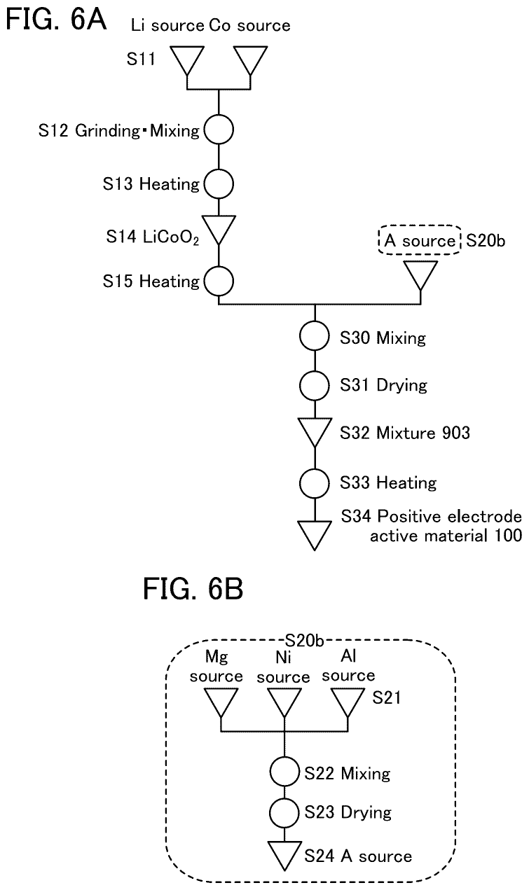

A manufacturing method 5 that is different from the above manufacturing method 4 is described with reference to FIG. 6 and the like. Specifically, the manufacturing method 5 is a method for forming a positive electrode active material containing lithium cobalt oxide and is different from the manufacturing method 4 in the step of adding the additive element.

### <Step S11 to Step S15>

Step S11 to Step S15 shown in FIG. 6A can be performed under the same conditions as those in Step S11 to Step S15 shown in FIG. 5A corresponding to the above manufacturing method 1.

### <Step S20b>

The additive element is added to lithium cobalt oxide that has been subjected to the initial heating and has a smooth surface. Unlike the manufacturing method 1, two or more selected from the above-described additive elements are used in Step S20b, and only this step is performed as the adding step in the manufacturing method 2. The additive element used in Step S20b is referred to as an additive element A. The additive element can be selected from the additive elements described in the manufacturing method 1.

Next, a method for preparing the additive element A source is described with reference to FIG. 6B as well. In FIG. 6B, a magnesium source (Mg source in the drawing), a nickel source (Ni source in the drawing), and an aluminum source (Al source in the drawing) are prepared, for example. Note that two or more additive elements are used in Step S40; for example, an aluminum source may be omitted.

### <Step S21 to Step S23>

In Step S21 shown in FIG. 6B, a magnesium source, a nickel source, and an aluminum source are prepared as described in the manufacturing method 1. An organic compound rather than an inorganic compound is preferably used as the magnesium source, the nickel source, and the aluminum source. In Step S22, the magnesium source, the nickel source, and the aluminum source are mixed, and the mixed solution is dried in Step S23. The condition of the drying step in Step S23 can be selected from the conditions of Step S43 described above in the manufacturing method 1.

### <Step S24>

As a result, the additive element A source can be obtained in Step S24. As in Step S22, the additive element A source is preferably mixed before mixing with the composite oxide, in which case two or more additive elements A can be uniformly added to the lithium cobalt oxide. In the case where two or more additive element A sources are prepared as in Step S21 and the additive element sources are dissolved in organic solvents, the same kind of organic solvent is preferably used, in which case the mixing in Step S22 can be easily performed.

Needless to say, the magnesium source and the lithium cobalt oxide may be mixed and then the nickel source and/or the aluminum source may be added in this order. Alternatively, the nickel source and/or the aluminum source may be mixed with the cobalt oxide and then the magnesium source may be added thereto.

### <Step S30 to Step S33>

Next, Step S30 to Step S33 shown in FIG. 6A can be performed under the same conditions as those in Step S30 to Step S33 shown in FIG. 5A.

### <Step S34>

Through the above steps, the positive electrode active material 100 of one embodiment of the present invention can be formed in Step S34.

The procedure of the steps described in this embodiment are preferably performed so that the smoothness of the surface obtained by the initial heating can be maintained. That is, the surface of the positive electrode active material 100 of one embodiment of the present invention becomes smooth. A positive electrode active material with a smooth surface is unlikely to crack, and a secondary battery including the positive electrode active material 100 is expected to have improved cycle performance.

Since the number of steps is reduced in the manufacturing method 5, one of the methods with high mass productivity can be provided.

This embodiment can be used in combination with any of the other embodiments.

### Embodiment 3

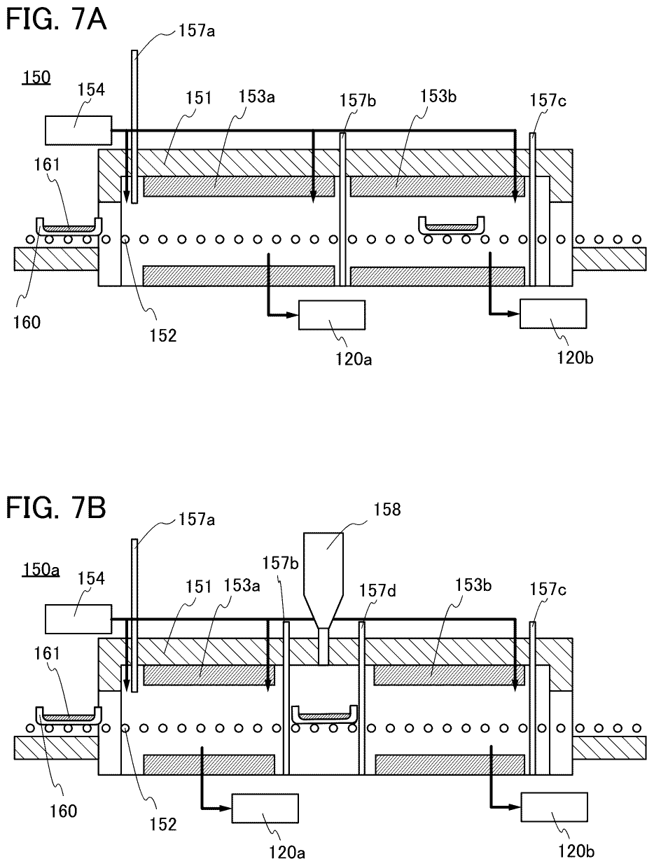

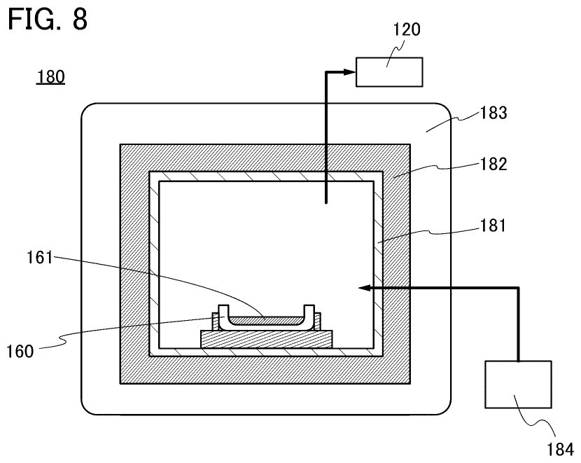

In this embodiment, a manufacturing apparatus of a positive electrode active material will be described with reference to FIG. 7, FIG. 8, and the like. As described in Embodiments 1 and 2, heat treatment is performed in the manufacturing process of the positive electrode active material. A manufacturing apparatus such as a roller hearth kiln or a muffle furnace can be used for the heat treatment.

### <Roller Hearth Kiln>

FIG. 7A is a schematic cross-sectional view of a roller hearth kiln 150. The roller hearth kiln 150 includes a kiln main body 151, a plurality of rollers 152, a heating unit 153a, a heating unit 153b, and an atmosphere control unit 154. The roller hearth kiln 150 preferably includes a blocking board 157a, a blocking board 157b, a blocking board 157c, a measurement device 120a, and a measurement device 120b. The kiln can be divided by the blocking board 157a and the blocking board 157b. The divided kiln between the blocking board 157a and the blocking board 157b is referred to as an upstream portion, includes a heating unit 153a, and is preferably connected to the measurement device 120a. By dividing by the blocking board 157b and the blocking board 157c, a kiln (referred to as a downstream portion) that includes the heating unit 153b and is connected to the measurement device 120b is obtained.

The kiln main body 151 has a tunnel-like shape, and the heating unit 153a and the heating unit 153b are also provided in a tunnel-like shape. The plurality of rollers 152 have a function of transferring a container 160 containing an object 161. The container 160 passes through the tunnel-like kiln main body 151 with the plurality of rollers 152 and is transferred to the outside. Since a source material to be sublimated, e.g., magnesium fluoride containing fluorine is not used in the heating steps in the above embodiments, the container 160 does not need to be covered with a lid.

The kiln main body 151 includes the above-described upstream portion and downstream portion along the transfer direction of the plurality of rollers 152. The kiln main body 151 includes the heating unit 153a in the upstream portion and the heating unit 153b in the downstream portion. By providing the blocking board 157b between the upstream portion and the downstream portion, the atmospheres in the upstream portion and the downstream portion can be independently controlled. When the blocking board 157a is provided near the inlet of the kiln main body 151 and the blocking board 157c is provided near the outlet of the kiln main body 151, the atmosphere inside the kiln main body 151 can be controlled easily.

The heating unit 153a and the heating unit 153b each have a function of heating the kiln main body 151 to a temperature higher than or equal to 700° C. and lower than or equal to 1200° C. As the heating unit 153a and the heating unit 153b, one or two or more selected from a silicon carbide heater, a carbon heater, a metal heater, and a molybdenum disilicide heater can be used, for example. The heating unit 153a and the heating unit 153b are preferably controlled to meet the conditions in Step S13 described above. Alternatively, the heating unit 153a and the heating unit 153b are preferably controlled to meet the conditions in Step S15 described above. Alternatively, the heating unit 153a and the heating unit 153b are preferably controlled to meet the conditions in Step S33 described above. Alternatively, the heating unit 153a and the heating unit 153b are preferably controlled to meet the conditions in Step S53 described above. The atmosphere control unit 154 has a function of controlling an atmosphere inside the kiln main body 151. An example of the atmosphere control unit 154 is a gas introduction line. A gas to be introduced preferably contains oxygen.

Although not illustrated, the kiln main body 151 is preferably provided with a control board having a function of controlling a heating temperature, an atmosphere, and the like.

The measurement device 120a and the measurement device 120b each preferably have a function of measuring the atmosphere inside the kiln main body 151. For the measurement device 120a and the measurement device 120b, one or two or more of GC (gas chromatography), MS (mass spectrometer), GC-MS, IR (infrared spectroscopy), and FT-IR (Fourier transform infrared spectroscopy) can be used. Note that the measurement device 120a and the measurement device 120b may be provided in an exhaust port or the vicinity thereof as long as the measurement device 120a and the measurement device 120b can confirm whether preferable heating conditions are made.

The roller hearth kiln 150 is preferable because the object is successively processed and thus the productivity is high.

The manufacturing apparatus of one embodiment of the present invention may be a roller hearth kiln having a function of supplying a new source material during heating. FIG. 7B is a schematic cross-sectional view of a roller hearth kiln 150a including a source material supply unit 158.

The roller hearth kiln 150a includes a source material supply unit 158 in a space divided by the blocking board 157b and the blocking board 157d between the upstream portion and the downstream portion of the kiln main body 151. With the source material supply unit 158, heating can be performed in the downstream portion, after addition of the lithium source and/or the additive element source. For example, the heating in Step S15 can be performed in the upstream portion, the lithium source can be added by the source material supply means, and heating in Step S15 can be performed again in the downstream portion.

For the other components, the description relating to FIG. 7A can be referred to.

### <Muffle Furnace>

The manufacturing apparatus of one embodiment of the present invention may be a batch-type muffle furnace. FIG. 8 is a cross-sectional view of a muffle furnace 180.

The muffle furnace 180 includes a hot plate 181, a heating unit 182, a heat insulator 183, and an atmosphere control unit 184. The muffle furnace 180 preferably includes the measurement device 120.

The muffle furnace 180 is preferable because the atmosphere and the temperature are easy to control. For the other components, the description relating to FIG. 7A can be referred to.

This embodiment can be used in appropriate combination with any of the other embodiments.

### Embodiment 4

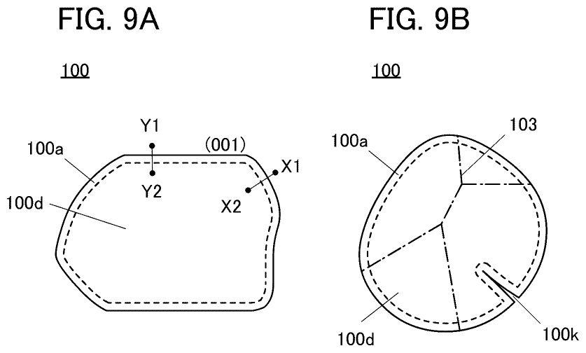

In this embodiment, the positive electrode active material 100 of one embodiment of the present invention is described with reference to FIG. 9 to FIG. 14 and the like.

FIG. 9A and FIG. 9B are cross-sectional views of the positive electrode active material 100 including lithium cobalt oxide or the like of one embodiment of the present invention. As illustrated in FIG. 9A and FIG. 9B, the positive electrode active material 100 includes the surface portion 100a and the inner portion 100d. In FIG. 9A and FIG. 9B, a dashed line denotes a boundary between the surface portion 100a and the inner portion 100d. Unlike in FIG. 9A, the positive electrode active material 100 in FIG. 9B also includes a crack 100k and a crystal grain boundary 103. In FIG. 9B, the crystal grain boundary 103 is denoted by a dashed-dotted line.

### <Surface Portion>

In this specification and the like, the surface portion 100a of the positive electrode active material 100 refers to a region within 200 nm, preferably within 100 nm, further preferably within 50 nm, still further preferably within 20 nm in depth from the surface toward the inner portion. The surface portion can be rephrased as the vicinity of a surface or a region in the vicinity of a surface.

### <Surface>

The positive electrode active material 100 is a composite oxide into and from which carrier ions, typically lithium ions, can be inserted and extracted, and thus does not include a chemically adsorbed carbonate nor a chemically adsorbed hydroxy group after formation of the positive electrode active material. Furthermore, an electrolyte, a binder, a conductive material, and a compound originating from any of these that are attached to the positive electrode active material 100 are not included either. Thus, the surface of the positive electrode active material 100 is a surface of a composite oxide into and from which carrier ions, typically lithium ions, can be inserted and extracted, and the above-described member that cannot be referred to as a composite oxide does not form the surface of the positive electrode active material 100. In the positive electrode active material 100 in FIG. 9B, a plane generated in the positive electrode active material 100 by the crack 100k may also be referred to as a surface.

### <Inner Portion>

The inner portion 100d refers to a region deeper than the surface portion 100a of the positive electrode active material 100. The inner portion 100d can be rephrased as an inner region or a core.

### <Crystallinity 2>

As described above in <Crystallinity 1>, the positive electrode active material 100 preferably has high crystallinity, further preferably includes a single crystal. Furthermore, the positive electrode active material 100 preferably includes a single particle (a primary particle) as illustrated in FIG. 9A. It is particularly preferable that the positive electrode active material 100 is a single crystal, in which case a crack is unlikely to be generated even when the volume of the positive electrode active material 100 is changed due to charging and discharging. Furthermore, when the positive electrode active material 100 is a single crystal, a secondary battery using the positive electrode active material 100 is presumably unlikely to ignite and can have a high level of safety.

As illustrated in FIG. 9B, the positive electrode active material 100 containing lithium cobalt oxide or the like may include the crystal grain boundary 103. In the case of the positive electrode active material 100 including the crystal grain boundary 103, the crystallite size is preferably large. For example, in the positive electrode active material 100, the lower limit of the crystallite size calculated from the half width of the diffraction pattern of XRD is preferably 250 nm, further preferably 420 nm.

The upper limit of the crystallite size is preferably 600 nm, further preferably 500 nm. The crystallite size increases when lithium becomes excessive; however, in the case where lithium is present in excess, gelation of the binder is induced in formation of slurry for an electrode such as a positive electrode. The upper limit of the crystallite size enables prevention of the gelation. The upper limit of the crystallite size can be combined with the lower limit described above to determine the range of the crystallite size.

### <XRD>

The conditions of the above XRD measurement are as described in Embodiment 1.

### <Particle Diameter 2>

As described above in <Particle diameter 1>, in the case where the positive electrode active material 100 containing lithium cobalt oxide or the like is also a single particle (a primary particle), the particle diameter is preferably small, in which case a crack is less likely to be generated. In contrast, too small a particle diameter might increase the specific surface area and increase a side reaction with the electrolyte solution, for example. Thus, the median diameter (D50) of the positive electrode active material 100 measured by a laser diffraction and scattering method is preferably greater than or equal to 2 μm and less than or equal to 15 μm.

A positive electrode is preferably formed using a mixture of positive electrode active materials having different particle diameters, in which case the electrode density can be increased, leading to a secondary battery with a high energy density. The positive electrode active material with a relatively small particle diameter is expected to achieve favorable charge and discharge rate performance. The positive electrode active material having a relatively large particle diameter is expected to have high charge and discharge cycle performance and maintain high discharge capacity. The particle diameter can be replaced with the median diameter (D50).

### <Median Diameter or the Like>

In a particle size distribution curve representing cumulative % on its horizontal axis, the particle diameter intersecting with a point where the horizontal axis is 10% is referred to as a 10% diameter or D10, the particle diameter intersecting with a point where the horizontal axis is 50% is referred to as a 50% diameter or D50, and the particle diameter intersecting with a point where the horizontal axis is 90% is referred to as a 90% diameter or D90; in some cases, D50 is referred to as a median diameter. In the case of representing the particle diameter, D50 is often used. When the particle diameter of the positive electrode active material 100 of one embodiment of the present invention is too large, there are problems such as difficulty in lithium diffusion and large surface roughness of an active material layer at the time when the material is applied to a current collector. In contrast, when the particle diameter is too small, a problem occurs such as over-reaction with an electrolyte solution. Accordingly, D50 of the positive electrode active material 100 is preferably greater than or equal to 1 μm and less than or equal to 100 μm, further preferably greater than or equal to 3 μm and less than or equal to 40 μm, still further preferably greater than or equal to 3 μm and less than or equal to 20 μm.

Particles having different particle diameters are preferably mixed and then used for a positive electrode, in which case the electrode density can be increased and a secondary battery with a high energy density can be manufactured. The positive electrode active material 100 with a relatively small particle diameter is expected to achieve favorable charge and discharge rate performance. The positive electrode active material 100 having a relatively large particle diameter is expected to have high charge and discharge cycle performance and maintain high discharge capacity.

### <Additive Element>

Furthermore, the positive electrode active material 100 of one embodiment of the present invention preferably contains an additive element. When the amount of the additive element is too small, the effect of chemically stabilizing the positive electrode active material 100 cannot be sufficiently exhibited; however, when the amount of the additive element is too large, discharge capacity or the like might be adversely affected. Therefore, for example, in the case where the positive electrode active material 100 containing an additive element A and lithium cobalt oxide is represented by LiCo_{1-z}O₂A_{z}, z is preferably greater than 0 and less than or equal to 0.3. Note that z is further preferably greater than 0 and less than or equal to 0.1, still further preferably greater than 0 and less than or equal to 0.05.

### <Solid Solution and Substitution>

The additive element preferably forms a solid-solution with the positive electrode active material 100. Alternatively, the additive element preferably substitutes for any of the sites of the transition metal, oxygen, and lithium contained in the positive electrode active material 100. In STEM-EDX line analysis of the positive electrode active material 100, the additive element being in such a state is determined to be positioned on the inner portion side of the positive electrode active material 100. In other words, in STEM-EDX line analysis of the positive electrode active material 100, a position where the number of counts of the additive element starts to increase is preferably at a deeper level than a position where the number of counts of the transition metal such as cobalt starts to increase.

### <Crystal Plane>

The positive electrode active material 100 illustrated in FIG. 9A is a composite oxide in which at least the inner portion 100d has a layered rock-salt crystal structure, and both the surface portion 100a and the inner portion 100d have a plane parallel to the (001) plane. In this specification and the like, the (001) plane, the (003) plane, and the like are collectively referred to as the (001) plane. Note that in this specification and the like, the (001) plane is sometimes referred to as a C plane, a basal plane, or the like, and it can be said that a diffusion path of lithium ions is along the basal plane. In this specification and the like, a plane where lithium is inserted and extracted, i.e., a plane where a diffusion path of lithium ions is exposed, specifically, a plane other than the (001) plane, is referred to as an edge plane in some cases.

### <Distribution of Additive Element>

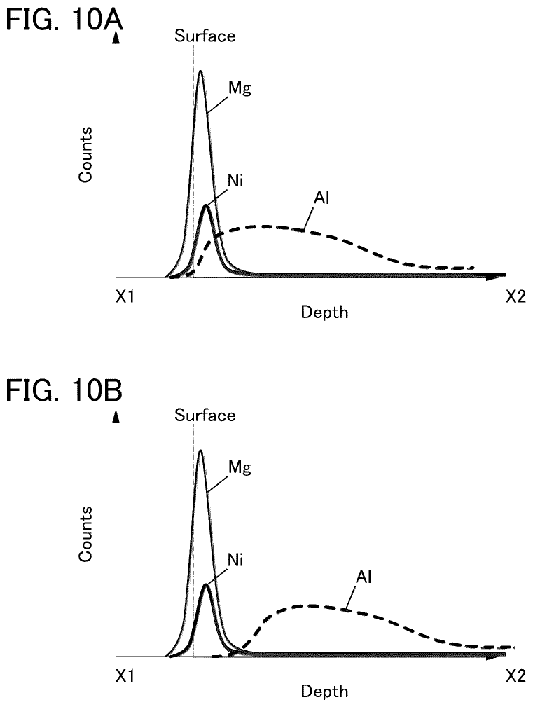

FIG. 10A and FIG. 10B show examples of distributions of the additive elements obtained by STEM-EDX line analysis performed on X1-X2 of the positive electrode active material 100 illustrated in FIG. 9A. Since X1-X2 corresponds to the region having the edge plane of the positive electrode active material 100, FIG. 10A and FIG. 10B can each be regarded as an example of distributions of the additive elements in the region having the edge plane. A point where the detected amount of an element which uniformly exists in the inner portion 100d of the positive electrode active material 100, e.g., oxygen or cobalt, is ½ of the detected amount thereof in the inner portion 100d is assumed to be the surface used in the STEM-EDX line analysis. As a detected amount, the detection intensity of characteristic X-rays, typically counts, can be used. In FIG. 10A and FIG. 10B, a point that is ½ of the detected amount of cobalt in the inner portion 100d is assumed to be the surface. The surface in FIG. 10A and FIG. 10B may be referred to as a reference point for the STEM-EDX line analysis.

As shown in FIG. 10A and FIG. 10B, in the region having the edge plane, the detection intensities of magnesium and nickel in the surface portion 100a are preferably higher than those in the inner portion 100d. It is further preferable that a peak of the detection intensity be observed in a region of the surface portion 100a that is closer to the surface. For example, the peak of the detection intensity is preferably observed in a region of 3 nm or less from the surface. The distribution of magnesium and the distribution of nickel preferably overlap with each other. The peak of the detection intensity of magnesium and the peak of the detection intensity of nickel may be positioned at the same depth, the peak of the detection intensity of magnesium may be closer to the surface, or the peak of the detection intensity of nickel may be closer to the surface. The difference in depth between the peak of the detection intensity of nickel and the peak of the detection intensity of magnesium is preferably less than or equal to 3 nm, further preferably less than or equal to 1 nm. The distribution of magnesium is not normal distribution in some cases. The distribution of nickel is not normal distribution in some cases.

As shown in FIG. 10A and FIG. 10B, in the region having the edge plane, the peak of the detection intensity of aluminum is preferably positioned more internally in the inner portion 100d than that of magnesium. The distribution of magnesium and the distribution of aluminum may overlap with each other as shown in FIG. 10A, or there may be almost no overlap between the distribution of magnesium and that of aluminum as shown in FIG. 10B. A peak of the detection intensity of aluminum may be located in the surface portion 100a or may be located deeper than the surface portion 100a. For example, the peak is preferably observed in a region of greater than or equal to 5 nm and less than or equal to 30 nm toward the inner portion from the surface or the reference point. The distribution of aluminum is not normal distribution in some cases.

In such a manner, aluminum is more distributed in the inner portion 100d than magnesium is, which is presumably because the diffusion rate of aluminum is higher than that of magnesium. Meanwhile, the detection intensity of aluminum is low in the region that is the closest to the surface, which is presumably because aluminum can be more stable in a region other than a region where magnesium or the like is solid-soluted at a high concentration.

To be specific, in a region having a layered rock-salt crystal structure belonging to the space group R-3m or a cubic rock-salt crystal structure, the distance between a cation and oxygen in a region where magnesium is solid-soluted at a high concentration is longer than that in LiAlO₂ having a layered rock-salt crystal structure, and thus aluminum is less likely to be stable. In the vicinity of cobalt, valence change due to replacement of Li⁺ with Mg²⁺ can be offset by Co²⁺ which is changed from Co³⁺, so that cation balance can be maintained. By contrast, Al is always trivalent and thus is presumed to be unlikely to be together with magnesium in a rock-salt or layered rock-salt crystal structure.

Note that it is acceptable that magnesium, nickel, and aluminum do not have the distributions as shown in FIG. 10A and FIG. 10B in the entire region having the edge plane of the positive electrode active material 100.

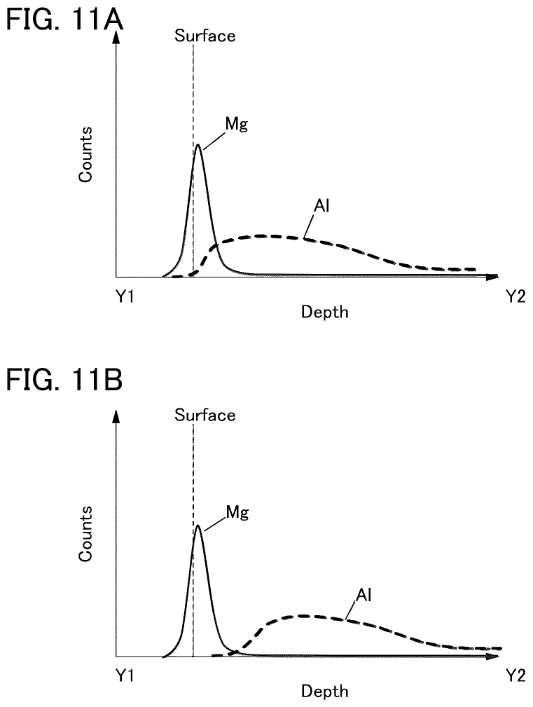

FIG. 11A and FIG. 11B show examples of distributions of additive elements obtained by STEM-EDX line analysis performed on Y1-Y2 of the positive electrode active material 100 illustrated in FIG. 9A. Since the Y1-Y2 corresponds to the region having the basal plane of the positive electrode active material 100, FIG. 11A and FIG. 11B can each be regarded as an example of distributions of the additive elements in the region having the basal plane.

As shown in FIG. 11A and FIG. 11B, the distributions of the additive elements in the region having the basal plane may be different from the distributions of the additive elements in the region having the edge plane. Specifically, the distribution of nickel in the region having the basal plane may be smaller than that in the region having the edge plane.

As shown in FIG. 11A and FIG. 11B, the peak of the detection intensity of the additive element in the region having the basal plane may be located shallower from the surface than that in the region having the edge plane. Specifically, the peaks of the detection intensities of magnesium and aluminum in the region having the basal plane may be located shallower from the surface than those in the region having the edge plane.

In a layered rock-salt crystal structure belonging to R-3m of the positive electrode active material 100, cations are arranged parallel to the (001) plane. In other words, CoO₂ layers and lithium layers are alternately stacked in parallel with the (001) plane. The CoO₂ layer is relatively stable, and thus the surface of the positive electrode active material 100 is more stable when having a (001) orientation. Thus, a diffusion path of lithium ions also is parallel to the (001) plane, and a main diffusion path of lithium ions in charging and discharging is not exposed on the (001) plane.

Thus, the plane other than the (001) plane and the surface portion thereof easily lose stability because they are regions where extraction of lithium ions starts as well as important regions for maintaining a diffusion path of lithium ions. Thus, the additive elements in the region having a plane other than the (001) plane are preferably distributed as illustrated in FIG. 10A to FIG. 11B. Among the additive elements, especially nickel may be detected in a region having a plane other than the (001) plane, and the nickel concentration in the region having the (001) plane may be low.

As described in the above-described embodiment, in the manufacturing method in which high-purity LiCoO₂ is formed, an additive element is then mixed, and heating is performed, the additive element spreads mainly through a diffusion path of lithium ions. Thus, the additive element distribution in the region having the plane other than the (001) plane can easily fall within a preferred range.

An effect of inhibiting a shift in the crystal structure due to magnesium and/or nickel is efficiently exhibited in the surface portion 100a; however, magnesium and nickel are less likely to be solid-soluted in the inner portion 100d. Thus, owing to aluminum that is easily diffused into the inner portion 100d, the effect of inhibiting a shift in the crystal structure can be efficiently exhibited in the inner portion 100d. Since the inner portion 100d accounts for the majority of the positive electrode active material 100, inhibition of a shift in the crystal structure in the inner portion 100d owing to aluminum can improve the cycle performance. Note that aluminum has a high bonding strength with oxygen; thus, it is inferred that a shift in the CoO₂ structure can be inhibited even when lithium ions are extracted by discharging.

The above-described additive element can further stabilize the crystal structure of the positive electrode active material 100 in charging. Needless to say, the additive element is not necessarily contained as long as the crystal structure of the positive electrode active material 100 can be further stabilized in charging.

Besides EDX line analysis, for example, XPS (X-ray photoelectron spectroscopy) analysis or EPMA (electron probe micro analysis) can be employed for specifying the atomic ratio of the additive element.

### <Substantially Aligned>

Owing to the above-described additive element concentration gradient, in some cases, the inner portion 100d has a layered rock-salt crystal structure, and the surface and the surface portion 100a have a rock-salt crystal structure or a crystal structure having features of both a rock-salt crystal structure and a layered rock-salt crystal structure, for example. It is preferable that the crystal structure continuously change from the inner portion 100d toward the surface portion 100a. Alternatively, the crystal orientations of the surface portion 100a and the inner portion 100d are preferably substantially aligned with each other.

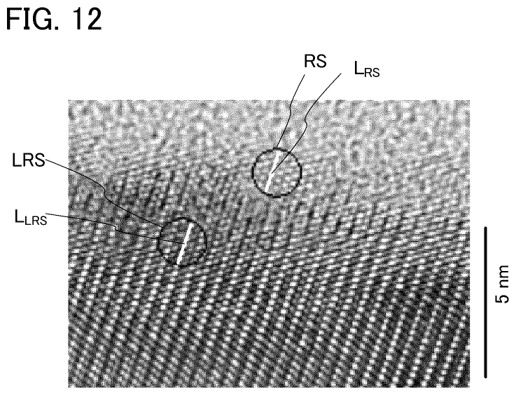

FIG. 12 shows an example of a TEM image in which orientations of a layered rock-salt crystal LRS of the inner portion 100d and a rock-salt crystal RS of the surface portion 100a are substantially aligned with each other. For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., LRs and LLRS shown in FIG. 12) is 5° or less or 2.5° or less in the TEM image, it can be determined that the crystal planes are substantially aligned with each other, that is, crystal orientations are substantially aligned with each other. Similarly, when the angle between the dark lines is 5° or less or 2.5° or less, it can be determined that crystal orientations are substantially aligned with each other.

An image reflecting a crystal structure is obtained not only in a TEM image but also in a HAADF-STEM image, an ABF-STEM image, and the like.

In a HAADF-STEM image, a contrast proportional to the atomic number is obtained, and an element having a larger atomic number is observed to be brighter. For example, in the case of lithium cobalt nickel oxide that has a layered rock-salt structure belonging to the space group R-3m, cobalt (atomic number: 27) and nickel (atomic number: 28) each have the large atomic number; hence, an electron beam is strongly scattered at the positions of a cobalt atom and a nickel atom, and arrangement of the cobalt atoms and the nickel atoms is observed as bright lines or arrangement of high-luminance dots. Thus, when the lithium cobalt nickel oxide having a layered rock-salt crystal structure is observed in the direction perpendicular to the c-axis, arrangement of the cobalt atoms and the nickel atoms is observed as bright lines or arrangement of high-luminance dots, and arrangement of lithium atoms and oxygen atoms is observed as dark lines or a low-luminance region in the direction perpendicular to the c-axis. Also in the case where fluorine (atomic number: 9) and magnesium (atomic number: 12) are contained as the additive elements of the lithium cobalt nickel oxide, arrangement of fluorine atoms and magnesium atoms is observed as dark lines or a low-luminance region.

Consequently, in the case where repetition of bright lines and dark lines is observed in two regions having different crystal structures and the angle between the bright lines is 5° or less or 2.5° or less in a HAADF-STEM image, it can be determined that arrangements of the atoms are substantially aligned with each other, that is, crystal orientations are substantially aligned with each other. Similarly, when the angle between the dark lines is 5° or less or 2.5° or less, it can be determined that crystal orientations are substantially aligned with each other. With an ABF-STEM, an element having a smaller atomic number is observed to be brighter, but a contrast corresponding to the atomic number is obtained as with a HAADF-STEM; hence, in an ABF-STEM image, crystal orientations can be determined as in a HAADF-STEM image.

By electron diffraction, a TEM image, a cross-sectional STEM image, or the like, it can be determined that the surface portion 100a or the like has features of both a layered rock-salt crystal structure and a rock-salt crystal structure.

When a layered rock-salt crystal structure is observed from a direction perpendicular to the c-axis in a cross-sectional STEM image or the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image or the like, and a metal that has a larger atomic number than lithium is present in part of the layers with low luminance, i.e., the lithium layers.

Anions of a layered rock-salt crystal and anions of a rock-salt crystal form a cubic close-packed structure (face-centered cubic lattice structure). Thus, when a layered rock-salt crystal and a rock-salt crystal are in contact with each other, there is a crystal plane at which orientations of cubic close-packed structures composed of anions are aligned with each other. In this specification, a state where the orientations of the cubic close-packed structures composed of anions in the layered rock-salt crystal and the rock-salt crystal are aligned with each other is referred to as a state where crystal orientations are substantially aligned with each other in some cases. In addition, topotaxy refers to having similarity in a three-dimensional structure such that crystal orientations are substantially aligned with each other, or to having the same orientations crystallographically.

### <Crystal Structure>

The positive electrode active material 100 of one embodiment of the present invention has a unique crystal structure. The crystal structure is described in comparison with that of conventional lithium cobalt oxide. In the description of the crystal structure, the amount of lithium ions to be extracted is denoted by x, the positive electrode active material 100 is denoted by LiₓCoO₂, and the description is made focusing on x. Note that the amount of lithium ions to be extracted, x, is different from the addition amount of lithium.

<<x in LiₓCoO₂ being 1>>

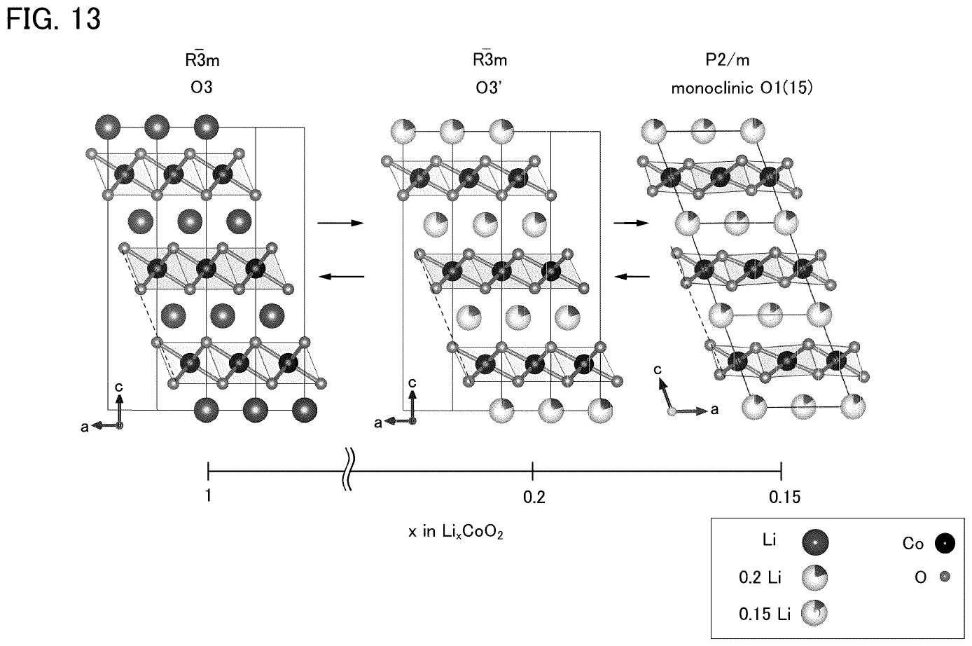

FIG. 13 shows the crystal structure of the positive electrode active material 100 of one embodiment of the present invention, and the horizontal axis represents the value of x in LiₓCoO₂. The positive electrode active material 100 of one embodiment of the present invention preferably has a layered rock-salt crystal structure in a discharged state, i.e., a state where x in LiₓCoO₂ is 1. It is particularly preferable that the inner portion 100d, which accounts for the majority of the volume of the positive electrode active material 100, have a layered rock-salt crystal structure belonging to the space group R-3m.

In FIG. 13, the layered rock-salt crystal structure is denoted by R-3m O3. In FIG. 13, “O3” is next to the space group. In this crystal structure, lithium occupies octahedral sites and a unit cell includes three layers each composed of octahedrons of the transition metal M (M is typically cobalt) and oxygen (hereinafter such layer is referred to as an MO₂ layer); thus, this crystal structure is sometimes referred to as an O3 type crystal structure. Note that the MO₂ layer refers to a structure in which an octahedral structure with the transition metal M coordinated to six oxygen atoms continues on a plane in an edge-shared state. Although lithium ions are at all the lithium sites in FIG. 13, the additive element, e.g., a magnesium ion, may be positioned at a lithium site as described above.

The surface portion 100a of the positive electrode active material 100 of one embodiment of the present invention can have a function of reinforcing the layered structure, which is formed of the MO₂ layers, of the inner portion 100d so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100d of the positive electrode active material 100 such as extraction of oxygen and/or a shift in the layered structure formed of the MO₂ layers, and/or inhibition of decomposition of an organic electrolyte solution or the like on the surface of the positive electrode active material 100. Since magnesium can inhibit extraction of oxygen therearound, the above-described reinforcement can be achieved when at least magnesium is contained as the additive element.

The surface portion 100a may have a crystal structure different from that of the inner portion 100d, for example. The surface portion 100a preferably has a more stable crystal structure than that of the inner portion 100d at room temperature (25° C.), in which case the above-described reinforcing effect can be exhibited. For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted first in charging, and is a region that tends to have a lower concentration of lithium than the inner portion 100d. It can be said that bonds between atoms are partly cut on the surface of the particle of the positive electrode active material 100 included in the surface portion 100a. Thus, the surface portion 100a is regarded as a region that tends to be unstable and tends to start deterioration of the crystal structure. For example, it is considered that a shift in the crystal structure of the layered structure, which is formed of the MO₂ layers, in the surface portion 100a has an influence on the inner portion 100d to cause a shift in the crystal structure of the layered structure in the inner portion 100d, leading to deterioration of the crystal structure in the whole positive electrode active material 100. Meanwhile, when the surface portion 100a can be made sufficiently stable, the layered structure, which is formed of the MO₂ layers, of the inner portion 100d is less likely to be broken even with small x in LiₓCoO₂. Furthermore, a shift in the MO₂ layers of the inner portion 100d can be inhibited.

As described above, the additive element distribution at the (001) plane of the positive electrode active material 100 may be different from that at a plane other than the (001) plane. This is probably because the MO₂ layer is relatively stable in a layered rock-salt crystal structure, and thus the surface of the positive electrode active material 100 is more stable when the surface is the (001) plane and a diffusion path of lithium ions is exposed at the plane other than the (001) plane. A main diffusion path of lithium ions in charging and discharging is not exposed at the (001) plane; meanwhile, the plane other than the (001) plane, at which a diffusion path of lithium ions is exposed, is an important region for maintaining a diffusion path of lithium ions. Moreover, the plane other than the (001) plane is a region from which lithium ions are extracted first, and thus is likely to be unstable. Thus, it is preferable to reinforce the plane other than the (001) plane so that the crystal structure of the whole positive electrode active material 100 is maintained.

Therefore, in the case of magnesium, the half width of the magnesium distribution at the (001) plane and the surface portion 100a having the plane is preferably greater than or equal to 5 nm and less than or equal to 150 nm, further preferably greater than or equal to 10 nm and less than or equal to 100 nm, still further preferably greater than or equal to 20 nm and less than or equal to 80 nm. The half width of the magnesium distribution at the plane other than the (001) plane and the surface portion 100a having the plane is preferably greater than 150 nm and less than or equal to 280 nm, further preferably greater than 180 nm and less than or equal to 250 nm, still further preferably greater than or equal to 200 nm and less than or equal to 230 nm. In the case where the half width is regarded as the distribution width, the distribution width at the (001) plane and the surface portion 100a having the plane is preferably greater than or equal to 10 nm and less than or equal to 300 nm in the profile of magnesium. The distribution width of magnesium at the plane other than the (001) plane and the surface portion 100a having the plane is preferably greater than 300 nm and less than or equal to 500 nm. Since magnesium might increase the resistance value of the surface portion 100a, magnesium preferably has a narrow distribution width as described above.

As described in the above embodiment, in the manufacturing method in which heating is performed after the additive element is mixed, the additive element may spread mainly through a diffusion path of lithium ions. Thus, in order to make the additive element distribution fall within a preferred range at the plane other than the (001) plane and the surface portion 100a having the plane, it is preferable to employ a method in which the additive element is mixed after the formation of lithium cobalt nickel oxide. Note that magnesium is preferable because magnesium has a large ion radius and thus is likely to remain in the surface portion 100a in whichever step magnesium is added.

### [Magnesium]

Since the ion radius of magnesium is close to the ion radius of a lithium ion, magnesium ions easily enter lithium sites in a layered rock-salt crystal structure. Magnesium occupying lithium sites of the surface portion 100a at an appropriate concentration can facilitate maintenance of the crystal structure of the inner portion 100d. This is presumably because magnesium occupying lithium sites serves as a column supporting the MO₂ layers. Moreover, magnesium occupying lithium sites can inhibit release of oxygen therearound and can inhibit a thermal decomposition reaction even in a state where x in LiₓCoO₂ is small. In addition, it is expected that a high magnesium concentration in the surface portion 100a increases the corrosion resistance to hydrofluoric acid generated by the decomposition of the organic electrolyte solution or the like.

### [Nickel]

Nickel has a lower oxidation-reduction potential than cobalt, and thus facilitates release of lithium during charging, for example. Therefore, the positive electrode active material 100 with a high atomic ratio of nickel is expected to increase the charge and discharge speed.

Ionization tendency is the lowest in nickel, followed in order by cobalt, aluminum, and magnesium (Mg>Al>Co>Ni). Therefore, it is considered that in charging, nickel is less likely to be dissolved into an electrolyte solution than the other elements described above. Accordingly, nickel has a high effect of stabilizing the crystal structure of the surface portion in a charged state, and nickel are preferably present in both the inner portion 100d and the surface portion 100a.

### [Aluminum]

Aluminum can occupy a cobalt site in a layered rock-salt crystal structure. Since aluminum is a trivalent representative element and its valence does not change, lithium around aluminum is unlikely to move even in charging and discharging. Thus, aluminum and lithium therearound can maintain the distance between adjacent MO₂ layers, so that a change in the crystal structure can be inhibited. This can inhibit deterioration of the positive electrode active material 100 if force of expansion and contraction of the positive electrode active material 100 in the c-axis direction operates owing to insertion and extraction of lithium ions, i.e., force of expansion and contraction in the c-axis direction operates owing to a change in charge depth or charge rate.

Furthermore, aluminum has effects of inhibiting dissolution of cobalt therearound and improving continuous charge tolerance. Moreover, an Al—O bond is stronger than an MO bond, specifically, a CoO bond, and thus extraction of oxygen around aluminum can be inhibited. These effects improve thermal stability. Hence, a secondary battery including the positive electrode active material 100 containing aluminum as the additive element can have a higher level of safety. Furthermore, the positive electrode active material 100 can have a crystal structure that is unlikely to be broken by repeated charging and discharging.

### [Synergistic Effect of a Plurality of Elements]

When the surface portion 100a contains both magnesium and nickel, nickel can be present more stably in the vicinity of magnesium. Thus, even with small x in LiₓCoO₂, dissolution of magnesium can be inhibited when the surface portion 100a contains both magnesium and nickel. This can contribute to stabilization of the surface portion 100a.

When a plurality of the additive elements are contained as described above, the effects of the additive elements contribute synergistically to further stabilization of the surface portion 100a. In particular, magnesium, nickel, and aluminum are preferably contained because a high effect of stabilizing the composition and crystal structure can be obtained.

Note that the surface portion 100a occupied by only a compound of an additive element and oxygen is not preferable, in which case insertion and extraction of lithium become difficult. For example, it is not preferable that the surface portion 100a be occupied by only a structure in which MgO is solid-soluted. Thus, it is necessary that the surface portion 100a contain at least cobalt, also contain lithium in a discharged state, and have a path through which lithium is inserted and extracted. To secure the path through which lithium is inserted and extracted sufficiently, the concentration of cobalt is preferably higher than that of magnesium in the surface portion 100a. It is allowable that the concentration of nickel is higher than that of magnesium in the surface portion 100a.

It is preferable that magnesium, which is one of the additive elements, have a higher concentration in the surface portion 100a than in the inner portion 100d and is randomly present also in the inner portion 100d to have a low concentration. When magnesium is present in the lithium sites of the inner portion 100d at an appropriate concentration, an effect of facilitating maintenance of the layered rock-salt crystal structure can be obtained in a manner similar to the above.

It is preferable that aluminum, which is one of the additive elements, have a higher concentration in the surface portion 100a than in the inner portion 100d and is randomly present also in the inner portion 100d to have a low concentration. When aluminum is present in the lithium sites of the inner portion 100d at an appropriate concentration, an effect of facilitating maintenance of the layered rock-salt crystal structure can be obtained in a manner similar to the above.

When nickel is present in the inner portion 100d, a shift in the layered structure formed of the MO₂ layers can be inhibited in a manner similar to the above. In addition, when nickel is present in the surface portion 100a, a shift in the layered structure formed of the MO₂ layers can be inhibited in a manner similar to the above.

<<x in LiₓCoO₂ being Small>>

Since the positive electrode active material 100 of one embodiment of the present invention has the above-described additive element distribution and/or crystal structure, the positive electrode active material 100 is different from conventional lithium cobalt oxide in the crystal structure in a state where x in LiₓCoO₂ is small, i.e., a high-voltage charged state. Here, “x is small” means, for example, 0.10<x≤0.24. A high voltage in a charged state means a voltage higher than or equal to 4.5 V, higher than or equal to 4.6 V, preferably higher than or equal to 4.7 V, further preferably higher than or equal to 4.8 V.

First, conventional lithium cobalt oxide is described. Conventional lithium cobalt oxide with x=approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

Conventional lithium cobalt oxide with x=0 has the trigonal crystal structure belonging to the space group P-3 ml and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x=approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that insertion and extraction of lithium do not necessarily uniformly occur in the positive electrode active material in reality; thus, a change in the crystal structure does not strictly correspond to the amount of lithium to be extracted, and the value of the amount of lithium to be extracted may be obtained at the timing when a crystal change starts.

When charging that makes x be 0.24 or less and discharging are repeated, the crystal structure of conventional lithium cobalt oxide repeatedly changes between the R-3m O3 structure in a discharged state and the H1-3 type crystal structure (i.e., an unbalanced phase change).

There is a large shift in the CoO₂ layers between these two crystal structures. The CoO₂ layer in the H1-3 type crystal structure largely shifts from R-3m O3 in a discharged state. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable. Accordingly, when charging that makes x be 0.24 or less and discharging are repeated, the crystal structure of conventional lithium cobalt oxide is gradually broken. The broken crystal structure triggers deterioration of the cycle performance. This is because the broken crystal structure has a smaller number of sites where lithium can be present stably and makes it difficult to insert and extract lithium.

Next, the positive electrode active material 100 of one embodiment of the present invention is described. In the positive electrode active material 100 of one embodiment of the present invention illustrated in FIG. 13, a change in the crystal structure in a state where x in LiₓCoO₂ is small, e.g., x=approximately 0.2 and x=approximately 0.15 is different from that in conventional lithium cobalt oxide. FIG. 13 illustrates a trigonal crystal structure belonging to the space group R-3m of the positive electrode active material 100 of one embodiment of the present invention with x=approximately 0.2. The symmetry of the CoO₂ layers of this structure is the same as that of O3. Thus, this crystal structure is called an O3′ type crystal structure. In FIG. 13, this crystal structure is denoted by R-3m O3′. An XRD pattern of this crystal structure is sometimes similar to a pattern of a spinel structure, and thus, this crystal structure may be referred to as a pseudo-spinel structure. The positive electrode active material 100 of one embodiment of the present invention with x of approximately 0.15 has a monoclinic crystal structure belonging to the space group P2/m. This structure includes one CoO₂ layer in a unit cell. The expression “x is approximately 0.15” may mean that lithium in the positive electrode active material 100 is approximately 15 atomic % of that in a discharged state. Thus, this crystal structure is referred to as a monoclinic O1 (15) type crystal structure. In FIG. 13, this crystal structure is denoted by P2/m monoclinic O1 (15).

As denoted by dotted lines in FIG. 13, in the positive electrode active material 100 of one embodiment of the present invention, the CoO₂ layers hardly shift in the O3′ type crystal structure. Furthermore, in the positive electrode active material 100 of one embodiment of the present invention, the shift in the CoO₂ layers is small between the state with x of 1 and the state with small x. Furthermore, in the positive electrode active material 100 of one embodiment of the present invention, a change in the volume per the same number of atoms of the transition metal can be small. Thus, in the positive electrode active material 100 of one embodiment of the present invention, the crystal structure is less likely to be broken, and the site at which lithium can be present stably is maintained even when charging that makes x be approximately 0.2, specifically, 0.24 or less, and discharging are repeated; accordingly, excellent cycle performance can be achieved.

The positive electrode active material 100 of one embodiment of the present invention can stably use a larger amount of lithium than conventional lithium cobalt oxide, and thus the positive electrode active material 100 enables high discharge capacity per weight and per volume. Thus, with use of the positive electrode active material 100, a secondary battery with high discharge capacity per weight and per volume can be manufactured.

The positive electrode active material 100 of one embodiment of the present invention can have a more stable crystal structure than conventional lithium cobalt oxide in a state where x in LiₓCoO₂ is 0.24 or less. Thus, in the positive electrode active material 100 of one embodiment of the present invention, oxygen is not easily released even when the state where x in LiₓCoO₂ is 0.24 or less is maintained, which can inhibit a thermal decomposition reaction. It is presumed that ignition does not occur in a lithium-ion secondary battery including the positive electrode active material 100 when the battery undergoes a nail penetration test. In other words, a secondary battery preferably includes the positive electrode active material 100 of one embodiment of the present invention to have improved safety.

In this specification and the like, “ignition does not occur in a nail penetration test” refers to a state where fire is not observed outside an exterior body or a state where thermal runaway of a secondary battery does not occur. That is, a state where a spark and/or smoke that are/is observed but do/does not spread is equivalent to a state where ignition does not occur.

In the unit cell of the O3′ type crystal structure of the positive electrode active material 100, the typical coordinates of cobalt and oxygen can be represented as follows: Co (0, 0, 0.5) and O (0, 0, x) within the range of 0.20≤x≤0.25. In the unit cell of the O3′ type crystal structure, the lattice constant of the a-axis is preferably 2.797×10⁻¹⁰≤a≤2.837×10⁻¹⁰ (m), further preferably 2.807×10⁻¹⁰≤a≤2.827×10⁻¹⁰ (m), typically a=2.817×10⁻¹⁰ (m). The lattice constant of the c-axis is preferably 13.681×10⁻¹⁰≤c≤13.881×10⁻¹⁰ (m), further preferably 13.751×10⁻¹⁰≤c≤13.811×10⁻¹⁰ (m), typically c=13.781×10⁻¹⁰ (m).

In order to make x in LiₓCoO₂ small, charging with a high charge voltage is necessary in general. Thus, the state where x in LiₓCoO₂ is small can be rephrased as a state where charging with a high charge voltage has been performed. For example, when constant current (CC) charging is performed and then constant voltage (CV) charging is performed (this is referred to as CCCV charging) at a voltage higher than or equal to 4.6 V using the potential of a lithium metal as a reference at 25° C., the H1-3 type crystal structure starts to appear in conventional lithium cobalt oxide. Meanwhile, the positive electrode active material 100 of one embodiment of the present invention is preferable because the crystal structure with the symmetry of R-3m O3 can be maintained even when CCCV charging is performed at a high charge voltage, for example, at a voltage higher than or equal to 4.6 V at 25° C.

In this specification and the like, unless otherwise specified, a charge voltage is shown using the potential of a lithium metal as a reference. Note that when a material other than the lithium metal is used for a counter electrode, the potential of a secondary battery differs from the potential of the positive electrode. As for the potential of the positive electrode, for example, charging at 4.5 V using a graphite counter electrode substantially corresponds to charging at 4.6 V using a lithium counter electrode.

Although lithium is present at all lithium sites with equal probability in the O3′ type crystal structure in illustration of FIG. 13, one embodiment of the present invention is not limited thereto. Lithium may be present unevenly in only some of the lithium sites. The lithium distribution can be analyzed by neutron diffraction, for example.

As described above, the crystal structure of the positive electrode active material 100 of one embodiment of the present invention preferably changes in accordance with a change in x in LiₓCoO₂, and this change is preferably unique and different from that of conventional lithium cobalt oxide. Note that the change in x in LiₓCoO₂ is equivalent to a change in a charge depth, and a charge depth in the case where x=0.2 corresponds to 1-0.2=0.8.

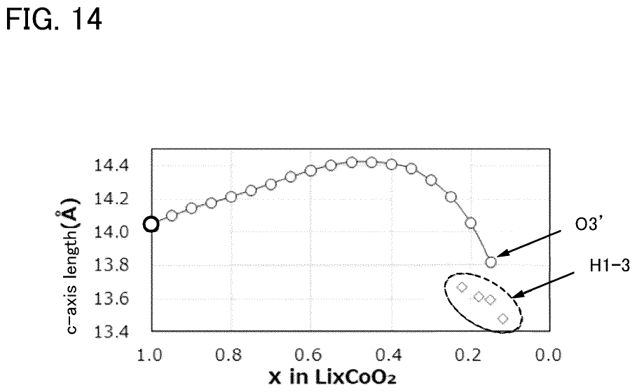

As already described above, the crystal structure of each of conventional lithium cobalt oxide and the positive electrode active material 100 changes in accordance with a change in charge depth, i.e., a change in x in LiₓCoO₂. FIG. 14 shows a change in the c-axis length with respect to x in LiₓCoO₂. The O3′ type crystal structure is preferable because the c-axis length can be greater than or equal to 13.6×10⁻¹⁰ (m) and less than 14.0×10⁻¹⁰ (m) when x is 0.24 or less.

### <<Analysis Method>>

Whether or not a given positive electrode active material has the O3′ type crystal structure in charging can be determined by analyzing a positive electrode including the positive electrode active material with small x in LiₓCoO₂ by XRD, electron diffraction, neutron diffraction, electron spin resonance (ESR), nuclear magnetic resonance (NMR), or the like. For example, x can be 0.2.

Note that a positive electrode active material with small x sometimes causes a change in its crystal structure when exposed to the air. For that reason, all samples subjected to analysis of crystal structures are preferably handled in an inert atmosphere such as an argon atmosphere.

XRD is particularly preferable because the symmetry of a transition metal contained in the positive electrode active material can be analyzed with high resolution, the degrees of crystallinity and the crystal orientations can be compared, the distortion of lattice periodicity and the crystallite can be analyzed, and a positive electrode itself obtained by disassembling a secondary battery can be measured with sufficient accuracy, for example. A diffraction peak reflecting the crystal structure of the inner portion 100d of the positive electrode active material 100, which accounts for the majority of the volume of the positive electrode active material 100, can be obtained through XRD, in particular, powder XRD.

### <<Charge Method>>

Charging for determining whether or not a positive electrode active material is the positive electrode active material 100 of one embodiment of the present invention can be performed using a coin cell (CR2032 type with a diameter of 20 mm and a height of 3.2 mm) that is formed using a lithium metal for a counter electrode, for example.

More specifically, a positive electrode can be formed by application of slurry in which the positive electrode active material, a conductive material, and a binder are mixed onto a positive electrode current collector made of aluminum foil.

A lithium metal can be used for the counter electrode as described above, but a material other than a lithium metal may be used. When a material other than the lithium metal is used, the potential of a secondary battery differs from the potential of the positive electrode. Unless otherwise specified, the voltage and the potential in this specification and the like refer to a potential of a positive electrode.

As a lithium salt contained in the electrolyte solution, 1 mol/L of lithium hexafluorophosphate (LiPF₆) is used, and as the electrolyte solution, a mixed solvent in which ethylene carbonate (EC) and diethyl carbonate (DEC) are mixed at EC:DEC=3:7 (volume ratio) can be used. In the electrolyte solution, 2 wt % of vinylene carbonate (VC) may be mixed to the mixture solvent as an additive agent.

As a separator, a 25-μm-thick polypropylene porous film can be used.

A can formed with stainless steel (SUS) can be used as each of a positive electrode can and a negative electrode can.

The coin cell manufactured under the above-described conditions is charged at a freely selected voltage (e.g., 4.6 V, 4.65 V, 4.7 V, 4.75 V, or 4.8 V). For example, in the case of CCCV charging, a current in the CC charging can be higher than or equal to 20 mA/g and lower than or equal to 100 mA/g. The CV charging can be terminated at a current higher than or equal to 2 mA/g and lower than or equal to 10 mA/g. To observe a phase change of the positive electrode active material, charging with such a small current value is desirably performed. The XRD measurement temperature is preferably set to 25° C. After charging is performed in this manner, the coin cell is disassembled in a glove box with an argon atmosphere to take out the positive electrode, whereby the positive electrode active material with a predetermined charge capacity, i.e., a predetermined charge depth can be obtained. In order to inhibit a reaction with components in the external environment, the positive electrode is preferably enclosed in an argon atmosphere in performing various analyses later. For example, XRD can be performed on the positive electrode active material enclosed in an airtight container with an argon atmosphere. After charging is completed, the positive electrode is preferably taken out immediately and subjected to the analysis. Specifically, the positive electrode is preferably subjected to the analysis within an hour after the completion of charging, further preferably within 30 minutes after the completion of charging.

In the case where the crystal structure in a charged state after performing charging and discharging multiple times is analyzed, the conditions of the multiple times of charging and discharging may be different from the above-described charge conditions. For example, as the charging, CC charging can be performed to a freely selected voltage (e.g., 4.6 V, 4.65 V, 4.7 V, 4.75 V, or 4.8 V) at a current value of higher than or equal to 20 mA/g and lower than or equal to 100 mA/g, and then CV charging can be performed until the current value becomes higher than or equal to 2 mA/g and lower than or equal to 10 mA/g. As the discharging, CC discharging can be performed at a current value of higher than or equal to 20 mA/g and lower than or equal to 100 mA/g until the discharge voltage reaches 2.5 V.

Also in the case where the crystal structure in a discharged state after the charging and discharging are performed multiple times is analyzed, CC discharging can be performed at a current value higher than or equal to 20 mA/g and lower than or equal to 100 mA/g until the discharge voltage reaches 2.5 V, for example.

### <<XRD>>

The apparatus and conditions of the XRD measurement are not particularly limited as long as appropriate adjustment and calibration are performed. For example, the above-described XRD conditions can be used. In this specification and the like, the 20 value of a diffraction peak refers to the 20 value at which a peak top of the diffraction peak is exhibited in an XRD pattern after a calculation model is fitted. There is no particular limitation on crystal structure analysis software used for the fitting; for example, it is possible to use TOPAS ver. 3 (crystal structure analysis software produced by Bruker Corporation).

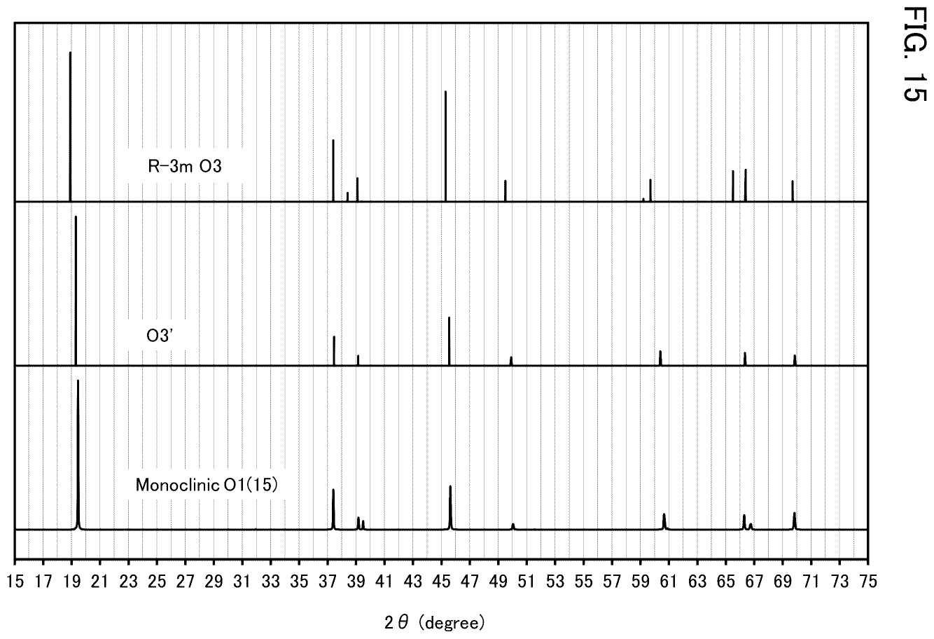

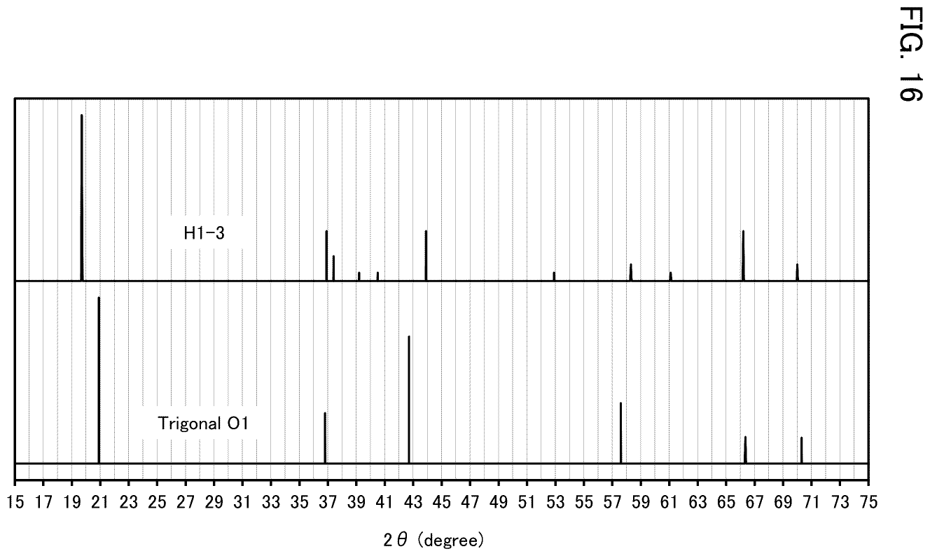

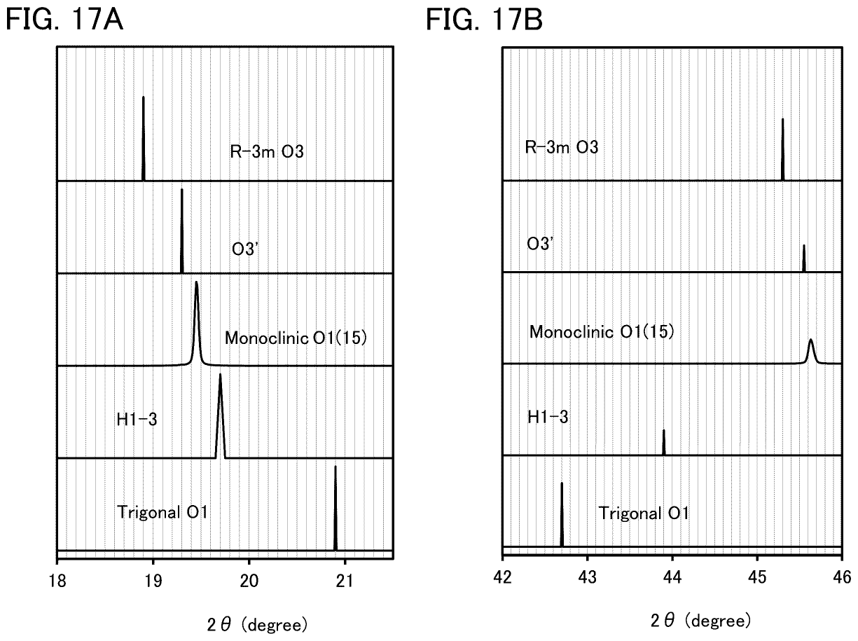

FIG. 15, FIG. 16, FIG. 17A, and FIG. 17B show ideal powder XRD patterns with CuKα₁ radiation that are calculated from models of the O3′ type crystal structure, the monoclinic O1 (15) type crystal structure, and the H1-3 type crystal structure. For comparison, ideal XRD patterns calculated from the crystal structure of LiCoO₂ O3 with x=1 in LiₓCoO₂ and the crystal structure of the trigonal O1 with x=0 are also shown. FIG. 17A and FIG. 17B each show the XRD patterns of the O3′ type crystal structure, the monoclinic O1 (15) type crystal structure, and the H1-3 type crystal structure, and FIG. 17A and FIG. 17B are enlarged diagrams showing, respectively, a range of 2θ greater than or equal to 18° and less than or equal to 21° and a range of 2θ greater than or equal to 42° and less than or equal to 46°. Note that the patterns of LiCoO₂ (O3) and CoO₂ (O1) are made from crystal structure data obtained from the ICSD (Inorganic Crystal Structure Database) (see Non-Patent Document 5) with use of Reflex Powder Diffraction, which is a module of Materials Studio (BIOVIA). The 2θ range is from 15° to 75°, the step size is 0.01, the wavelength 21 is 1.540562×10⁻¹⁰ m, 22 is not set, and a single monochromator is used. The pattern of the H1-3 type crystal structure is similarly made from the crystal structure data disclosed in Non-Patent Document 3. Patterns of the O3′ type crystal structure and the monoclinic O1 (15) type crystal structure are estimated from the XRD pattern of the positive electrode active material 100, fitting is performed with TOPAS ver. 3 (crystal structure analysis software produced by Bruker Corporation), and the XRD patterns of the O3′ type crystal structure and the monoclinic O1 (15) type crystal structure are made in a manner similar to that for other structures.

As shown in FIG. 15, FIG. 17A, and FIG. 17B, the O3′ type crystal structure exhibits diffraction peaks at a 2θ position greater than or equal to 19.13° and less than 19.37° and at a 2θ position greater than or equal to 45.37° and less than 45.57°.

Furthermore, the monoclinic O1 (15) type crystal structure exhibits diffraction peaks at a position of 2θ=19.47+0.10° (greater than or equal to 19.37° and less than or equal to 19.57°) and at a position of 2θ=45.62+0.05° (greater than or equal to 45.57° and less than or equal to 45.67°).

However, as shown in FIG. 16, FIG. 17A, and FIG. 17B, the H1-3 type crystal structure and the trigonal O1 do not exhibit peaks at these positions. Thus, exhibiting the peak at greater than or equal to 19.13° and less than 19.37° and/or the peak at greater than or equal to 19.37° and less than or equal to 19.57° and the peak at greater than or equal to 45.37° and less than 45.57° and/or the peak at greater than or equal to 45.57° and less than or equal to 45.67° in a state with small x in LiₓCoO₂ can be the feature of the positive electrode active material 100.

It can be said that the positions of the XRD diffraction peaks exhibited by the crystal structure with x=1 and the crystal structure with x≤0.24 are close to each other. More specifically, it can be said that a difference in 20 between the main diffraction peak exhibited by the crystal structure with x=1 and the main diffraction peak exhibited by the crystal structure with x≤0.24, which are exhibited at 20 of greater than or equal to 42° and less than or equal to 46°, is 0.7° or less, preferably 0.5° or less.

Although the positive electrode active material 100 has the O3′ type crystal structure and/or the monoclinic O1 (15) type crystal structure when x in LiₓCoO₂ is small, not all of the particles necessarily have the O3′ type crystal structure and/or the monoclinic O1 (15) type crystal structure. The positive electrode active material may include another crystal structure or may be partly amorphous. Typically, when the XRD patterns are subjected to Rietveld analysis, the O3′ type crystal structure and/or the monoclinic O1 (15) type crystal structure preferably account(s) for greater than or equal to 50%, further preferably greater than or equal to 60%, still further preferably greater than or equal to 66%. The O3′ type crystal structure and/or the monoclinic O1 (15) type crystal structure account(s) for greater than or equal to 50%, preferably greater than or equal to 60%, further preferably greater than or equal to 66%, in which case a positive electride active material enabling sufficiently good cycle performance can be provided.

Furthermore, even after 100 or more cycles of charging and discharging after the measurement starts, the O3′ type crystal structure and/or the monoclinic O1 (15) type crystal structure preferably account(s) for greater than or equal to 35%, further preferably greater than or equal to 40%, still further preferably greater than or equal to 43% when Rietveld analysis is performed.

In addition, the H1-3 type crystal structure and the O1 type crystal structure preferably account for less than or equal to 50% in the Rietveld analysis performed in a similar manner.

Sharpness of a diffraction peak in an XRD pattern indicates the degree of crystallinity. It is thus preferable that the diffraction peaks after charge be sharp or in other words, have a small half width, e.g., a small full width at half maximum. Even peaks that are derived from the same crystal phase have different half widths depending on the XRD measurement conditions or the 2θ value. In the case of the above-described measurement conditions, the diffraction peak observed at 2θ of greater than or equal to 43° and less than or equal to 46° preferably has a full width at half maximum of less than or equal to 0.2°, further preferably less than or equal to 0.15°, still further preferably less than or equal to 0.12°. Note that not all peaks need to fulfill the requirement. A crystal phase can be regarded as having high crystallinity when some peaks fulfill the requirement. Such high crystallinity sufficiently contributes to stability of the crystal structure after charging.

The crystallite sizes of the O3′ type crystal structure and the monoclinic O1 (15) type crystal structure included in the positive electrode active material 100 are only decreased to approximately one-twentieth that of LiCoO₂ (O3) in a discharged state. Thus, a clear peak(s) of the O3′ type crystal structure and/or the monoclinic O1 (15) type crystal structure can be observed when x in LiₓCoO₂ is small, even under the same XRD measurement conditions as those of a positive electrode before charging and discharging. In contrast, conventional LiCoO₂ has a small crystallite size and a broad and small peak even when it can have a structure part of which is similar to the O3′ type crystal structure and/or the monoclinic O1 (15) type crystal structure. The crystallite size can be calculated from the half width of the XRD peak.

### <<XPS>>

In an inorganic oxide, a region to a depth of approximately 2 nm to 8 nm (normally, 5 nm or less) from the surface can be analyzed by X-ray photoelectron spectroscopy (XPS) using monochromated aluminum Ka radiation as an X-ray source; thus, the concentrations of elements in a region of approximately half the depth of the surface portion 100a of the positive electrode active material 100 can be quantitatively analyzed. The bonding states of the elements can be analyzed by narrow scanning.

In the positive electrode active material 100 of one embodiment of the present invention, the concentration of one or two or more selected from the additive elements is preferably higher in the surface portion 100a than in the inner portion 100d. This means that the concentration of one or two or more selected from the additive elements in the surface portion 100a is preferably higher than the average concentration in the entire positive electrode active material 100. For this reason, for example, it is preferable that the concentration of one or two or more additive elements selected from the surface portion 100a, which is measured by XPS or the like, be higher than the average additive element concentration in the entire positive electrode active material 100, which is measured by ICP-MS (inductively coupled plasma-mass spectrometry), GD-MS (glow discharge mass spectrometry), or the like. For example, the magnesium concentration in at least part of the surface portion 100a, which is measured by XPS or the like, is preferably higher than the average of the magnesium concentration in the entire positive electrode active material 100. The nickel concentration in at least part of the surface portion 100a is preferably higher than the average of the nickel concentration in the entire positive electrode active material 100. The aluminum concentration in at least part of the surface portion 100a is preferably higher than the average of the aluminum concentration in the entire positive electrode active material 100. The fluorine concentration in at least part of the surface portion 100a is preferably higher than the average of the fluorine concentration in the entire positive electrode active material 100.

The additive element concentration may be compared using the ratio of the additive element to cobalt. The use of the ratio of the additive element to cobalt is preferable because it enables comparison while reducing the influence of a carbonate or the like which is chemically adsorbed after formation of the positive electrode active material. For example, in the XPS analysis, the atomic ratio Mg/Co of magnesium to cobalt is preferably greater than or equal to 0.4 and less than or equal to 1.5. In the ICP-MS analysis, Mg/Co is preferably greater than or equal to 0.001 and less than or equal to 0.06.

Similarly, to ensure the path through which lithium is inserted and extracted sufficiently, the concentrations of lithium and cobalt are preferably higher than those of the additive elements in the surface portion 100a of the positive electrode active material 100. This means that the concentrations of lithium and cobalt in the surface portion 100a are preferably higher than the concentration(s) of one or two or more selected from the additive elements contained in the surface portion 100a, which is measured by XPS or the like.

Furthermore, when XPS analysis is performed on the positive electrode active material 100 of one embodiment of the present invention, the atomic ratio of magnesium is preferably greater than or equal to 0.4 times and less than or equal to 1.2 times, further preferably greater than or equal to 0.65 times and less than or equal to 1.0 times the atomic ratio of cobalt. The atomic ratio of aluminum is preferably less than or equal to 0.12 times, further preferably less than or equal to 0.09 times the atomic ratio of cobalt. When the ratio is within the above range, it can be said that the additive element is widely distributed at a preferable concentration in the surface portion 100a of the positive electrode active material 100.

In the XPS analysis, monochromatic aluminum Ko radiation can be used as an X-ray source, for example. An extraction angle is, for example, 45°. For example, the measurement can be performed using the following apparatus and conditions.
Measurement device: PHI Quantera II
X-ray source: monochromatic Al Kα (1486.6 eV)
Detection area: 100 μmφ
Detection depth: approximately 4 to 5 nm (extraction angle) 45°
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from both 685 eV, which is the bonding energy of lithium fluoride, and 686 eV, which is the bonding energy of magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to the value of the bonding energy of magnesium oxide.

### <<EDX>>

The one or two or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated, for example, by exposing a cross section of the positive electrode active material 100 using FIB (Focused Ion Beam) or the like and analyzing the cross section using energy dispersive X-ray spectroscopy, EPMA (electron probe microanalysis), or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. The measurement of a region without scanning is referred to as point analysis.

By EDX area analysis (e.g., element mapping), the additive element concentrations in the surface portion 100a, the inner portion 100d, the vicinity of the grain boundary 101, and the like of the positive electrode active material 100 can be quantitatively analyzed. By EDX line analysis, the concentration distribution and the highest additive element concentration can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

In EDX area analysis or EDX point analysis of the positive electrode active material 100 of one embodiment of the present invention, the concentration of each additive element, in particular, the additive element in the surface portion 100a is preferably higher than that in the inner portion 100d.

In EDX line analysis, EDX area analysis, or EDX point analysis of the positive electrode active material 100, the ratio of the atomic ratio of magnesium Mg to the atomic ratio of cobalt Co (Mg/Co) at a peak of the magnesium concentration is preferably greater than or equal to 0.05 and less than or equal to 0.6, further preferably greater than or equal to 0.1 and less than or equal to 0.4. The ratio of the atomic ratio of aluminum Al to the atomic ratio of cobalt Co (Al/Co) at a peak of the aluminum concentration is preferably greater than or equal to 0.05 and less than or equal to 0.6, further preferably greater than or equal to 0.1 and less than or equal to 0.45.

According to a result of the EDX line analysis, where the surface of the positive electrode active material 100 is can be estimated in the following manner, for example. A point where the detected amount of an element which is uniformly present in the inner portion 100d of the positive electrode active material 100, e.g., oxygen or cobalt, is ½ of the detected amount thereof in the inner portion 100d is used as the surface of the positive electrode active material 100.

Since the positive electrode active material 100 is a composite oxide, the detected amount of oxygen can be used to estimate where the surface is. Specifically, an average value Oₐᵥₑ of the oxygen concentration in a region of the inner portion 100d where the detected amount of oxygen is stable is calculated first. At this time, in the case where oxygen O_{bg} which is presumably led from chemical adsorption or the background is detected in a region that is obviously outside the surface, O_{bg} can be subtracted from the measurement value to obtain the average value Oₐᵥₑ of the oxygen concentration. The measurement point where the measurement value which is closest to ½ of the average value Oₐᵥₑ, i.e., Oₐᵥₑ/2, is obtained can be estimated to be the surface of the positive electrode active material 100.

The detected amount of cobalt can also be used to estimate where the surface of the positive electrode active material 100 is, as in the above description. Alternatively, the sum of the detected amounts of a plurality of transition metals can be used for the estimation in a similar manner. The detected amount of the transition metal such as cobalt is less likely to be affected by chemical adsorption and thus is suitable for estimating where the surface is.

This embodiment can be used in combination with any of the other embodiments or the examples.

### Embodiment 5

In this embodiment, examples of a secondary battery of one embodiment of the present invention are described with reference to FIG. 14.

### <Structure Example 1 of Secondary Battery>

Hereinafter, a secondary battery in which a positive electrode, a negative electrode, and an electrolyte solution are stored in an exterior body is described as an example.

### [Positive Electrode]

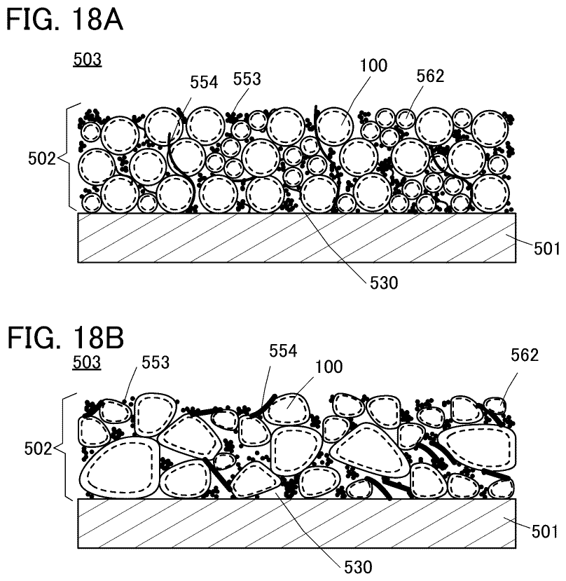

FIG. 18A illustrates an example of a cross-sectional view of a positive electrode 503 used for a secondary battery. The positive electrode 503 includes a positive electrode active material layer 502 over a positive electrode current collector 501. The positive electrode active material layer 502 includes the positive electrode active material 100, a positive electrode active material 562, a conductive material 553, a conductive material 554, and an electrolyte solution 530. The positive electrode active material layer 502 also includes a binder (not illustrated). The secondary battery may include either the conductive material 553 or the conductive material 554.

A median diameter (D50) of the positive electrode active material 100 is preferably greater than or equal to 1 μm and less than or equal to 50 μm, preferably greater than or equal to 5 μm and less than or equal to 30 μm. To increase the filling density, the positive electrode active material 562 with a different median diameter (D50) is preferably added. The median diameter (D50) of the positive electrode active material 562 is preferably 1/10 to ⅙ of D50 of the positive electrode active material 100. When particle size distribution measurement is performed on an active material in which the positive electrode active material 100 and the positive electrode active material 562 are mixed, two peaks with different local maximum values are observed. Needless to say, two or more peaks may be observed. Note that the filling density can be increased without the positive electrode active material 562.

Although the boundary between a surface portion and an inner portion is indicated by a dotted line in FIG. 18A, the boundary is not always as clear as that in FIG. 18A.

The active material of the positive electrode active material 100 may be the same as or different from the active material of the positive electrode active material 562. The same active materials contain the same main source material but may be different in the presence of an additive element or the like. The different active materials contain different main source materials.

As already described above, it is preferable that the positive electrode active material 100 and the positive electrode active material 562 contain an additive element. The additive element may be unevenly distributed or may be thinly distributed in the inner portion.

The surface portion may contain the additive element. The additive element concentration in the surface portion is preferably different from the additive element concentration in the inner portion. The additive element concentration in the surface portion is preferably higher than the additive element concentration in the inner portion. This state is sometimes described as uneven distribution of the additive element in the surface portion.

Although sometimes referred to as positive electrode active material particles, the positive electrode active material 100 and the positive electrode active material 562 are in any of a variety of forms other than a particle form. Unlike FIG. 18A, FIG. 18B illustrates the positive electrode 503 including a positive electrode active material in a form other than a particle form. The positive electrode active material in FIG. 18B is the same as that in FIG. 18A except for its form and thus is not described.

Although the positive electrode active material 100 and the positive electrode active material 562 are illustrated as primary particles in FIG. 18A and FIG. 18B, they may be secondary particles. The positive electrode active material 100 and the positive electrode active material 562 are preferably single particles.

The positive electrode active material of one embodiment of the present invention and another positive electrode active material may be mixed to be used. Examples of the another positive electrode active material include a composite oxide having an olivine crystal structure, a composite oxide having a layered rock-salt crystal structure, and a composite oxide having a spinel crystal structure. For example, a compound such as LiFePO₄, LiFeO₂, LiNiO₂, LiMn₂O₄, V₂O₅, Cr₂O₅, or MnO₂ can be used.

As the another positive electrode active material, it is preferable to mix lithium nickel oxide (LiNiO₂ or LiNi₁₋ₓMₓO₂ (0<x<1) (M=Co, Al, or the like) with a lithium-containing material that has a spinel crystal structure and contains manganese, such as LiMn₂O₄. This composition can improve the characteristics of the secondary battery.

As the another positive electrode active material, a lithium-manganese composite oxide that can be represented by a composition formula LiₐMn_{b}M_{c}O_{d} can be used. Here, the element M is preferably silicon, phosphorus, or a metal element other than lithium and manganese, further preferably nickel. In the case where all lithium-manganese composite oxide particles are measured, it is preferable to satisfy the following at the time of discharging: 0<a/(b+c)<2; c>0; and 0.26≤(b+c)/d<0.5 (note that a, b, c, and d are not 0). Note that the proportions of metals, silicon, phosphorus, and the like in all lithium-manganese composite oxide particles can be measured with, for example, an ICP-MS (inductively coupled plasma mass spectrometer). The proportion of oxygen in all lithium-manganese composite oxide particles can be measured by, for example, EDX (energy dispersive X-ray spectroscopy). In addition, the proportion of oxygen can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain one or two or more selected from a group consisting of chromium, cobalt, aluminum, nickel, iron, magnesium, molybdenum, zinc, indium, gallium, copper, titanium, niobium, silicon, phosphorus, and the like.

### [Conductive Material]

The conductive material has a function of giving aid to, for example, a current path between the active material and the current collector or a current path between a plurality of active materials. In order to have such a function, the conductive material preferably contains a material having lower resistance than the active material. The conductive material is also referred to as a conductive additive or a conductivity-imparting agent because of its function.

As the conductive material, a carbon material or a metal material is typically used. The conductive material is in a particle form; examples of the particulate conductive material include carbon black (e.g., furnace black, acetylene black, or graphite). Carbon black mostly has a smaller particle diameter than the positive electrode active material. The conductive material is in a fibrous form; examples of the fibrous conductive additive include carbon nanotube (CNT) and VGCF (registered trademark). Some of the conductive materials are sheet-shaped conductive materials; examples of the sheet-shaped conductive additive include multilayer graphene. The sheet-shaped conductive additive sometimes looks like a thread in observation of a cross section of a positive electrode.

The particulate conductive material can enter a gap of the positive electrode active material or the like and easily aggregates. Thus, the particulate conductive material can give aid to a conductive path between positive electrode active materials provided close to each other. Although having a bent region, the fibrous conductive material is larger than the positive electrode active material. The fibrous conductive material can thus give aid not only to a conductive path between adjacent positive electrode active materials but also to a conductive path between positive electrode active materials located apart from each other. Conductive additives in two or more forms are preferably mixed.

In the case of using multilayer graphene as the sheet-shaped conductive material and carbon black as a particulate conductive material, the weight of the carbon black is preferably 1.5 times to 20 times, further preferably 2 times to 9.5 times the weight of the multilayer graphene in the state of slurry where these are mixed.

When the mixing ratio between multilayer graphene and carbon black is in the above-described range, carbon black does not aggregate and is easily dispersed. When the mixing ratio between multilayer graphene and carbon black is in the above range, the electrode density can be higher than when only carbon black is used as a conductive additive. As the electrode density is higher, the capacity per unit weight can be higher.

Moreover, when the mixing ratio between multilayer graphene and carbon black is in the above range, fast charging is possible.

Graphene in this specification and the like refers to multilayer graphene and multi graphene. In other words, graphene contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound also refers to graphene oxide, multilayer graphene oxide, multi graphene oxide, reduced graphene oxide, reduced multilayer graphene oxide, reduced multi graphene oxide, graphene quantum dots, and the like. That is, a graphene compound may include a functional group. Graphene or a graphene compound is preferably bent. Graphene or a graphene compound may be rolled, and rolled graphene is referred to as a carbon nanofiber in some cases.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

As a graphene compound, fluorine-containing graphene may be used. Fluorine in the graphene compound is preferably adsorbed on a surface. Fluorine-containing graphene can be formed by making graphene and a fluorine compound contact with each other (which is called fluorination treatment). For the fluorination treatment, fluorine (F₂) or a fluorine compound is preferably used. The fluorine compound is preferably hydrogen fluoride, halogen fluoride (e.g., CIF₃ or IF₅), a gaseous fluoride (e.g., BF₃, NF₃, PF₅, SiF₄, or SF₆), a metal fluoride (e.g., LiF, NiF₂, AlF₃, or MgF₂), or the like. For the fluorination treatment, a gaseous fluoride is preferably used, and the gaseous fluoride may be diluted with an inert gas. The fluorination treatment is preferably performed at room temperature or in a temperature range higher than or equal to 0° C. and lower than or equal to 250° C., which includes the room temperature. Performing the fluorination treatment at higher than or equal to 0° C. enables adsorption of fluorine onto a surface of graphene.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistant surface contact. Furthermore, a graphene compound sometimes has extremely high conductivity even with a small thickness, and thus a small amount of a graphene compound efficiently allows a conductive path to be formed in an active material layer. Hence, by using a graphene compound as the conductive material, the area where the active material and the conductive material are in contact with each other can be increased. The graphene compound preferably covers 80% or more of the area of the active material. Note that the graphene compound preferably clings to at least part of an active material particle. The graphene compound preferably overlays at least part of the active material particle. The shape of the graphene compound preferably conforms to at least part of the shape of the active material particle. The shape of an active material particle means, for example, an uneven surface of a single active material particle or an uneven surface formed by a plurality of active material particles. The graphene compound preferably surrounds at least part of an active material particle. The graphene compound may have a hole.

In the case where active material particles with small diameters, e.g., active material particles with diameters of 1 μm or less, are used, the specific surface areas of the active material particles are large and thus more conductive paths for connecting the active material particles are needed. In such a case, it is particularly preferable to use a graphene compound that can efficiently form a conductive path even with a small amount.

It is particularly effective to use a graphene compound, which has the above-described properties, as a conductive material of a secondary battery that needs to be rapidly charged and rapidly discharged. For example, a secondary battery for a two-wheeled or four-wheeled vehicle, a secondary battery for a drone, or the like is required to be rapidly charged and rapidly discharged in some cases. In addition, a mobile electronic device or the like is required to have fast charge characteristics in some cases. Rapid charging and discharging are referred to as charging and discharging at, for example, 200 mA/g, 400 mA/g, or 1000 mA/g or more.

In the active material layer, sheet-shaped graphene or a graphene compound is preferably dispersed uniformly. A plurality of sheets of graphene or a plurality of graphene compounds are formed to partly cover the plurality of active materials or adhere to the surfaces of the plurality of particulate active materials, so that the plurality of sheets of graphene or the plurality of graphene compounds make surface contact with each other.

Here, the plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active materials. Accordingly, the amount of the binder can be reduced, or the binder does not have to be used. This can increase the proportion of the active material in the electrode volume and the electrode weight. That is to say, the discharge capacity of the secondary battery can be increased.

Here, it is preferable to perform reduction after the active material layer is formed in such a manner that graphene oxide is used as the graphene or the graphene compound and mixed with an active material. That is, the formed active material layer preferably contains reduced graphene oxide. When graphene oxide with extremely high dispersibility in a polar solvent is used for the formation of the graphene or the graphene compound, the graphene or the graphene compound can be substantially uniformly dispersed in the active material layer. The solvent is removed by volatilization from a dispersion medium in which graphene oxide is uniformly dispersed, and the graphene oxide is reduced; hence, graphene or the graphene compounds remaining in the active material layer partly overlap with each other and are dispersed such that surface contact is made, thereby forming a three-dimensional conduction path. Note that graphene oxide can be reduced by heat treatment or with the use of a reducing agent, for example.

Unlike a particulate conductive material, such as acetylene black, which makes point contact with an active material, the graphene or the graphene compound is capable of making low-resistance surface contact; accordingly, the electrical conduction between the active material with a small amount compared with a normal conductive material and the graphene or the graphene compound can be improved.

It is possible to form, with a spray dry apparatus, a graphene compound serving as a conductive material as a coating portion to cover the entire surface of the active material in advance and to form a conductive path between the active materials using the graphene compound.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The particle diameter is represented by D50 and the D50 is preferably less than or equal to 1 μm, further preferably less than or equal to 100 nm.

As the conductive material, acetylene black (referred to as AB) can be used instead of graphene. Fluorine-containing acetylene black may be used. Fluorine in the fluorine-containing acetylene black is preferably adsorbed on a surface. Fluorine-containing acetylene black can be formed by making acetylene black and a fluorine compound contact with each other (which is called fluorination treatment). For the fluorination treatment, the contents of the description on graphene can be referred to for acetylene black.

As the conductive material, a carbon fiber material (referred to as carbon nanotube or CNT) can be used instead of graphene and acetylene black. A fluorine-containing carbon nanotube may be used. Fluorine in the fluorine-containing carbon nanotube is preferably adsorbed on a surface. A fluorine-containing carbon nanotube can be formed by making a carbon nanotube and a fluorine compound contact with each other (which is called fluorination treatment). For the fluorination treatment, the contents of the description on graphene can be referred to for carbon nanotube.

### [Binder]

The binder, which does not cover the entire surface of the active material, is necessary for enhancing adhesion of the active material in powder form. The binder needs to have a property of adhering to the current collector. In other words, the binder preferably contains a material containing an adhering component. Furthermore, it is preferable that the binder be sufficiently flexible and resilient to a change in the state of the active material, in view of expansion of the active material. The binder also needs to be compatible with the electrolyte solution. Moreover, since a secondary battery involves an extremely strong oxidation reaction and an extremely strong reduction reaction, it is desirable that the binder do not deteriorate due to the reactions or be less reactive to the reactions.

As the binder, a rubber material such as styrene-butadiene rubber (SBR), styrene-isoprene-styrene rubber, acrylonitrile-butadiene rubber, butadiene rubber, or an ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and/or high elasticity but may have difficulty in viscosity modification when mixed in a solvent. In such a case, a rubber material or the like is preferably mixed with a material having a significant viscosity modifying effect, for example. As a material having a significant viscosity modifying effect, for example, a water-soluble polymer is preferably used. As a water-soluble polymer having a significant viscosity modifying effect, the above-mentioned polysaccharide, for example, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers the active material surface or is in contact with the surface forms a film, the film is expected to serve also as a passivation film to suppress the decomposition of the electrolyte solution. Here, a passivation film refers to a film without electrical conductivity or a film with extremely low electrical conductivity, and can inhibit the decomposition of an electrolyte solution at a potential at which a battery reaction occurs when the passivation film is formed on the active material surface, for example. It is more desirable that the passivation film can conduct lithium ions while suppressing electrical conduction.

### [Positive Electrode Current Collector]

For the positive electrode current collector, a material that has high conductivity, such as a metal like stainless steel, gold, platinum, aluminum, or titanium, or an alloy thereof can be used. It is preferable that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may also be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material and/or a carbon-based material can be used.

For the negative electrode active material, an element that enables charge and discharge reactions by an alloying reaction and a dealloying reaction with lithium can be used. For example, a material containing one or two or more selected from silicon, tin, gallium, aluminum, germanium, lead, antimony, bismuth, silver, zinc, cadmium, indium, and the like can be used. Such elements enable higher charge and discharge capacity than carbon; in particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO2), or molybdenum dioxide (MoO₂) can be used.

Alternatively, as the negative electrode active material, Li₃₋ₓMₓN (M=Co, Ni, Cu) with a Li₃N structure, which is a nitride of lithium and a transition metal, can be used. For example, Li_{2.6}Co_{0.4}N enables high discharge capacity (900 mAh/g, 1890 mAh/cm³), and thus is preferable.

A nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that even in the case of using a material containing lithium ions as a positive electrode active material, the nitride containing lithium and a transition metal can be used as the negative electrode active material when the lithium ions contained in the positive electrode active material are extracted in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorine compounds such as FeF₃ and BiF₃.

For the conductive material and the binder that can be included in the negative electrode active material layer, materials similar to those for the conductive material and the binder that can be included in the positive electrode active material layer can be used.

### [Negative Electrode Current Collector]

For the negative electrode current collector, a material similar to that of the positive electrode current collector can be used. Note that a material that does not alloy with carrier ions of lithium or the like is preferably used for the negative electrode current collector.

### [Electrolyte Solution]

The electrolyte solution contains a solvent and a lithium salt. As the solvent of the electrolyte solution, an aprotic organic solvent is preferable. For example, one or two or more of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used in combination. A solvent obtained by combining two or more solvents is referred to as a mixed solvent.

When ethylene carbonate (EC) and diethyl carbonate (DEC) are contained in the electrolyte solution, it is possible to use a mixed organic solvent in which the volume ratio between EC and DEC is x:100−x (where 20≤x≤40) on the assumption that the total content of EC and DEC is 100 vol %. More specifically, a mixed solvent containing EC and DEC at EC:DEC=30:70 (volume ratio) can be used.

In the case where ethylene carbonate (EC), ethyl methyl carbonate (EMC), and dimethyl carbonate (DMC) are contained in the electrolyte solution, it is possible to use a mixed organic solvent in which the volume ratio between ethylene carbonate, ethyl methyl carbonate, and dimethyl carbonate is x:y:100−x−y (where 5≤x≤35 and 0<y<65) on the assumption that the total content of ethylene carbonate, ethyl methyl carbonate, and dimethyl carbonate is 100 vol %. More specifically, a mixed solvent containing EC, EMC, and DMC at EC:EMC:DMC=30:35:35 (volume ratio) can be used.

Furthermore, as the electrolyte solution, a mixed solvent containing a fluorinated cyclic carbonate or a fluorinated linear carbonate can be used. The above mixed solvent further preferably contains both a fluorinated cyclic carbonate and a fluorinated chain carbonate. A fluorinated cyclic carbonate and a fluorinated chain carbonate are preferable because they each include a substituent with an electron-withdrawing property and have a low solvation energy of a lithium ion. Accordingly, a fluorinated cyclic carbonate and a fluorinated chain carbonate are each suitable for the electrolyte solution, and a mixed solvent containing either of them is suitable for an electrolyte solution.

As a fluorinated cyclic carbonate, fluoroethylene carbonate (also referred to FEC, F1EC), difluoroethylene carbonate (DFEC, F2EC), trifluoroethylene carbonate (F3EC), or tetrafluoroethylene carbonate (F4EC) or the like can be used. Note that DFEC has isomers such as a cis-4,5 isomer and a trans-4,5 isomer. Each of these fluorinated cyclic carbonates includes a substituent with an electron-withdrawing property and thus is presumed to have a low solvation energy of a lithium ion. The substituent with an electron-withdrawing property in FEC is an F group.

An example of the fluorinated chain carbonate is methyl 3,3,3-trifluoropropionate. An abbreviation of methyl 3,3,3-trifluoropropionate is “MTFP”. The substituent with an electron-withdrawing property in MTFP is a CF₃ group.

FEC, which is a cyclic carbonate, has a high dielectric constant and thus has an effect of promoting dissociation of a lithium salt when used in an organic solvent. Furthermore, it can be said that since FEC includes a substituent having an electron-withdrawing property, a lithium ion is desolvated with FEC more easily than with ethylene carbonate (EC). Specifically, the solvation energy of a lithium ion is lower in FEC than in ethylene carbonate (EC), which does not include a substituent with an electron-withdrawing property. Thus, lithium ions are likely to be extracted from surfaces of a positive electrode active material and a negative electrode active material, which can reduce an internal resistance of a secondary battery. In addition, FEC probably has a deep highest occupied molecular orbital (HOMO) level and the deep HOMO level inhibits easy oxidation and improves oxidation resistance. Meanwhile, FEC disadvantageously has high viscosity. In view of this, a mixed organic solvent containing not only FEC but also MTFP is preferably used for the electrolyte solution. MTFP, which is a linear carbonate, can have an effect of reducing the viscosity of the electrolyte solution or maintaining the viscosity at room temperature (typically, 25° C.) even at low temperatures (typically, 0° C.). Moreover, MTFP has a lower solvation energy than methyl propionate (abbreviated as “MP”), which does not include a substituent with an electron-withdrawing property, and may solvate a lithium ion when used for the electrolyte solution.

FEC and MTFP having the above-described physical properties may be mixed in the ratio of x:100−x (where 5≤x≤30, preferably 10≤x≤20) on the assumption that a mixed c solvent containing FEC and MTFP accounts for 100 vol %. In other words, MTFP and FEC are preferably mixed such that the amount of MTFP is larger than that of FEC in the mixed solvent.

The above-described organic solvent is preferably highly purified and contains a small amount of particulate dust or a molecule other than the constituent molecules of the organic solvent (hereinafter also simply referred to as an “impurity”, which include oxygen (O₂) and water (H₂O) or moisture). It is preferable that generation of a reaction by-product in synthesis be inhibited through appropriate purification. Specifically, the impurity in the electrolyte is less than or equal to 100 ppm, preferably less than or equal to 50 ppm, further preferably less than 10 ppm. Among such impurities, the concentration of moisture can be detected by Karl Fischer titration.

Furthermore, it is preferable that peaks attributed to impurities in the above-described organic solvent be hardly observed by NMR measurement or the like. The expression “hardly observed” includes the case where the ratio of the integral area of the peak attributed to impurities to the integral area of the peak attributed to the main component (such a ratio is simply referred to as an integral ratio) is less than or equal to 0.005, preferably less than or equal to 0.002. An apparatus used for the NMR measurement is not particularly limited, and for example, “AVANCE III 400” (Bruker Corporation) can be used. Among the five peaks of acetonitrile derived from acetonitrile-d3 used in a solvent in the 1H-NMR measurement, the center peak can be 1.94 ppm.

For example, in the case of MTFP, it is known that when 1H-NMR is measured using an acetonitrile-d3 solvent, four peaks appear in the 8 range greater than or equal to 3.29 ppm and less than or equal to 3.43 ppm. However, in the case where another peak appears in the vicinity of the above range, for example, another peak appears in the 8 range greater than or equal to 3.24 ppm and less than or equal to 3.29 ppm, the peak is probably derived from impurities. Accordingly, when the ratio (integral ratio) of a peak area greater than or equal to 3.24 ppm and less than or equal to 3.29 ppm to a peak area greater than or equal to 3.29 ppm and less than or equal to 3.43 ppm is less than or equal to 0.005, preferably less than or equal to 0.002, peaks attributed to impurities are hardly observed.

The use of one or two or more kinds of ionic liquids (room temperature molten salts) which have features of non-flammability and non-volatility as the solvent of the electrolyte solution can prevent a secondary battery from exploding and/or igniting, for example, even when the secondary battery internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

### [Lithium Salt]

As a lithium salt (also referred to as an electrolyte) dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more kinds of these can be used in an appropriate combination in an appropriate ratio. The lithium salt is preferably greater than or equal to 0.5 mol/L and less than or equal to 3.0 mol/L with respect to the solvent. Using a fluoride such as LiPF₆ or LiBF₄ enables a lithium-ion secondary battery to have improved safety.

As the above-described electrolyte solution, it is preferable to use a highly purified electrolyte solution containing small contents of dust particles or elements other than the constituent elements of the electrolyte solution (hereinafter, also simply referred to as “impurities”). Specifically, the weight ratio of impurities to the electrolyte solution is preferably less than or equal to 1 wt %, further preferably less than or equal to 0.1 wt %, still further preferably less than or equal to 0.01 wt %.

### [Additive Agent]

The electrolyte solution may contain an additive agent. An additive agent can inhibit a decomposition reaction of an electrolyte which might occur on a positive electrode surface or a negative electrode surface when a secondary battery operates at a high voltage and/or high temperatures. As the additive agent, for example, vinylene carbonate (VC), propane sultone (PS), tert-butylbenzene (TBB), fluoroethylene carbonate (FEC), or lithium bis(oxalate) borate (LiBOB) is preferably used. It is particularly preferable to use LiBOB because it enables favorable film formation. VC or FEC is preferable because it forms a favorable coating film on a negative electrode at the time of charging and discharging, which improves the cycle performance. As the additive agent, a dinitrile compound containing succinonitrile, glutaronitrile, adiponitrile (ADN), ethylene glycol bis(propionitrile) ether (EGBE), or the like is preferably used. The dinitrile compound is preferable because its nitrile groups are oriented to the positive electrode active material and the negative electrode active material and oxidative decomposition of the organic solvent is hindered, whereby withstand voltage can be increased. Furthermore, in the case where copper is used in a current collector of a negative electrode, the dinitrile compound is preferable because it can inhibit dissolution of copper at the time of overdischarging. Considering the usage of the secondary battery at a high voltage, a dinitrile compound is preferably added.

Furthermore, fluorobenzene may be added to the above organic solvent. The concentration of the additive in the whole electrolyte solution is, for example, higher than or equal to 0.1 wt % and lower than or equal to 5 wt %. PS or EGBE is preferable because it forms a favorable coating film on a positive electrode at the time of charging and discharging, which improves the cycle performance. FB is preferable because it improves the wettability of the organic solvent with the positive electrode and the negative electrode.

As the additive agent, one or two or more of the above-described materials can be used.

### [Gel Electrolyte]

A polymer gel obtained in a manner in which a polymer is swelled with an electrolyte solution may be used as a gel electrolyte. When a polymer gel electrolyte is used, a semisolid electrolyte layer can be provided, so that safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is to be in contact with the positive electrode may be coated with the mixed material of aluminum oxide and aramid, and a surface of the polypropylene film that is to be in contact with the negative electrode may be coated with the fluorine-based material.

The use of a separator having a multilayer structure makes it possible to maintain the safety of the secondary battery even when the total thickness of the separator is small, so that the discharge capacity per volume of the secondary battery can be increased.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. An aluminum-containing film having a multilayer structure is sometimes referred to as an aluminum laminate film.

### <Structure Example 2 of Secondary Battery>

### [Solid Electrolyte]

Instead of the electrolyte solution, a solid electrolyte including an inorganic material such as a sulfide-based or oxide-based inorganic material, a solid electrolyte including a high-molecular material such as a PEO (polyethylene oxide)-based high-molecular material, or the like can be used. When the solid electrolyte is used, a separator and/or a spacer is not necessary. Furthermore, the battery can be entirely solidified; therefore, there is no possibility of liquid leakage and thus the safety of the battery is dramatically improved.

A structure of a secondary battery including a solid electrolyte layer is described below as a structure example of a secondary battery.

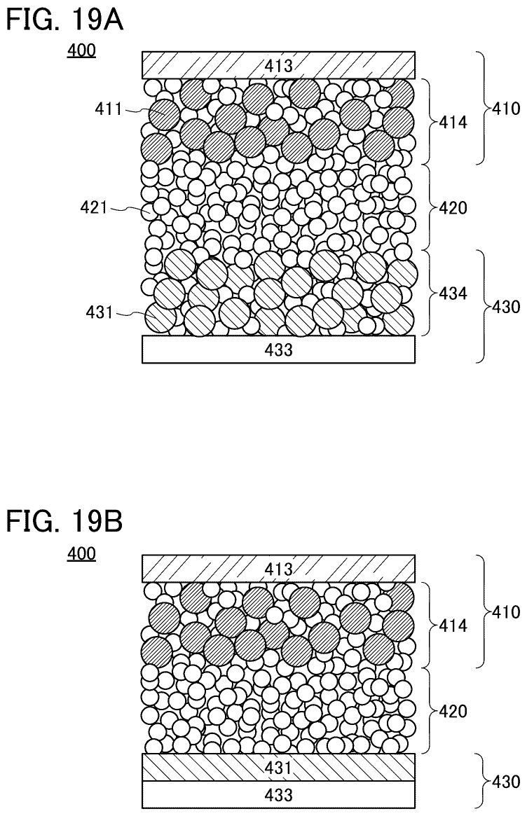

As illustrated in FIG. 19A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material manufactured by the manufacturing method described in the above embodiment is used. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive material and a binder. Note that when metal lithium is used for the negative electrode 430, it is possible that the negative electrode 430 does not include the solid electrolyte 421 as illustrated in FIG. 19B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1+X}Al_{X}Ti_{2-X} (PO₄)₃), a material with a garnet crystal structure (e.g., Li₇La₃Zr₂O₁₂), a material with a LISICON crystal structure (e.g., Li₁₄ZnGe₄O₁₆), LLZO(Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69} Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide and/or porous silica are filled with such a halide-based solid electrolyte can be used as the solid electrolyte.

Different solid electrolytes may be mixed and used.

In particular, Li₁₊ₓAlₓTi₂₋ₓ(PO₄)₃ (0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

This embodiment can be used in combination with any of the other embodiments or an example as appropriate.

### Embodiment 6

This embodiment describes examples of shapes of a secondary battery including the positive electrode active material 100 formed by the manufacturing method described in the foregoing embodiment.

### [Coin-Type Secondary Battery]

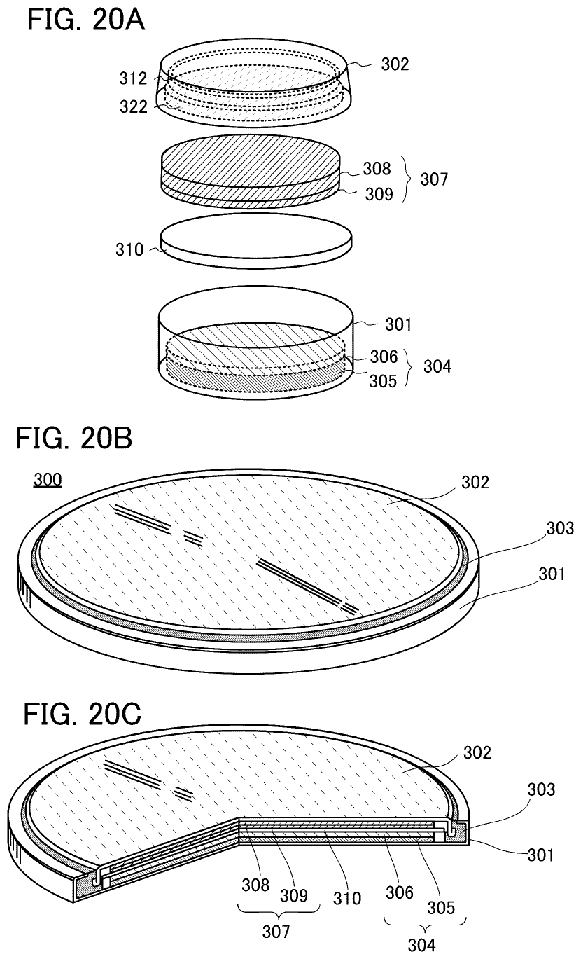

An example of a coin-type secondary battery is described. FIG. 20A is an exploded perspective view of a coin-type (single-layer flat type) secondary battery, FIG. 20B is an external view thereof, and FIG. 20C is a cross-sectional view thereof. Coin-type secondary batteries are mainly used in small electronic devices.

For easy understanding, FIG. 20A is a schematic view illustrating overlap (a vertical relation and a positional relation) between components. Thus, FIG. 20A and FIG. 20B do not completely correspond with each other.

In FIG. 20A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 20A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305. Slurry containing the positive electrode active material 100 is applied onto the current collector and dried, so that the positive electrode active material layer 306 is formed. After the positive electrode active material layer 306 is formed, press may be performed. The slurry contains a conductive material, a binder, and a solvent, in addition to the positive electrode active material 100. Note that a carbon material such as graphite or carbon fiber is used as the conductive material.

### [Conductive Material]

As the conductive material, a carbon material or a metal material is typically used. The conductive material is in a particle form; examples of the particulate conductive material include carbon black (e.g., furnace black, acetylene black, or graphite). Carbon black mostly has a smaller particle diameter than the positive electrode active material. The conductive material may be in a fibrous form; examples of the fibrous conductive additive include carbon nanotube (CNT) and VGCF (registered trademark). Other conductive materials are in a sheet form; examples of the sheet-shaped conductive additive include multilayer graphene. The sheet-shaped conductive additive sometimes looks like a thread in observation of a cross section of a positive electrode.

The particulate conductive material can enter a gap of the positive electrode active material or the like and easily aggregates. Thus, the particulate conductive material can give aid to a conductive path between positive electrode active materials provided close to each other. Although having a bent region, the fibrous conductive material is larger than the positive electrode active material. The fibrous conductive material can thus give aid not only to a conductive path between adjacent positive electrode active materials but also to a conductive path between positive electrode active materials located apart from each other. Conductive additives in two or more forms as described above are preferably mixed.

In the case of using multilayer graphene as the sheet-shaped conductive material and carbon black as a particulate conductive material, the weight of the carbon black is preferably 1.5 times to 20 times, further preferably 2 times to 9.5 times the weight of the multilayer graphene in the state of slurry where these are mixed. Moreover, when the mixing ratio between multilayer graphene and carbon black falls within the above-described range, rapid charging is possible.

Graphene in this specification and the like refers to multilayer graphene and multi graphene. In other words, graphene contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet.

A graphene compound in this specification and the like also refers to graphene oxide, multilayer graphene oxide, multi graphene oxide, reduced graphene oxide, reduced multilayer graphene oxide, reduced multi graphene oxide, graphene quantum dots, and the like. That is, a graphene compound may include a functional group. Graphene or a graphene compound preferably a bent shape. Graphene or a graphene compound may be rolled, and rolled graphene is referred to as a carbon nanofiber in some cases. In this specification and the like, graphene oxide contains carbon and oxygen, has a sheet-like shape, and includes a functional group, in particular, an epoxy group, a carboxy group, or a hydroxy group.

As a graphene compound, fluorine-containing graphene may be used. Fluorine in the graphene compound is preferably adsorbed on a surface. Fluorine-containing graphene can be formed by making graphene and a fluorine compound contact with each other (which is called fluorination treatment). For the fluorination treatment, fluorine (F₂) or a fluorine compound is preferably used. The fluorine compound is preferably hydrogen fluoride, halogen fluoride (e.g., CIF₃ or IF₅), a gaseous fluoride (e.g., BF₃, NF₃, PF₅, SiF₄, or SF₆), a metal fluoride (e.g., LiF, NiF₂, AlF₃, or MgF₂), or the like. For the fluorination treatment, a gaseous fluoride is preferably used, and the gaseous fluoride may be diluted with an inert gas. The fluorination treatment is preferably performed at room temperature or in a temperature range higher than or equal to 0° C. and lower than or equal to 250° C., which includes the room temperature. Performing the fluorination treatment at higher than or equal to 0° C. enables adsorption of fluorine onto a surface of graphene.

The graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistant surface contact. Furthermore, the graphene compound sometimes has an extremely high conductivity even with a small thickness, and thus a small quantity of the graphene compound allows a conductive path to be formed efficiently in the active material layer. Hence, by using a graphene compound as the conductive material, the area where the active material and the conductive material are in contact with each other can be increased. The graphene compound preferably covers 80% or more of the area of the active material. Note that the graphene compound preferably clings to at least part of an active material particle. The graphene compound preferably overlays at least part of the active material particle. The shape of the graphene compound preferably conforms to at least part of the shape of the active material particle. The shape of an active material particle means, for example, an uneven surface of a single active material particle or an uneven surface formed by a plurality of active material particles. The graphene compound preferably surrounds at least part of an active material particle. The graphene compound may have a hole.

In the case where active material particles with a small diameter, e.g., active material particles with a diameter of 1 μm or less, are used, the specific surface area of the active material particles is large and thus more conductive paths for connecting the active material particles are needed. In such a case, it is particularly preferable to use a graphene compound that can efficiently form a conductive path even with a small amount.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have rapid charge and rapid discharge characteristics in some cases. In addition, a mobile electronic device or the like is required to have rapid charge characteristics in some cases. Rapid charging and discharging are referred to as charging and discharging at, for example, 200 mA/g, 400 mA/g, or 1000 mA/g or more.

Fluorine-containing acetylene black may be used as the conductive material. Fluorine in the fluorine-containing acetylene black is preferably adsorbed on a surface. Fluorine-containing acetylene black can be formed by making acetylene black and a fluorine compound contact with each other (which is called fluorination treatment). For the fluorination treatment, the contents of the description on graphene can be referred to for acetylene black.

Fluorine in the fluorine-containing carbon nanotube is preferably adsorbed on a surface as the conductive material. A fluorine-containing carbon nanotube can be formed by making a carbon nanotube and a fluorine compound contact with each other (which is called fluorination treatment). For the fluorination treatment, the contents of the description on graphene can be referred to for carbon nanotube.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, water-soluble polymers are preferably used, for example. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, it is preferable to use a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose.

As the binder, two or more of the above materials may be used in combination.

FIG. 20B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 is formed of the positive electrode current collector 305 and the positive electrode active material layer 306 provided in contact with the positive electrode current collector 305. The negative electrode 307 is formed of a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 can be provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution or the like. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 20C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is manufactured. With the above structure, the coin-type secondary battery 300 can have a high level of safety.

### [Cylindrical Secondary Battery]

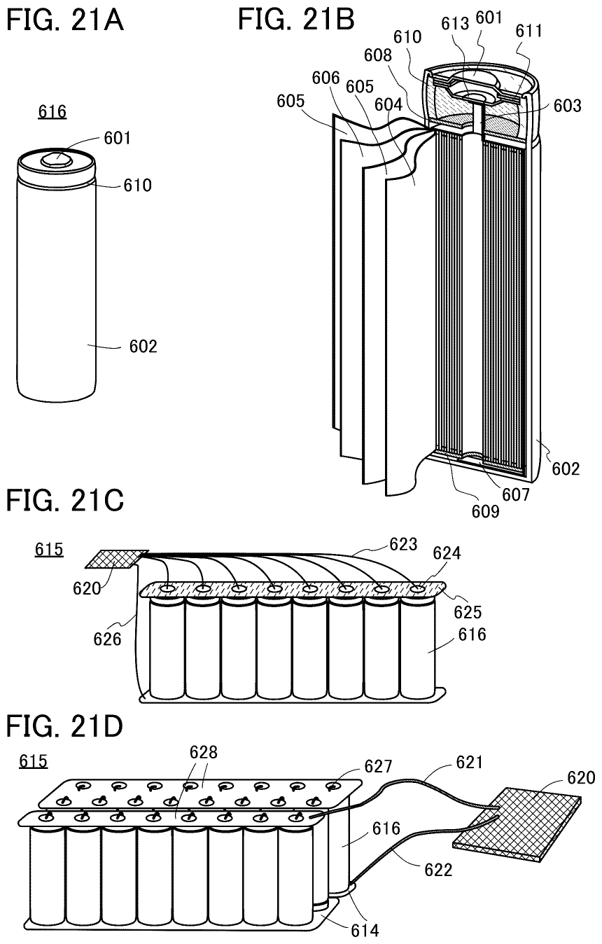

An example of a cylindrical secondary battery is described with reference to FIG. 21A. As illustrated in FIG. 21A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 21B is a diagram schematically illustrating a cross section of a cylindrical secondary battery. The cylindrical secondary battery illustrated in FIG. 21B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a wound body in which a strip-shaped positive electrode 604 and a strip-shaped negative electrode 606 are wound with a separator 605 located therebetween is provided. Although not illustrated, the wound body in which the strip-shaped positive electrode 604 and the strip-shaped negative electrode 606 are wound with the separator 605 located therebetween is wound around the central axis. One end of the battery can 602 is closed and the other end thereof is opened. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, and the like in order to prevent corrosion due to the electrolyte solution. Inside the battery can 602, the wound body in which the positive electrode, the negative electrode, and the separator are wound is provided between a pair of insulating plates 608 and 609 that face each other. The inside of the battery can 602 provided with the wound body is filled with a nonaqueous electrolyte solution (not illustrated). As the nonaqueous electrolyte solution, a nonaqueous electrolyte solution that is similar to that used for the coin-type secondary battery can be used.

Since a positive electrode and a negative electrode that are used for a cylindrical storage battery are wound, active materials are preferably formed on both surfaces of a current collector.

The positive electrode active material 100 obtained in Embodiment 1 is used in the positive electrode 604, whereby the cylindrical secondary battery 616 can have a high level of safety.

A positive electrode terminal (positive electrode current collecting lead) 603 is connected to the positive electrode 604, and a negative electrode terminal (negative electrode current collecting lead) 607 is connected to the negative electrode 606. For the positive electrode terminal 603, a metal material such as aluminum can be used. For the negative electrode terminal 607, a metal material such as copper can be used. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery increased and exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 21C shows an example of a power storage system 615. The power storage system 615 includes a plurality of the secondary batteries 616. The positive electrodes of the secondary batteries are in contact with and electrically connected to conductors 624 isolated by an insulator 625. The conductors 624 are electrically connected to a control circuit 620 through wirings 623. The negative electrodes of the secondary batteries are electrically connected to the control circuit 620 through a wiring 626. As the control circuit 620, a charging and discharging control circuit for performing charging, discharging, and the like or a protection circuit for preventing overcharging and/or overdischarging can be used.

FIG. 21D shows an example of the power storage system 615. The power storage system 615 includes a plurality of the secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in parallel, and then those sets may be connected in series.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 21D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

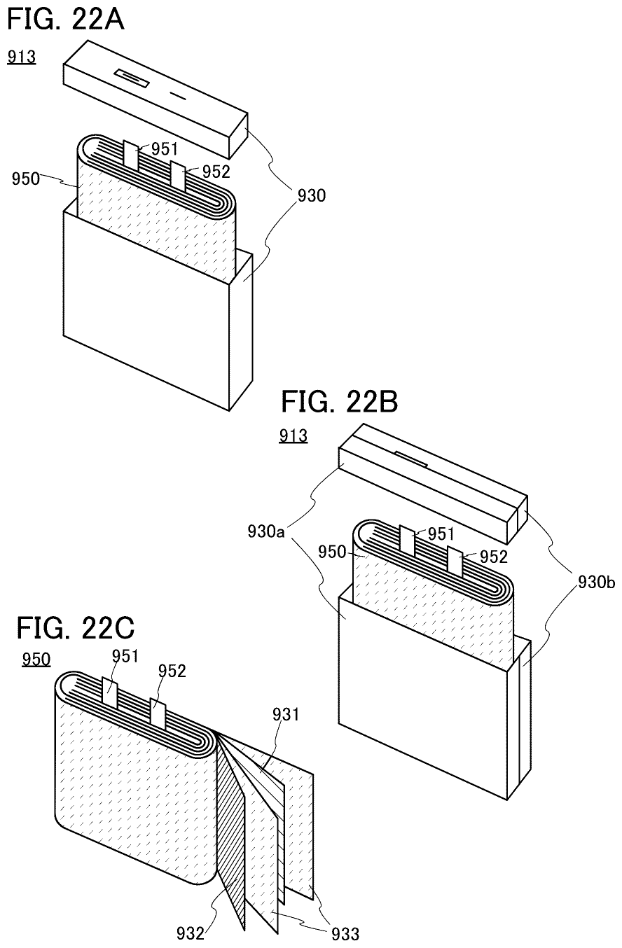

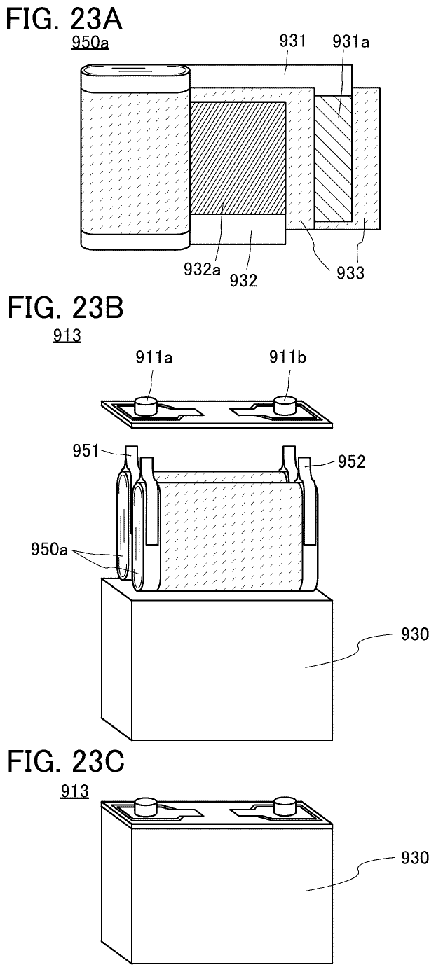

Structure examples of secondary batteries will be described with reference to FIG. 22 and FIG. 23.

A secondary battery 913 illustrated in FIG. 22A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 22A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a stack of a metal material and a resin material can be used.

Note that as illustrated in FIG. 22B, the housing 930 illustrated in FIG. 22A may be formed using a plurality of materials. For example, in the secondary battery 913 illustrated in FIG. 22B, a housing 930a and a housing 930b are attached to each other, and the wound body 950 is provided in a region surrounded by the housing 930a and the housing 930b.

For the housing 930a, a stack of a metal material and an organic resin can be used, for example. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material or a stack of a metal material and a resin material can be used, for example.

FIG. 22C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap each other with the separator 933 therebetween. Note that a plurality of stacks each including the negative electrode 931, the positive electrode 932, and the separators 933 may be further stacked.

The secondary battery 913 may include a wound body 950a illustrated in FIG. 23. The wound body 950a illustrated in FIG. 23A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiment 1 is used in the positive electrode 932, whereby the secondary battery 913 can have a high level of safety.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 23B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 23C, the wound body 950a and an electrolyte solution are covered with the housing 930, whereby the secondary battery 913 is completed. The housing 930 is preferably provided with a safety valve, an overcurrent protection element, and the like. The safety valve is a valve to be released when the internal pressure of the housing 930 reaches a predetermined pressure, in order to prevent the battery from exploding.

As illustrated in FIG. 23B, the secondary battery 913 may include a plurality of the wound bodies 950a. The use of the plurality of wound bodies 950a enables the secondary battery 913 to have higher discharge capacity. The description of the secondary battery 913 illustrated in FIG. 22A to FIG. 22C can be referred to for the other components of the secondary battery 913 illustrated in FIG. 23A and FIG. 23B.

### <Laminated Secondary Battery>

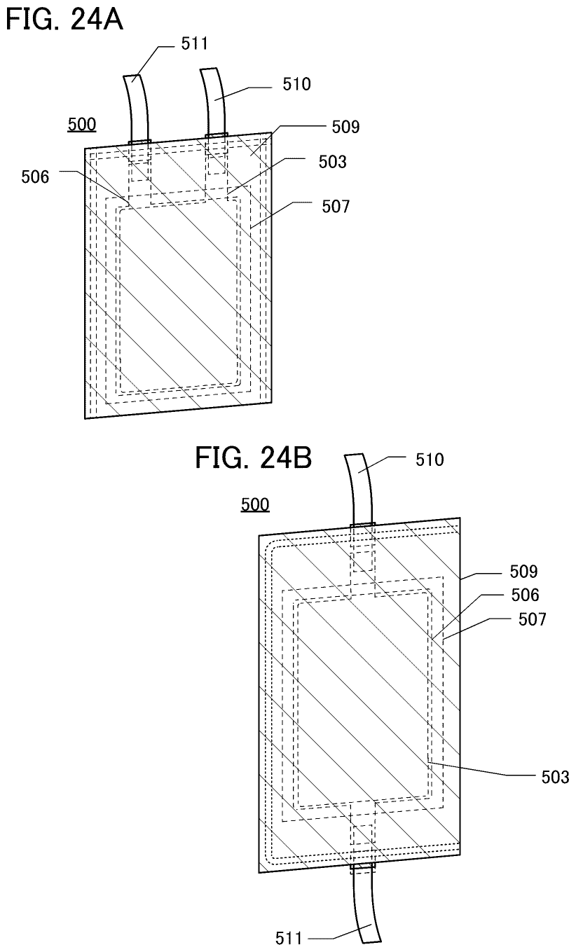

Next, examples of the appearance of a laminated secondary battery are shown in FIG. 24A and FIG. 24B. In FIG. 24A and FIG. 24B, the positive electrode 503, the negative electrode 506, the separator 507, the exterior body 509, the positive electrode lead electrode 510, and the negative electrode lead electrode 511 are included.

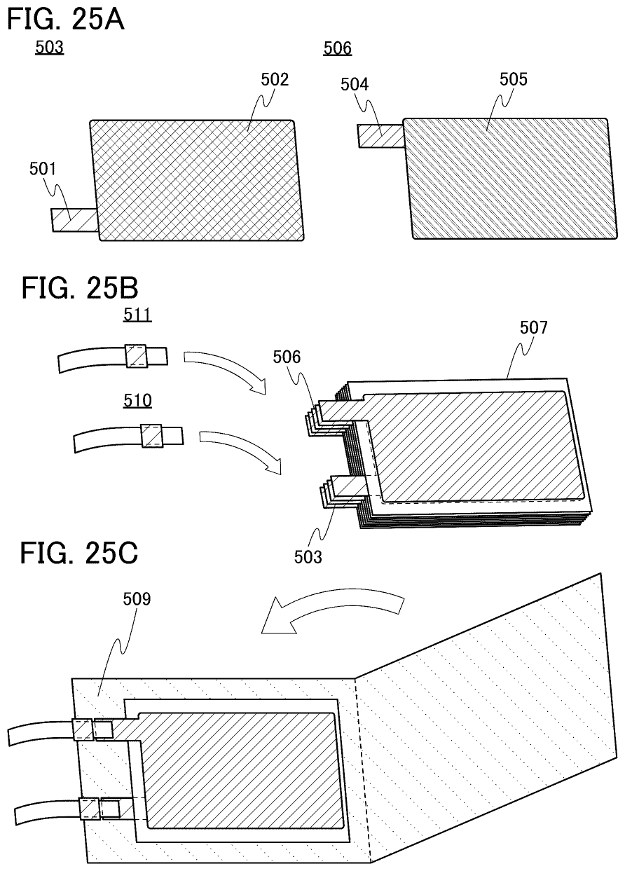

FIG. 25A illustrates external views of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. Note that the areas or the shapes of the tab regions included in the positive electrode and the negative electrode are not limited to the examples shown in FIG. 25A.

### <Method for Manufacturing Laminated Secondary Battery>

An example of a method for manufacturing the laminated secondary battery having the appearance illustrated in FIG. 24A will be described with reference to FIG. 25B and FIG. 25C.

First, the negative electrode 506, the separator 507, and the positive electrode 503 are stacked. FIG. 22B illustrates the negative electrodes 506, the separators 507, and the positive electrodes 503 that are stacked. Here, an example in which five negative electrodes and four positive electrodes are used is illustrated. This can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

Next, the negative electrodes 506, the separators 507, and the positive electrodes 503 are placed over the exterior body 509.

Subsequently, the exterior body 509 is folded along a portion shown by a dashed line, as illustrated in FIG. 25C. Then, the outer edges of the exterior body 509 are bonded to each other. The bonding may be performed by thermocompression, for example. At this time, an unbonded region (hereinafter, referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced under a reduced pressure atmosphere or an inert gas atmosphere. Lastly, the inlet is sealed by bonding. In this manner, the laminated secondary battery 500 can be fabricated.

The positive electrode active material 100 obtained in Embodiment 1 is used in the positive electrodes 503, whereby the secondary battery 500 can have a high level of safety.

### Embodiment 7

In this embodiment, examples of vehicles each including the secondary battery of one embodiment of the present invention will be described.

The secondary battery can be used in vehicles, typically automobiles. Examples of the automobiles include next-generation clean energy vehicles such as hybrid vehicles (HVs), electric vehicles (EVs), and plug-in hybrid vehicles (PHEVs or PHVs), and the secondary battery can be used as one of the power sources provided for the automobiles. The vehicles are not limited to automobiles. Examples of the vehicles include a train, a monorail train, a ship, a submarine (a deep-submergence vehicle and an unmanned submarine), a flying object (a helicopter, an unmanned aircraft (a drone), an airplane, a rocket, and an artificial satellite), an electric bicycle, and an electric motorcycle, and the secondary battery of one embodiment of the present invention can be used for the vehicles.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than those of the first batteries 1301a and 1301b.

The internal structure of the first battery 1301a may be the wound structure illustrated in FIG. 22C or FIG. 23A or the stacked-layer structure illustrated in FIG. 24A or FIG. 24B

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to 42 V system in-vehicle parts (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to 14 V system in-vehicle parts (such as a stereo 1313, a power window 1314, and lamps 1315) through a DCDC circuit 1310.

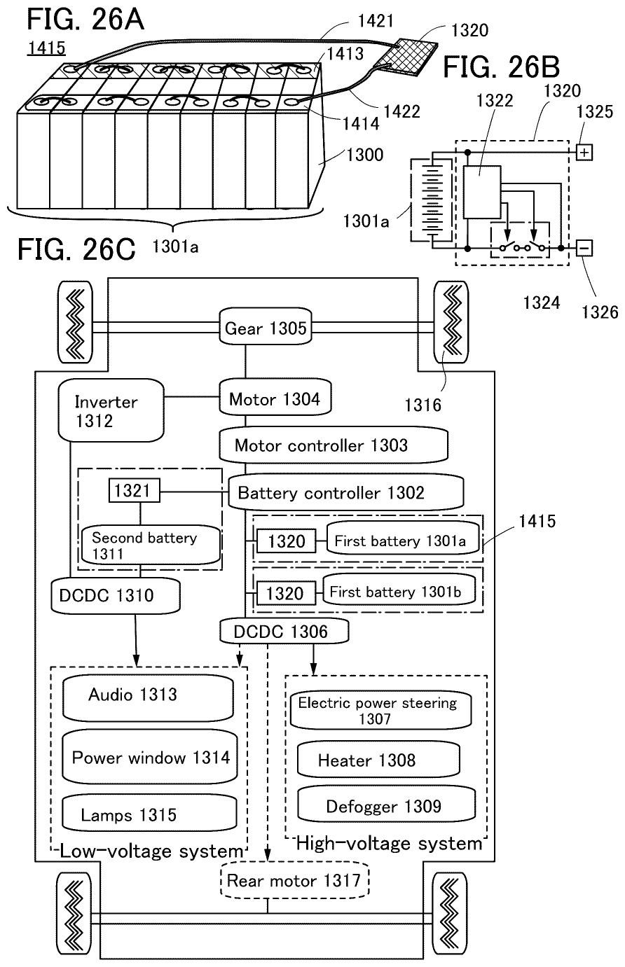

Next, the first battery 1301a is described with reference to FIG. 26A.

FIG. 26A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. Furthermore, the other electrode is electrically connected to the control circuit portion 1320 through a wiring 1422.

Next, FIG. 26C illustrates an example of a block diagram of the battery pack 1415 illustrated in FIG. 26B.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like.

The first batteries 1301a and 1301b mainly supply electric power to 42 V system (high-voltage system) in-vehicle parts, and the second battery 1311 supplies electric power to 14 V system (low-voltage system) in-vehicle parts. Lead storage batteries are usually used for the second battery 1311 due to cost advantage.

In this embodiment, an example in which lithium-ion batteries are used as both the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of rapid charging.

The battery controller 1302 can set the charge voltage, charge current, and the like of the first batteries 1301a and 1301b. The battery controller 1302 can set charge conditions in accordance with charge performance of a secondary battery used, so that rapid charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

For external chargers installed at charging stations and the like, there are 100 V outlets-200 V outlets or three-phase 200 V outlets with 50 kW, for example. Furthermore, charging can be performed with electric power supplied from external charge equipment by a contactless power feeding method or the like.

For rapid charging, secondary batteries that can withstand high-voltage charging are desired to perform charging in a short time.

Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or longer, without increasing the proportion of the weight of the secondary battery to the weight of the entire vehicle.

Specifically, in the above secondary battery in this embodiment, the use of the positive electrode active material 100 described in Embodiment 1 can increase the operating voltage of the secondary battery, and the increase in charge voltage can increase the available capacity. Moreover, using the positive electrode active material 100 described in Embodiment 1 in the positive electrode can provide an in-vehicle secondary battery having a high level of safety.

Next, examples in which the secondary battery of one embodiment of the present invention is mounted on a vehicle, typically a transport vehicle, will be described.

Mounting the secondary battery illustrated in any of FIG. 21D, FIG. 23C, and FIG. 26A on vehicles can achieve next-generation clean energy vehicles such as hybrid vehicles (HVs), electric vehicles (EVs), and plug-in hybrid vehicles (PHVs). The secondary battery can also be mounted on agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

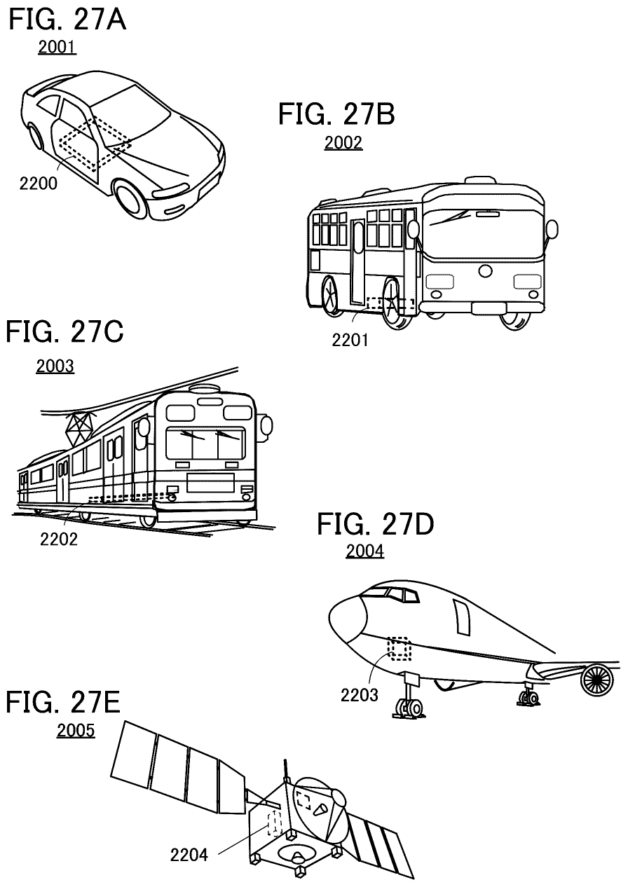

FIG. 27A to FIG. 27D illustrate examples of transport vehicles using one embodiment of the present invention. An automobile 2001 illustrated in FIG. 27A is an electric vehicle that runs using an electric motor as a driving power source. Alternatively, the automobile 2001 is a hybrid vehicle that enables appropriate selection of an electric motor or an engine as a driving power source. In the case where the secondary battery is mounted on the vehicle, an example of the secondary battery described in Embodiment 5 is provided at one position or several positions. The automobile 2001 illustrated in FIG. 27A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charge equipment by a plug-in system, a contactless charge system, or the like. In charging, a given method such as CHAdeMO (registered trademark) or Combined Charging System may be employed as a charge method, the standard of a connector, or the like as appropriate. Charge equipment may be a charge station provided in a commerce facility or a household power supply. For example, with the use of a plug-in technique, the secondary battery mounted on the automobile 2001 can be charged by being supplied with electric power from the outside. Charging can be performed by converting AC power into DC power through a converter such as an ACDC converter.

Although not illustrated, the vehicle may be provided with a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when moving. In addition, the contactless power feeding system may be utilized to perform transmission and reception of electric power between two vehicles. Furthermore, a solar cell may be provided in the exterior of the vehicle to charge the secondary battery while the vehicle is stopped or is moving. To supply power in such a contactless manner, an electromagnetic induction method or a magnetic resonance method can be used.

FIG. 27B illustrates a large transporter 2002 having a motor controlled by electricity, as an example of a transport vehicle. A secondary battery module of the transporter 2002 has a cell unit of four secondary batteries with a nominal voltage of 3.0 V or higher and 5.0 V or lower, and 48 cells are connected in series to have 170 V as the maximum voltage, for example. A battery pack 2201 has the same function as that in FIG. 27A except, for example, the number of secondary batteries configuring the secondary battery module; thus, the description is omitted.

FIG. 27C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have a small variation in the characteristics. By employing the positive electrode active material 100 described in Embodiments 1 to 3 for the positive electrode, a secondary battery having stable battery characteristics can be manufactured and mass production at low cost is possible in light of the yield. A battery pack 2202 has the same function as that in FIG. 26A except, for example, the number of secondary batteries configuring the secondary battery module; thus, the description is omitted.

FIG. 27D illustrates an aircraft 2004 having a combustion engine as an example. The aircraft 2004 illustrated in FIG. 27D can also be regarded as a kind of transport vehicle because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series, which has a maximum voltage of 32 V, for example. The battery pack 2203 has the same function as that in FIG. 27A except, for example, the number of secondary batteries configuring the secondary battery module; thus, the description is omitted.

FIG. 27E illustrates an artificial satellite 2005 including a secondary battery 2204 as an example. The artificial satellite 2005 is desired to develop no trouble due to ignition because the artificial satellite 2005 is used in a cosmic space; thus, the secondary battery 2204 which is a highly safe secondary battery of one embodiment of the present invention is preferably provided. It is further preferable that the secondary battery 2204 be mounted inside the artificial satellite 2005 while being covered with a heat-retaining member.

### Embodiment 8

In this embodiment, examples in which a lithium-ion battery of one embodiment of the present invention is mounted on a motorcycle and a bicycle will be described as examples of mounting a secondary battery in a vehicle.

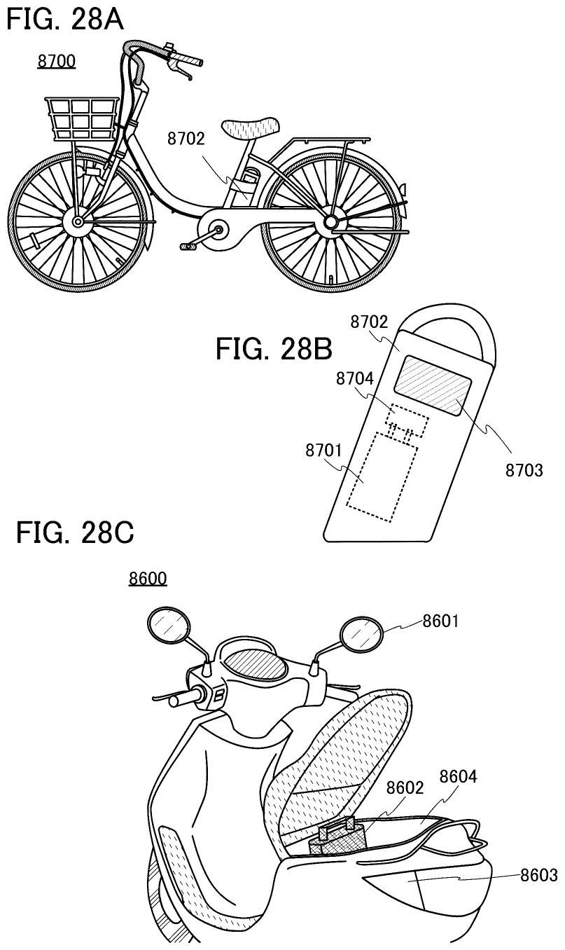

FIG. 28A illustrates an example of an electric bicycle using the power storage device of one embodiment of the present invention. The power storage device of one embodiment of the present invention can be used for an electric bicycle 8700 illustrated in FIG. 28A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 28B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly sensing for the secondary battery, which is exemplified in Embodiment 6. The control circuit 8704 is electrically connected to a positive electrode and a negative electrode of the storage battery 8701. When the control circuit 8704 is used in combination with a secondary battery including a positive electrode using the positive electrode active material 100 obtained in Embodiment 1, the synergy on safety can be obtained. The secondary battery including a positive electrode using the positive electrode active material 100 obtained in Embodiment 1 and the control circuit 8704 has a high level of safety, and can contribute greatly to elimination of accidents due to secondary batteries, such as fires.

FIG. 28C illustrates an example of a two-wheeled vehicle including the power storage device of one embodiment of the present invention. A motor scooter 8600 illustrated in FIG. 28C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in Embodiment 1 can have high capacity and contribute to a reduction in size.

In the motor scooter 8600 illustrated in FIG. 28C, the power storage device 8602 can be stored in an under-seat storage unit 8604. The power storage device 8602 can be stored in the under-seat storage unit 8604 even when the under-seat storage unit 8604 is small.

### Embodiment 9

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

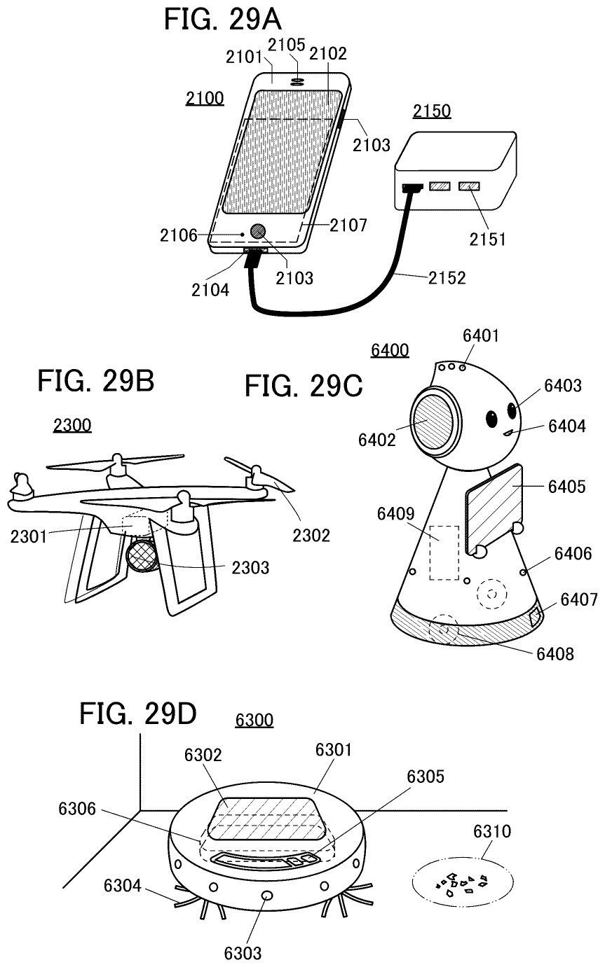

FIG. 29A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 100 described in Embodiment 1 can achieve high capacity and a structure that accommodates space saving due to a reduction in size of the housing. The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication with a headset capable of wireless communication enables hands-free calling.

The mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

The mobile phone 2100 may be provided with an external battery 2150. The external battery 2150 includes a secondary battery and a plurality of terminals 2151. Through a cable 2152 or the like, the mobile phone 2100 or the like can be charged with electricity from the external battery 2150. When the positive electrode active material of one embodiment of the present invention is used for the secondary battery included in the external battery 2150, the external battery 2150 can have high performance. Furthermore, even when the capacity of the secondary battery 2107 included in the mobile phone 2100 itself is low, the mobile phone 2100 can be used for a long time by being charged with electricity from the external battery 2150. Thus, the mobile phone 2100 itself can be small and/or lightweight and can have improved safety.

FIG. 29B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiment 1 has high energy density and a high level of safety, and thus can be used safely for a long time over a long period of time and is preferable as the secondary battery included in the unmanned aircraft 2300.

FIG. 29C illustrates an example of a robot. A robot 6400 illustrated in FIG. 29C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user by using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the secondary battery 6409 of one embodiment of the present invention and a semiconductor device or an electronic component. A secondary battery including a positive electrode using the positive electrode active material 100 obtained in Embodiment 1 has high energy density and a high level of safety, and thus can be used safely for a long time over a long period of time and is preferable as the secondary battery 6409 included in the robot 6400.

FIG. 29D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 obtained in Embodiment 1 has high energy density and a high level of safety, and thus can be used safely for a long time over a long period of time and is preferable as the secondary battery 6306 included in the cleaning robot 6300.

### Embodiment 10

In this embodiment, thermal runaway, a nail penetration test, and the like of a secondary battery will be explained, and the principle that ignition is less likely to occur when a secondary battery including the positive electrode active material 100 of one embodiment of the present invention is subjected to a nail penetration test will be described, for example.

### <Thermal Runway of Secondary Battery>

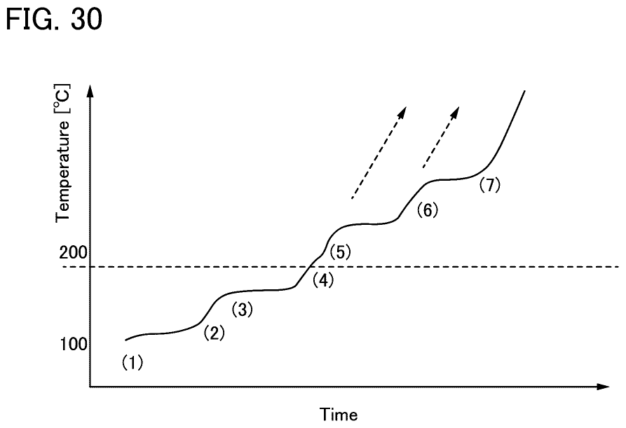

FIG. 30 is a graph obtained by partly modifying the graph cited from [FIG. 2-11] on page 69 of Non-Patent Document 8. The graph of FIG. 30 shows the internal temperature (hereinafter, simply referred to as temperature) of a secondary battery with respect to time and demonstrates that when the temperature increases, the secondary battery enters thermal runaway after going through several states.

In general, when the temperature of the secondary battery reaches 100° C. or the vicinity thereof, (1) collapse of SEI (Solid Electrolyte Interphase) of a negative electrode and heat generation are caused. When the temperature of the secondary battery exceeds 100° C., (2) reduction of an electrolyte solution by the negative electrode (the negative electrode is C₆Li when graphite is used) and heat generation are caused, and (3) oxidation of the electrolyte solution by a positive electrode and heat generation are caused. When the temperature of the secondary battery reaches 180° C. or the vicinity thereof, (4) thermal decomposition of the electrolyte solution is caused and (5) oxygen release from the positive electrode and thermal decomposition of the positive electrode (the thermal decomposition includes a structural change in a positive electrode active material) are caused. After that, when the temperature of the secondary battery exceeds 200° C., (6) decomposition of the negative electrode is caused, and finally, (7) the positive electrode and the negative electrode come into direct contact with each other. The secondary battery enters thermal runaway after passing through the state (5), the state (6), the state (7), or the like. Thus, to prevent thermal runaway, the temperature rise of the secondary battery is preferably inhibited and the negative electrode, the positive electrode, and/or the electrolyte solution are/is preferably kept stable at high temperatures exceeding 100° C.

The positive electrode active material 100 including lithium cobalt oxide or the like of one embodiment of the present invention has a stable crystal structure and an effect of inhibiting release of oxygen. Thus, the secondary battery including the positive electrode active material 100 probably does not come into at least the state (5) and the subsequent states and the temperature rise of the secondary battery is probably inhibited, leading to a significant effect that thermal runaway is less likely to occur.

### <Nail Penetration Test>

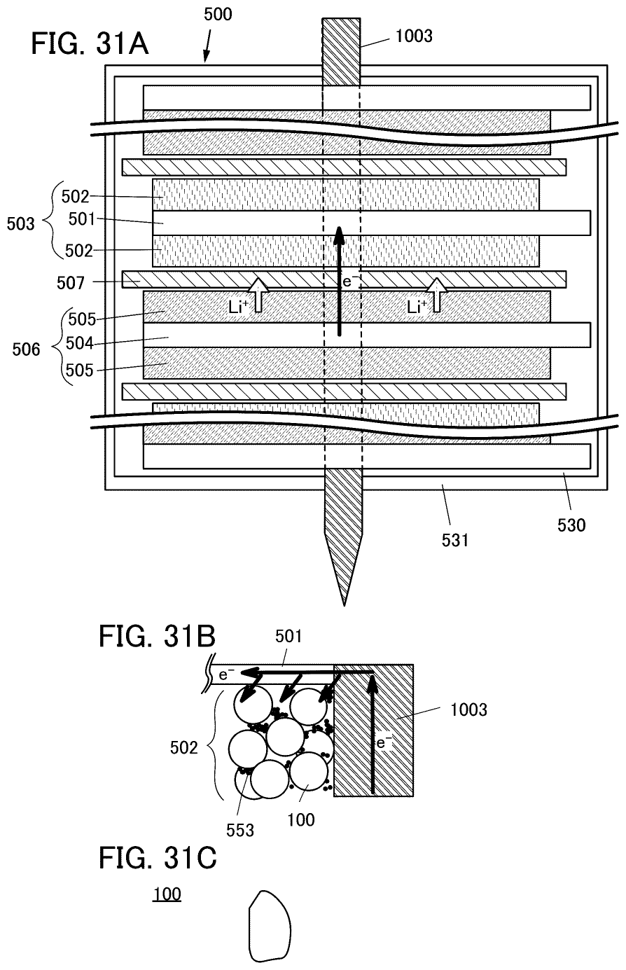

Next, a nail penetration test is described with reference to FIG. 31A to FIG. 31C and the like. In the nail penetration test, a nail 1003 having a predetermined diameter selected from a range of 2 mm to 10 mm penetrates a secondary battery 500 at a predetermined speed selected from a range of 1 mm/s to 20 mm/s, for example. In this example and the like, the nail penetration test was performed on the fully-charged secondary battery 500 (States Of Charge: SOC 100%). FIG. 31A is a cross-sectional view illustrating the state where the nail 1003 penetrates the secondary battery 500. The secondary battery 500 has a structure in which the positive electrode 503, the separator 507, the negative electrode 506, and the electrolyte solution 530 are held in an exterior body 531. The positive electrode 503 includes the positive electrode current collector 501 and the positive electrode active material layers 502 formed over both surfaces of the positive electrode current collector 501. The negative electrode 506 includes the negative electrode current collector 504 and the negative electrode active material layers 505 formed over one surface or both surfaces of the negative electrode current collector 504. FIG. 31B is an enlarged view of the nail 1003 and the positive electrode current collector 501 and clearly illustrates the positive electrode active material 100 of one embodiment of the present invention and the conductive material 553 that are included in the positive electrode active material layer 502. FIG. 31C is an enlarged view of the positive electrode active material 100. The positive electrode active material 100 has the features described in the above embodiments.

As illustrated in FIG. 31A and FIG. 31B, when the nail 1003 penetrates the positive electrode 503 and the negative electrode 506, an internal short circuit occurs. This makes the potential of the nail 1003 equivalent to the potential of the negative electrode, so that an electron (e⁻) flows to the positive electrode 503 as indicated by arrows through the nail 1003 or the like and Joule heat is generated in the portion where the internal short circuit has occurred and the vicinity of the portion. Due to the internal short circuit, carrier ions extracted from the negative electrode 506, typically lithium ions (Li⁺), are released into the electrolyte solution as indicated by the white arrows. Here, in the case where anions are insufficient in the electrolyte solution 530, the electrical neutrality of the electrolyte solution 530 is not maintained when lithium ions are released from the negative electrode 506 into the electrolyte solution 530, so that the electrolyte solution 530 starts decomposing to maintain the electrical neutrality. This is one of electrochemical reactions and is referred to as a reduction reaction of an electrolyte solution by a negative electrode. Then, the electron (e) that has flowed to the positive electrode 503 reduces the transition metal M, which is tetravalent in NCM in the charged state, so that the transition metal M becomes trivalent or divalent. This reduction reaction causes oxygen release from NCM, and the electrolyte solution 530 is decomposed by the released oxygen or the like. This is one of electrochemical reactions and is referred to as an oxidation reaction of an electrolyte solution by a positive electrode.

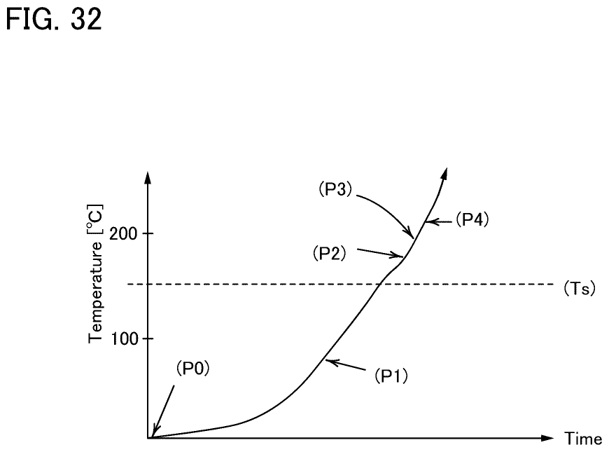

When an internal short circuit of a secondary battery occurs, its temperature changes as shown in the graph of FIG. 32. FIG. 32 is a graph obtained by partly modifying the graph cited from [FIG. 2-12] on page 70 of Non-Patent Document 8. This graph shows the temperature of a secondary battery with respect to time. According to the graph, upon an internal short circuit at (P0), the temperature of the secondary battery increases over time. Specifically, when the temperature of the secondary battery reaches 100° C. or the vicinity thereof because of Joule heat as indicated by (P1), the temperature exceeds the reference temperature (Ts) of the secondary battery. Then, reduction of an electrolyte solution by a negative electrode (the negative electrode is C₆Li when graphite is used) and heat generation are caused at (P2), oxidation of the electrolyte solution by a positive electrode and heat generation are caused at (P3), and heat generation due to thermal decomposition of the electrolyte solution is caused at (P4). Accordingly, the secondary battery enters thermal runaway, resulting in ignition or the like.

In the positive electrode active material at this time, a reaction occurs in which electrons rapidly flowing into the positive electrode active material reduce the transition metal M (e.g., cobalt becomes Co²⁺ from Co⁴⁺) and oxygen is released from the positive electrode active material. Since this reaction is an exothermic reaction, thermal runaway is likely to occur. In other words, inhibiting this reaction enables a positive electrode active material that does not easily undergo thermal runaway.

Thus, a surface portion of a positive electrode active material where the reaction easily occurs preferably has a crystal structure that is less likely to release oxygen. Alternatively, the concentration of a metal that is less likely to release oxygen is preferably high. When oxygen is less likely to be released from the positive electrode active material, the above reduction reaction (e.g., the reaction in which Co⁴⁺ becomes Co²⁺) is inhibited. A metal that is less likely to release oxygen is a metal that forms a stable metal oxide, such as magnesium or aluminum. Nickel is also presumed to have an effect of inhibiting oxygen release when occupying a lithium site. In addition, an effect of inhibiting a thermite reaction between an aluminum foil used for the positive electrode current collector and the positive electrode active material is considered to be obtained.

In the case where a nail penetration test is performed on a secondary battery using the positive electrode active material 100 including lithium cobalt oxide of one embodiment of the present invention, the positive electrode active material 100 has a unique effect of inhibiting release of oxygen owning to the above-described barrier film; thus, it is considered that an oxidation reaction of the electrolyte solution and heat generation can be inhibited. Furthermore, the barrier film in the surface portion of the positive electrode active material 100 has characteristics similar to those of an insulator; thus, the speed of current flowing into the positive electrode at the time of an internal short circuit probably becomes low. In that case, a significant effect that thermal runaway is less likely to occur and thus ignition or the like is less likely to occur can be obtained.

Even when the transition metal M such as cobalt is reduced, insertion of lithium ions into the positive electrode active material before oxygen release would maintain electrical neutrality and thus prevent an exothermic reaction involving oxygen release. Thus, even when electrons rapidly flow into the positive electrode active material, the crystal structure of the positive electrode active material should remain stable at least until insertion of lithium ions into the inner portion of the positive electrode active material from the negative electrode through the electrolyte solution is completed.

### Example 1

In this example, a positive electrode active material was prepared in accordance with the above-described manufacturing method 1 of a positive electrode active material. A commercially available NCM (product name: “NMC811” with Ni:Co:Mn=8:1:1, produced by SHANDONG GELON LIB) was prepared as the lithium composite oxide 99 in the manufacturing method 1 of the positive electrode active material and was subjected to heat treatment in Step S136 (at 850° C. for 2 hours), whereby Sample 1 was prepared. Furthermore, a commercially available NCM (product name: “NMC811” with Ni:Co:Mn=8:1:1, produced by SHANDONG GELON LIB) was used as Sample 2 as it was, without being heated.

The numbers of projection portions of Sample 1 and Sample 2 were calculated in accordance with the method 4 described in the above embodiment.

### [Calculation of Projection Portions]

First, particle size distributions of Samples 1 and 2 were measured to obtain median diameters (D50). The median diameters (D50) were measured by a laser diffraction scattering method in accordance with JIS Z 8825 (2013) performed on 0.3 g or more of Samples 1 and 2. As a measurement apparatus of particle size distribution, a laser diffraction particle size distribution measurement apparatus (Shimadzu SALD-2200) was used. First, approximately 0.4 g of each of Sample 1 and Sample 2, a surface active agent, and 1 mL to 2 mL, inclusive, of distilled water were put in a beaker, and the mixture was stirred sufficiently by ultrasonic treatment. After that, this solution was injected into a stirring tank, and luminous intensity distribution was measured 64 times at intervals of two seconds to analyze particle size distribution data.

As results of the particle size distribution measurement, the median diameter (D50) of Sample 1 was 6.6 μm and the median diameter (D50) of Sample 2 was 3.2 μm. It was found that the median diameter (D50) was increased by the heat treatment.

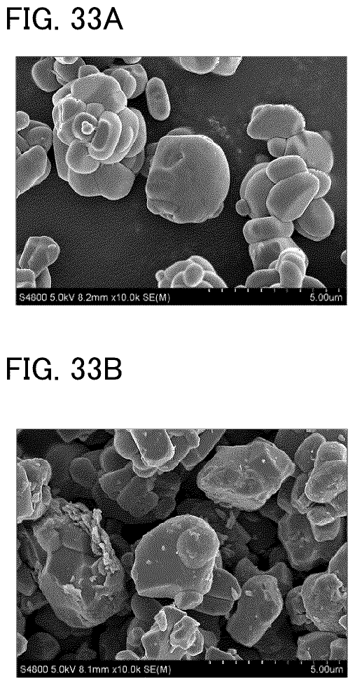

Next, a surface SEM image of the positive electrode containing the positive electrode active material was obtained by observation at an acceleration voltage of 5 kV and a magnification of 10000 times. FIG. 33A is a surface SEM image of Sample 1, and FIG. 33B is a surface SEM image of Sample 2. Comparison of the surface SEM images reveals that Sample 1 has higher smoothness than Sample 2.

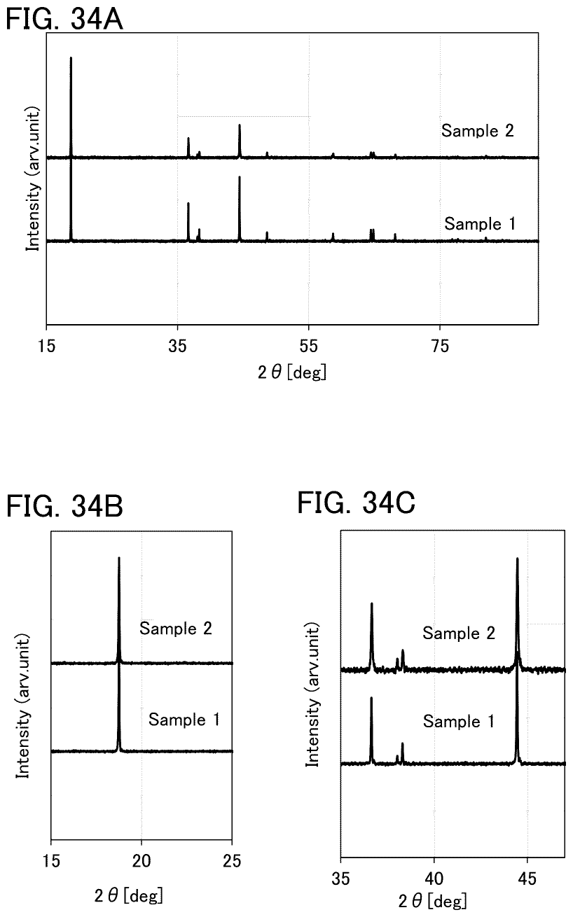

Next, XRD measurement was performed on Samples 1 and 2. FIG. 34A to FIG. 34C show the results. In each of FIG. 34A to FIG. 34C, the vertical axis represents Intensity (arv. unit) and the horizontal axis represents 2θ (deg). FIG. 34A is a graph where a 2θ range is greater than or equal to 15° and less than or equal to 90°, FIG. 34B is a graph where a 2θ range is greater than or equal to 15° and less than or equal to 25° C., and FIG. 34C is a graph where 2θ is greater than or equal to 35° C. and less than or equal to 50° C. As shown in FIG. 34A to FIG. 34C, high peaks were observed at 2θ of 18° or in the neighborhood thereof and 2θ of 44° or in the neighborhood thereof. Samples 1 and 2 had peaks at the same positions, and the crystallinity was not changed. The product name “NMC811” is what is called a single particle, and it can be said that Samples 1 and 2 are each a single particle.

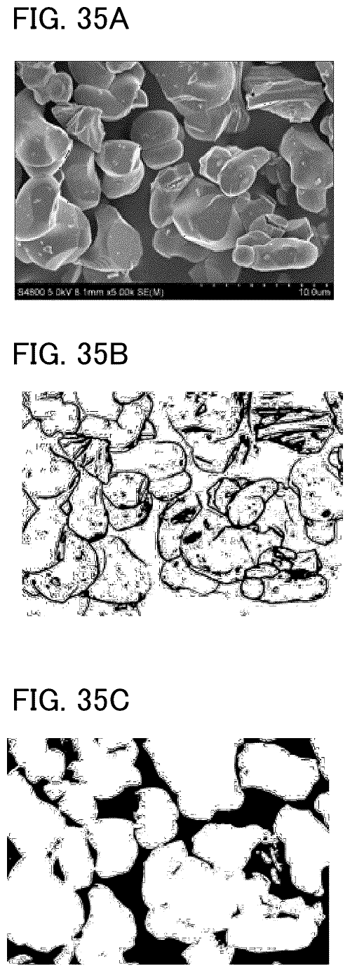

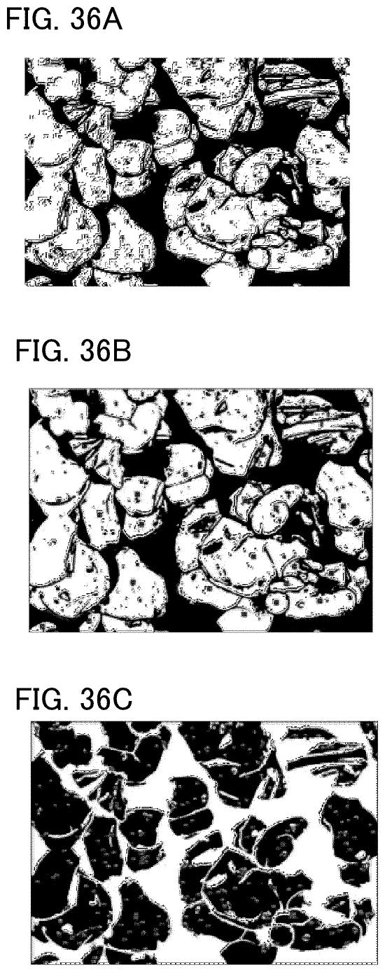

A method for calculating a projection is described with reference to FIG. 35 and FIG. 36. A given SEM image is shown in FIG. 35A. Then, a label portion that is not used for image analysis is trimmed from the SEM image. For trimming, well-known image processing software can be used, and for example, the product name “ImageJ” is preferably used. Hereinafter, a procedure in which ImageJ is used will be described.

In the case where a plurality of positive electrode active materials are aggregated as shown in FIG. 35A, i.e., a plurality of positive electrode active materials are adjacent to or in close contact with each other, boundaries of the positive electrode active materials are extracted. To extract the boundaries, it is preferable to extract a portion where a luminance change in the image is large by using a Find Edges function of ImageJ, perform image noise processing by a Gaussian Blur function (sigma=2.0), and then perform binarization by a Threshold function (Otsu's algorithm). FIG. 35B shows an image of extracted boundary portions.

In the case where the aggregated positive electrode active materials are observed as shown in FIG. 35A, the boundaries of positive electrode active materials on the front side are preferably identified. For example, to identify the positive electrode active materials on the front side, it is preferable to increase the contrast of the image by an Enhance Contrast (Saturated pixels=0.35%) function of ImageJ, perform image noise processing by the Gaussian Blur function (sigma=2.0), and then perform binarization by the Threshold function (Minimum algorithm), thereby extracting the boundaries of the positive electrode active materials on the front side. FIG. 35C shows an image of the extracted positive electrode active materials on the front side.

FIG. 35B obtained in the above procedure is superimposed on FIG. 35C at a transmittance of 50% by an Add Image function of ImageJ. After that, binarization is performed by the Threshold function (Otsu's algorithm) of ImageJ, thereby obtaining such an image as shown in FIG. 36A in which the background and the interior of the particles are separated.

Particles each having an area in FIG. 36A, i.e., an area in the image, of 0.8 μm² or larger are specified by an Analyze particle function with the use of ImageJ (FIG. 36B), and the number of the particles is counted. The particles each correspond to a positive electrode active material. The particle area of 0.8 μm² or larger is selected and corresponds to a median diameter (D50) of 1 μm or greater. This can be regarded as selection of the area consistent with the particle size distribution measurement.

Next, fine particles of 0.25 μm² or smaller present on the surfaces of the specified particles, i.e., the positive electrode active materials, are specified by the Analyze particle function of ImageJ, and the number of the fine particles is calculated. At this time, a particle with a size of 10 pixels or less in the image is excluded as noise. FIG. 36C shows an image from which noise has been removed. The fine particles each corresponds to a projection.

By calculating the fine particles of 0.25 μm² or smaller present on the surface of the positive electrode active material in this manner, whether the positive electrode active material has a smooth region can be evaluated.

According to the above procedure, projection portions and the like were calculated in the surface SEM image of Sample 1, and 38 fine particles (38 points) were obtained with respect to 41 positive electrode active materials. In accordance with the same procedure, projection portions and the like were calculated in the surface SEM image of Sample 2, and 263 fine particles (263 points) were obtained with respect to 35 positive electrode active materials. Sample 1 of this example was found to have three or less fine particles per positive electrode active material and be a positive electrode active material including a smooth region.

### Example 2

In this example, a commercially available NCM (product name: “NMC811” with Ni:Co:Mn=8:1:1, produced by SHANDONG GELON LIB) was prepared and subjected to different heating conditions in Step S136, whereby Samples were prepared.

### <Sample A>

Sample A was obtained in such a manner that the NMC811 was passed through a sieve with an aperture size of 53 μm.

### <Sample B>

The NMC811 was passed through a sieve with an aperture of 53 μm, was then put in a crucible, and was heated at 200° C. for 1 hour (first heating). Oxygen was continuously supplied at 5 L/min to the furnace where the crucible was placed. After that, heating was performed at 700° C. for 10 hours (second heating). In the first heating and the second heating, oxygen was continuously supplied at 5 L/min to the furnace where the crucible was placed. This sample was Sample B.

### <Sample C>

Titanium acetylacetonate represented by Structural Formula (H14) was prepared and mixed with the NMC811 passed through a sieve with an aperture of 53 μm. In the mixing, the atomic weight of titanium of the titanium acetylacetonate was set to 0.25% to the total atomic weight of nickel, manganese, and cobalt of the NMC811. After that, the first heating and the second heating were performed under the same conditions as those in Sample B. This sample was Sample C.

### <Sample D>

Titanium acetylacetonate represented by Structural Formula (H14) was prepared and mixed with the NMC811 passed through a sieve with an aperture of 53 μm. In the mixing, the atomic weight of titanium of the titanium acetylacetonate was set to 0.5% to the total atomic weight of nickel, manganese, and cobalt of the NMC811. The conditions of the first heating and the second heating after that were the same as those of Sample C.

### <Sample E>

Titanium acetylacetonate represented by Structural Formula (H14) was prepared and mixed with the NMC811 passed through a sieve with an aperture of 53 μm. In the mixing, the atomic weight of titanium of the titanium acetylacetonate was set to 1% to the total atomic weight of nickel, manganese, and cobalt of the NMC811. The conditions of the first heating and the second heating after that were the same as those of Sample C.

### <SEM Observation>

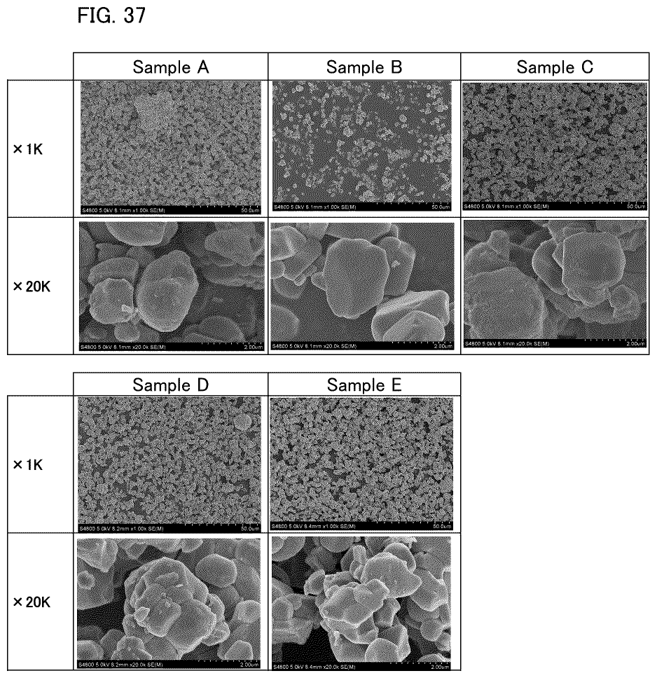

SEM observation was performed on Sample A to Sample E. As the SEM observation conditions, the acceleration voltage was 5 kV and the magnification was 1000 times or 20000 times. FIG. 37 shows the results. Sample B was a single particle. Sample C to Sample E were not single particles but secondary particles.

### <Charge and Discharge Cycle Test>

Positive electrodes including Sample A to Sample E were manufactured, coin cells were assembled as described later, and charge and discharge cycle tests were performed on the coin cells. The optimal range of Ti was examined from the results of the charge and discharge cycle tests.

### <Positive Electrode>

Positive electrodes containing the positive electrode active materials corresponding to Sample A to Sample E were manufactured. A positive electrode slurry was prepared to have an active material ratio of 95% by mixing the positive electrode active material, a conductive material (AB), and a binder (PVDF) at the weight ratio of 95:3:2. As a dispersion solvent of the positive electrode slurry, N-methyl-2-pyrrolidone (NMP) was used. The positive electrode slurry was applied to aluminum foil and then dried such that the load amount of the positive electrode active material was greater than or equal to 7 mg/cm² and less than or equal to 20 mg/cm². After drying, pressing with a roller press machine was performed with upper and lower roll temperatures at 120° C. and at a linear pressure of 210 kN/m.

### <Coin Cell Assembly>

In this example, a coin cell including the above positive electrode (CR2032 type, with a diameter of 20 mm and a height of 3.2 mm) was assembled in a glove box with an argon atmosphere. Stainless steel (SUS) was used for each of a positive electrode can and a negative electrode can of the coin cell. For a separator of the coin cell, polypropylene was used. As the electrolyte solution of the coin cell, a mixture obtained by dissolving LiPF₆ at 1.0 mol/l in a mixed solution with EC:DEC=30:70 (volume ratio) was prepared (the mixture was referred to as LiPF₆_EC+DEC), and 2 wt % of VC was added to the LiPF₆_EC+DEC as an additive agent. Note that exposure to the test sometimes generates a dendrite in metal lithium and make it difficult to continue the test; however, since the VC serving as the additive agent can inhibit the dendrite, a long-term test is enabled.

First, a positive electrode that was cut out to fit the size of the coin cell was immersed in an electrolyte solution to prepare the positive electrode impregnated with the electrolyte solution. The positive electrode impregnated with the electrolyte solution was placed over the positive electrode can. At this time, the positive electrode current collector was in contact with the positive electrode can. Next, a separator that was cut out to fit the size of the coin cell was immersed in the electrolyte solution to the separator impregnated with the electrolyte solution. The separator impregnated with the electrolyte solution was placed over the positive electrode, and the electrolyte solution was injected in this state. After that, a gasket was placed over the separator, and a lithium metal was placed over the gasket. The gasket is preferably made of an insulating material containing a fluorine compound and has a ring-like shape. When the gasket is provided, the airtightness inside the coin cell can be maintained. Furthermore, a spacer was placed over the lithium metal, and a washer was placed over the spacer. The spacer has a function of preventing a contact between the lithium metal and the washer. After that, the negative electrode can was placed thereover and the negative electrode can and the positive electrode can were crimped. In this manner, the coin cell used in the test of this example was completed. Coin cells including Sample A to Sample E were respectively referred to as a coin cell A to a coin cell E.

### <Charge and Discharge Cycle Test>

Charge and discharge cycle tests were performed on the coin cell A to the coin cell E. Charge and discharge cycle test conditions and the like are described. The coin cell A to the coin cell E were each placed in a thermostatic chamber held at 25° C., and aging was performed under the following aging conditions. After that, the coin cell A to the coin cell E were each placed in a thermostatic oven held at 25° C. or 45° C., and the following cycle condition 1 was repeated 100 cycles.

### Aging Conditions

First cycle
Charge condition: CCCV charge, 0.1C rate, 4.5 V, 0.01C cutoff
Discharge condition: CC discharge, 0.1 rate, 2.5 V cutoff
Second cycle
Charge condition: CCCV charge, 0.5C rate, 4.5 V, 0.01C cutoff
Discharge condition: CC discharge, 0.5 rate, 2.5 V cutoff
Cycle condition 1
Charge condition: CCCV charge, 0.5C rate, 4.5 V, 0.01C cutoff
Discharge condition: CC discharge, 0.5C rate, 2.5 V cutoff

In the aging conditions and the cycle condition 1, the current value corresponding to 1C was 200 mA/g per weight of the positive electrode active material. In each condition, a 10-minute break was taken between completion of charge and the next discharge. In the case where the current does not reach the cutoff current in the charge condition, charge is cut off at a given time. In this test, the condition of the given time for cut off was three hours. The 4.5 V in the charge condition is referred to as the upper limit voltage, and in the period of the CV charge, the voltage is held at the upper limit voltage. The 2.5 V in the discharge condition is referred to as the lower limit voltage.

### <Charge Capacity and Discharge Capacity>

In the charge and discharge cycle test, current was measured with a charge-discharge measuring instrument and the measured current was used as charge capacity and discharge capacity. In charge and discharge measurement, current flowing through the secondary battery was measured by a four-terminal method. In charging, electrons flow from a positive electrode terminal to a negative electrode terminal through a charge-discharge measuring instrument and thus, a charge current flows from the negative electrode terminal to the positive electrode terminal through the charge-discharge measuring instrument. In discharging, electrons flow from the negative electrode terminal to the positive electrode terminal through the charge-discharge measuring instrument and thus, a discharge current flows from the positive electrode terminal to the negative electrode terminal through the charge-discharge measuring instrument. The charge current and the discharge current are measured with an ammeter included in the charge-discharge measuring instrument. The accumulated amount of electric charge flowing in one cycle of charging corresponds to the charge capacity. The accumulated amount of electric charge flowing in one cycle of discharging corresponds to the discharge capacity. For example, the accumulated amount of the discharge current flowing in the first cycle of discharging can be regarded as the discharge capacity in the first cycle, and the accumulated amount of the discharge current flowing in the 50th cycle of discharging can be regarded as the discharge capacity in the 50th cycle. The discharge capacity is converted to a discharge capacity per weight of the positive electrode active material, and a higher discharge capacity is more desirable as a battery characteristic. The charge capacity is also converted to a charge capacity per weight of the positive electrode active material.

### <Discharge Capacity Retention Rate>

The discharge capacity retention rate (%) in the n-th cycle was calculated by (the discharge capacity in the n-th cycle/the maximum value of the discharge capacity in the first cycle to the n-th cycle)×100. In the formula, n is a natural number excluding zero, and n=50 in this example. A higher discharge capacity retention rate after 50 cycles is desirable as a battery characteristic because a reduction in battery capacity after repeated charging and discharging is inhibited.

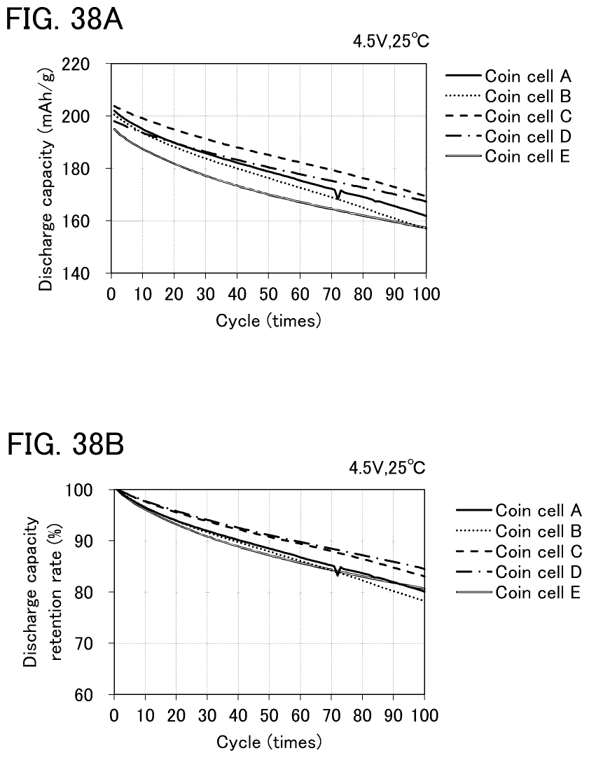

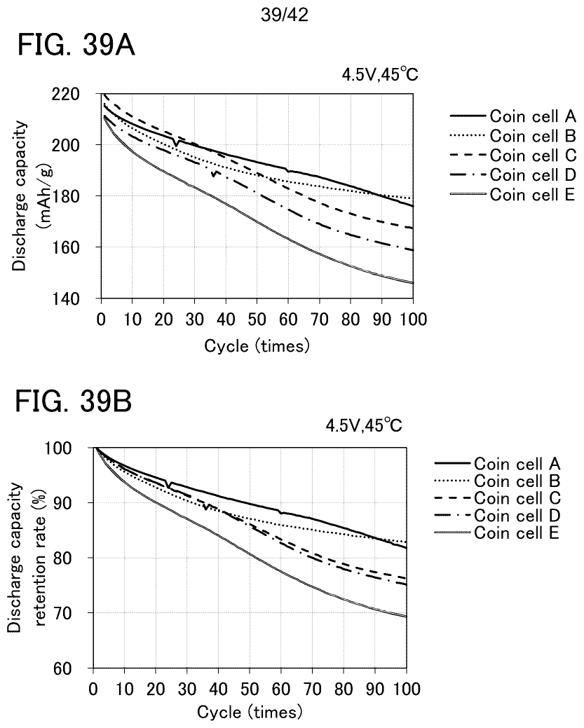

FIG. 38A and FIG. 38B show the results of the charge and discharge cycle test at 25° C. under Condition 1. FIG. 39A and FIG. 39B show the results of the charge and discharge cycle test at 45° C. under Condition 1. As shown in FIG. 38A and FIG. 38B, the coin cell C and the coin cell D exhibited better charge and discharge cycle performance than the coin cell A. The results of this experiment reveal that the concentration of Ti is preferably higher than or equal to 0.25% and lower than or equal to 1%.

Next, samples were prepared again in order to examine the heating time.

### <Sample A2>

Sample A2 was obtained in such a manner that the NMC811 was passed through a sieve with an aperture size of 53 μm. Sample A2 was made under the same conditions as Sample A.

### <Sample B2>

The NMC811 was passed through a sieve with an aperture size of 53 μm, put in a crucible, and heated at 200° C. for 1 hour (first heating). Oxygen was continuously supplied at 5 L/min to the furnace where the crucible was placed. After that, heating was performed at 700° C. for 10 hours (second heating). In the first heating and the second heating, oxygen was continuously supplied at 5 L/min to the furnace where the crucible was placed. This sample was Sample B2. Sample B2 was made under the same conditions as Sample B.

### <Sample C2>

Titanium acetylacetonate represented by Structural Formula (H14) was prepared and mixed with the NMC811 passed through a sieve with an aperture of 53 μm. In the mixing, the atomic weight of titanium of the titanium acetylacetonate was set to 0.25% to the total atomic weight of nickel, manganese, and cobalt of the NMC811. After that, the first heating was performed under the same conditions as those in Sample C, and the second heating was performed at 700° C. for two hours. This sample was Sample C2.

### <Sample D2>

Titanium acetylacetonate represented by Structural Formula (H14) was prepared and mixed with the NMC811 passed through a sieve with an aperture of 53 μm. In the mixing, the atomic weight of titanium of the titanium acetylacetonate was set to 0.25% to the total atomic weight of nickel, manganese, and cobalt of the NMC811 so that the same conditions as Sample C2 was obtained. After that, the first heating was performed under the same conditions as those in Sample C, and the second heating was performed at 700° C. for five hours. This sample was Sample D2.

### <Sample E2>

Titanium acetylacetonate represented by Structural Formula (H14) was prepared and mixed with the NMC811 passed through a sieve with an aperture of 53 μm. In the mixing, the atomic weight of titanium of the titanium acetylacetonate was set to 0.25% to the total atomic weight of nickel, manganese, and cobalt of the NMC811 so that the same conditions as Sample C2 was obtained. The conditions of the first heating and the second heating after that were the same as those of Sample C. This sample was Sample E2.

### <SEM Observation>

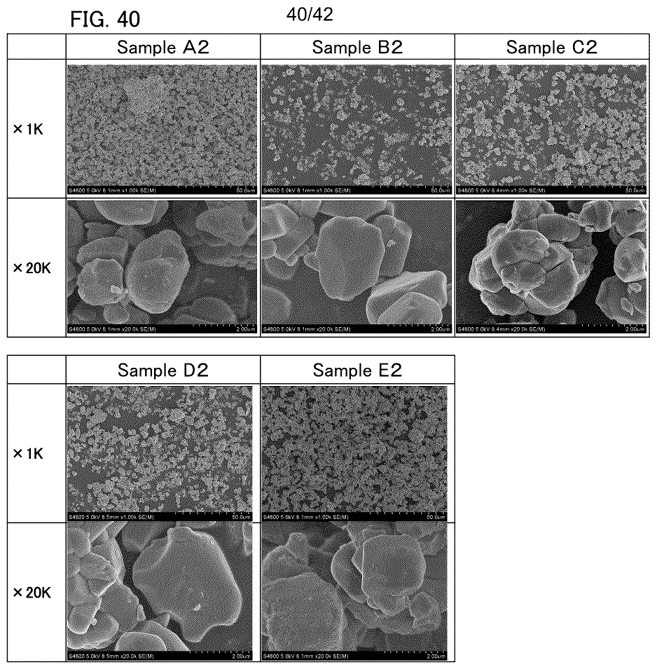

SEM observation was performed on Sample A2 to Sample E2. As the SEM observation conditions, the acceleration voltage was 5 kV and the magnification was 1000 times or 20000 times. FIG. 40 shows the results. Sample B2 was a single particle. Sample C2 to Sample E2 were not single particles but secondary particles.

### <Charge and Discharge Cycle Test>

Positive electrodes including Sample A2 to Sample E2 were manufactured, coin cells were assembled, and charge and discharge cycle tests were performed on the coin cells. The optimal range of Ti was examined from the results of the charge and discharge cycle tests. The manufacturing conditions and the like of the coin cells were similar to those of the coin cell A; the coin cells including Sample A2 to Sample E2 are respectively referred to as a coin cell A2 to a coin cell E2.

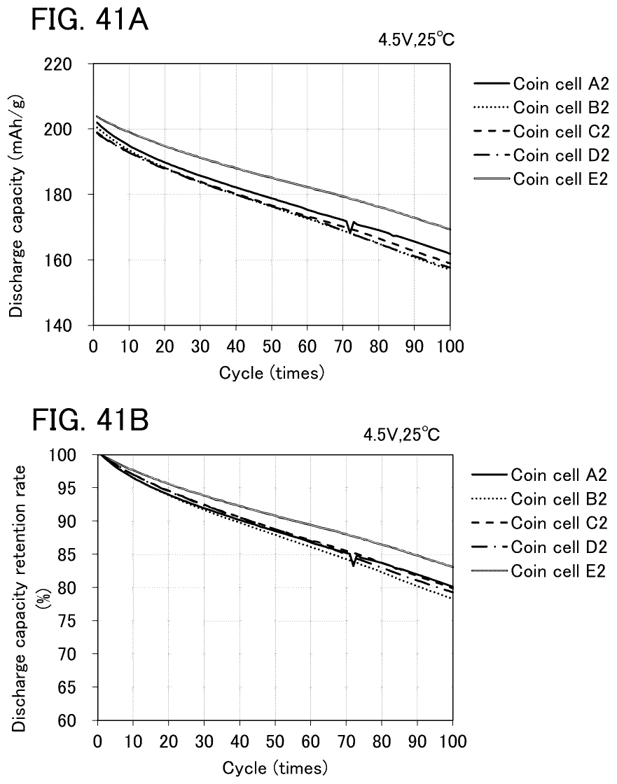

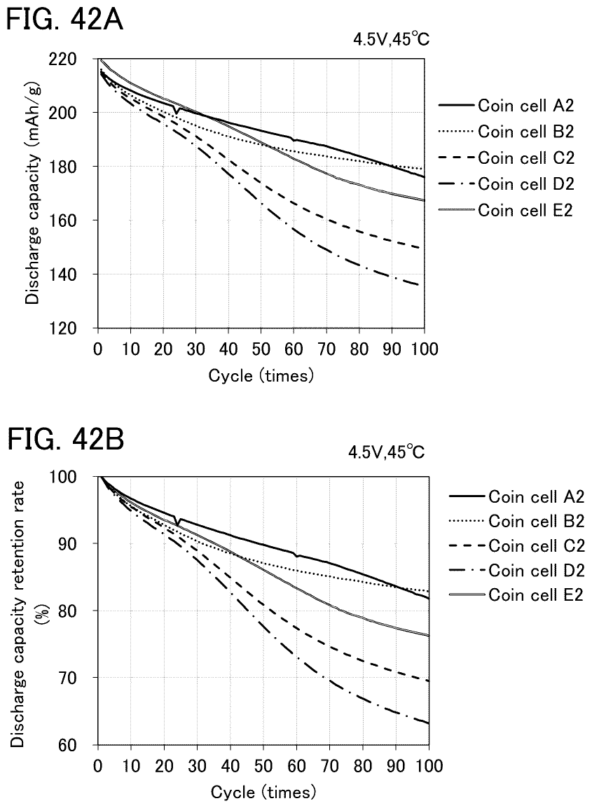

The conditions of the charge and discharge cycle test are similar to those of the charge and discharge cycle test for the coin cell A. FIG. 41A and FIG. 41B show the results of the charge and discharge cycle test at 25° C. under the cycle condition 1. FIG. 42A and FIG. 42B show the results of the charge and discharge cycle test at 45° C. under the cycle condition 1. As shown in FIG. 41A and FIG. 41B, the coin cell E2 exhibited better charge and discharge cycle performance than the coin cell C2 and the coin cell D2. The results of this experiment reveal that the time at a baking temperature of 700° C. is preferably 10 hours.

### REFERENCE NUMERALS

100 positive electrode active material
100a: surface portion, 100b: positive electrode active material, 100c: positive electrode active material, 100d: inner portion, 101a: first positive electrode active material particle, 101b: second positive electrode active material particle, 101c: third positive electrode active material particle,
102: interface

1. A method for manufacturing a lithium-ion secondary battery comprising a positive electrode comprising a positive electrode active material and a negative electrode, the method comprising the steps of:
a first step of heating a first composite oxide comprising lithium and a transition metal;
a second step of mixing the first composite oxide comprising the lithium and the transition metal with a magnesium source to form a first mixed solution;
a third step of performing heating after drying the first mixed solution to form a second composite oxide;
a fourth step of mixing the second composite oxide with one or both of a nickel source and an aluminum source to form a second mixed solution; and
a fifth step of performing heating after drying the second mixed solution,
wherein the magnesium source comprises an organometallic compound comprising magnesium,
wherein the nickel source comprises an organometallic compound comprising nickel, and
wherein the aluminum source comprises an organometallic compound comprising aluminum.

2. (canceled)

3. A method for manufacturing a lithium-ion secondary battery comprising a positive electrode comprising a positive electrode active material and a negative electrode, the method comprising the steps of:
a first step of heating a first composite oxide comprising lithium and a transition metal;
a second step of mixing the first composite oxide comprising the lithium and the transition metal with a magnesium source, a nickel source, and an aluminum source to form a first mixed solution; and
a third step of performing heating after drying the first mixed solution to form a second composite oxide,
wherein the magnesium source comprises an organometallic compound comprising magnesium,
wherein the nickel source comprises an organometallic compound comprising nickel, and
wherein the aluminum source comprises an organometallic compound comprising aluminum.

4. The method for manufacturing a lithium-ion secondary battery, according to claim 1,
wherein the magnesium source comprises an organic solvent in which the organometallic compound comprising magnesium is dissolved.

5-21. (canceled)

22. A method for manufacturing a positive electrode active material, comprising:
forming a lithium composite oxide comprising nickel, cobalt, manganese, and a first additive element source;
heating the lithium composite oxide; and
adding a second additive element source to the heated lithium composite oxide,
wherein the first additive element source and the second additive element source each comprise one or more selected from titanium, calcium, aluminum, zirconium, magnesium, and fluorine.

23. The method for manufacturing a positive electrode active material, according to claim 22,
wherein a temperature of the heating is higher than or equal to 600° C. and lower than or equal to 1000° C., and
wherein a time of the heating is longer than or equal to 1 hour and shorter than or equal to 30 hours.

24. The method for manufacturing a positive electrode active material, according to claim 22,
wherein the first additive element source comprises an inorganic metal compound.

25. The method for manufacturing a positive electrode active material, according to claim 22,
wherein the first additive element source comprises an organometallic compound.

26. The method for manufacturing a positive electrode active material, according to claim 3,
wherein the magnesium source comprises an organic solvent in which the organometallic compound comprising magnesium is dissolved.

27. The method for manufacturing a lithium-ion secondary battery according to claim 1,
wherein surface roughness obtained by quantifying unevenness data on a surface or a vicinity of the surface is less than 3 nm in a cross-sectional STEM image of the positive electrode active material.

28. The method for manufacturing a lithium-ion secondary battery according to claim 1,
wherein a number of projection portions per second composite oxide obtained by quantifying the projection portions is 5 or less in a surface SEM image of the positive electrode comprising the second composite oxide.

29. The method for manufacturing a lithium-ion secondary battery according to claim 3,
wherein surface roughness obtained by quantifying unevenness data on a surface or a vicinity of the surface is less than 3 nm in a cross-sectional STEM image of the positive electrode active material.

30. The method for manufacturing a lithium-ion secondary battery according to claim 3,
wherein a number of projection portions per second composite oxide obtained by quantifying the projection portions is 5 or less in a surface SEM image of the positive electrode comprising the second composite oxide.

31. The method for manufacturing a positive electrode active material, according to claim 22,
wherein surface roughness obtained by quantifying unevenness data on a surface or a vicinity of the surface is less than 3 nm in a cross-sectional STEM image of the positive electrode active material.
